(19) United States
(12) Patent Application Publication
(10) Pub. No.: US 2012/0162619 A1
(43) Pub. Date: Jun. 28, 2012

(54) LIQUID IMMERSION MEMBER, IMMERSION EXPOSURE APPARATUS, EXPOSING METHOD, DEVICE FABRICATING METHOD, PROGRAM, AND STORAGE MEDIUM

(75) Inventor: Shinji SATO, Fukaya-shi (JP)

(73) Assignee: NIKON CORPORATION, Tokyo (JP)

(21) Appl. No.: 13/334,808

(22) Filed: Dec. 22, 2011

Related U.S. Application Data
(60) Provisional application No. 61/427,320, filed on Dec. 27, 2010.

(51) Int. Cl. G03B 27/52

(52) U.S. Cl. 355/27; 355/18; 355/77

(57) ABSTRACT

A liquid immersion member inside an immersion exposure apparatus that is disposed at least partly around an optical member and an optical path of exposure light wherethrough a first liquid between the optical member and an object passes includes a first liquid immersion member, which is disposed at least partly around the optical path and forms a first immersion space of the first liquid at an emergent surface side of the optical member; a guide part, which guides at least some of the first liquid in the first immersion space to a first guide space, which is partly around the optical path; and a second liquid immersion member, which is disposed at an outer side of the first liquid immersion member with respect to the optical path and forms a second immersion space of a second liquid partly around the first immersion space and adjacent to the first guide space.

### CROSS-REFERENCE TO RELATED APPLICATION

This application is a non-provisional application claiming priority to and the benefit of U.S. provisional application No. 61/427,320, filed on Dec. 27, 2010. The entire contents of which are incorporated herein by reference.

### BACKGROUND

1. Field of the Invention

The present invention relates to a liquid immersion member, an immersion exposure apparatus, an exposing method, a device fabricating method, a program, and a storage medium.

2. Description of Related Art

As disclosed in, for example, U.S. Patent Application Publication No. 200910046261, among exposure apparatuses used in photolithography, an immersion exposure apparatus is known that exposes a substrate with exposure light that transits a liquid.

### SUMMARY

In an immersion exposure apparatus, exposure failures might occur if, for example, a liquid flows out of a prescribed space. These problems could result in the production of defective devices.

An object of aspects of the present invention is to provide a liquid immersion member, an immersion exposure apparatus, and an exposing method that can prevent exposure failures from occurring. Another object of aspects of the present invention is to provide a device fabricating method, a program, and a storage medium that can prevent defective devices from being produced.

A first aspect of the invention provides a liquid immersion member inside an immersion exposure apparatus that is disposed at least partly around an optical member and an optical path of exposure light, which passes through a first liquid between the optical member and an object and that comprises: a first liquid immersion member, which is disposed at least partly around the optical path and forms a first immersion space of the first liquid at an emergent surface side of the optical member such that the optical path of the exposure light between the optical member and the object is filled with the first liquid; a guide part, which guides at least some of the first liquid in the first immersion space to a first guide space, which is partly around the optical path; and a second liquid immersion member, which is disposed at an outer side of the first liquid immersion member with respect to the optical path and forms a second immersion space of a second liquid partly around the first immersion space and adjacent to the first guide space.

A second aspect of the invention provides a liquid immersion member inside an immersion exposure apparatus that is disposed at least partly around an optical member and an optical path of exposure light which passes through a first liquid between the optical member and an object passes and that comprises: a first liquid immersion member, which is disposed at least partly around the optical path and forms a first immersion space of the first liquid at an emergent surface side of the optical member such that the optical path of the exposure light between the optical member and the object is filled with the first liquid; and a second liquid immersion member, which is disposed at the outer side of the first liquid immersion member with respect to the optical path and adjacent to the first liquid immersion member in a first direction in which the object moves in a prescribed operation of the immersion exposure apparatus, that forms a second immersion space of a second liquid partly around the first immersion space.

A third aspect of the invention provides a liquid immersion member, inside an immersion exposure apparatus, that is disposed at least partly around an optical member and an optical path of exposure light, which passes through a first liquid between the optical member and an object, the liquid immersion member comprises: a first liquid immersion member, which is disposed at least partly around the optical path and forms a first immersion space of the first liquid at an emergent surface side of the optical member such that the optical path of the exposure light between the optical member and the object is filled with the first liquid; and a second liquid immersion member, which is disposed at an outer side of the first liquid immersion member with respect to the optical path and forms a second immersion space of a second liquid partly around the first immersion space, wherein the second liquid immersion member comprises a second supply port, which is disposed such that the object opposes it and which is capable of supplying the second liquid, and a fluid recovery part, which is disposed such that it surrounds the second supply port and such that the object opposes it and which is capable of recovering a fluid.

A fourth aspect of the invention provides a liquid immersion member, inside an immersion exposure apparatus, that is disposed at least partly around an optical member and an optical path of exposure light, which passes through a first liquid between the optical member and an object, the liquid immersion member comprises: a first liquid immersion member, which is disposed at least partly around the optical path and forms a first immersion space of the first Liquid at an emergent surface side of the optical member such that the optical path of the exposure light between the optical member and the object is filled with the first liquid; a second liquid immersion member, which is disposed at an outer side of the first liquid immersion member with respect to the optical path and forms a second immersion space of a second liquid partly around the first immersion space; and a recovery member, which is disposed at an outer side of the first liquid immersion member with respect to the optical path and which has a fluid recovery part, the fluid recovery part being capable of recovering a fluid.

A fifth aspect of the invention provides a liquid immersion member, inside an immersion exposure apparatus, that is disposed at least partly around an optical member and an optical path, of exposure light, which passes through a first liquid between the optical member and an object, the liquid immersion member comprises: a first liquid immersion member, which is disposed at least partly around the optical path and forms a first immersion space of the first liquid at an emergent surface side of the optical member such that the optical path of the exposure light between the optical member and the object is filled with the first liquid; a second liquid immersion member, which is disposed at an outer side of the first liquid immersion member with respect to the optical path and forms a second immersion space of a second liquid partly around the first immersion space; and a gas supply member that has a gas supply port, which supplies a gas from an outer side of a space between the first liquid immersion member and the object toward the space.

A sixth aspect of the invention provides a liquid immersion member, inside an immersion exposure apparatus, that is disposed at least partly around an optical member and an optical path of exposure light, which passes through a first liquid between the optical member and an object, the liquid immersion member comprising: a first liquid immersion member, which is disposed at least partly around the optical path, and which has a first lower surface the object being capable of opposing, and which forms a first immersion space of the first liquid at an emergent surface side of the optical member such that the optical path of the exposure light between the optical member and the object is filled with the first liquid; and a second liquid immersion member, which is disposed at an outer side of the first liquid immersion member with respect to the optical path, and which has a second lower surface the object being capable of opposing, and which forms a second immersion space of a second liquid partly around the first immersion space; wherein a distance between the second lower surface and a front surface of the object is smaller than a distance between the first lower surface and a front surface of the object.

A seventh aspect of the invention provides a liquid immersion member, inside an immersion exposure apparatus, that is disposed at least partly around an optical, member and an optical path of exposure light, which passes through a first liquid between the optical member and an object, the liquid immersion member comprises: a first liquid immersion member, which is disposed at least partly around the optical path and forms a first immersion space of the first liquid at an emergent surface side of the optical member such that the optical path of the exposure light between the optical member and the object is filled with the first liquid; a second liquid immersion member, which is disposed at an outer side of the first liquid immersion member with respect to the optical path and forms, a second immersion space of a second liquid partly around the first immersion space; and a gas supply port, which is disposed at an outer side of the second liquid immersion member with respect to the optical path and supplies gas.

A eighth aspect of the invention provides an immersion exposure apparatus that exposes a substrate with exposure light through a first liquid and that comprises: a liquid immersion member according to one of the first or seventh aspects.

A ninth aspect of the invention provides a device fabricating method that comprises the steps of: exposing a substrate using an immersion exposure apparatus according to the eighth aspect; and developing the exposed substrate.

A tenth aspect of the invention provides an exposing method that exposes a substrate with exposure light through a first liquid, which fills an optical path of the exposure light between the substrate and an optical member wherefrom the exposure light can emerge and that comprises the steps of: forming a first immersion space of the first liquid at an emergent surface side of the optical member with a first liquid immersion member, which is disposed at least partly around the optical path, such that the optical path of the exposure light between the optical member and the substrate is filled with the first liquid; exposing the substrate through the first liquid of the first immersion space; guiding at least some of the first liquid in the first immersion space to a first guide space, which is partly around the optical path; and forming a second immersion space of a second liquid with a second liquid immersion member, which is disposed at an outer side of the first liquid immersion member with respect to the optical path, such that the second immersion space is partly around the first immersion space and is adjacent to the first guide space.

A eleventh aspect of the invention provides an exposing method that exposes a substrate with exposure light through a first liquid, which fills an optical path of the exposure light between the substrate and an optical member wherefrom the exposure light can emerge and that comprises the steps of: forming a first immersion space of the first liquid at an emergent surface side of the optical member with a first liquid immersion member, which is disposed at least partly around the optical path, such that the optical path of the exposure light between the optical member and the substrate is filled with the first liquid; exposing the substrate through the first liquid of the first immersion space; and forming a second immersion space of a second liquid partly around the first immersion space with a second liquid immersion member, which is disposed at the outer side of the first liquid immersion member with respect to the optical path and adjacent to the first liquid immersion member in a first direction in which the substrate moves in a prescribed operation of the substrate.

A twelfth aspect of the invention provides an exposing method that exposes a substrate with exposure light through a first liquid, which fills an optical path of the exposure light between the substrate and an optical member wherefrom the exposure light can emerge, the method comprises: forming a first immersion space of the first liquid at an emergent surface side of the optical member with a first liquid immersion member, which is disposed at least partly around the optical path, such that the optical path of the exposure light between the optical member and the substrate is filled with the first liquid; exposing the substrate through the first liquid of the first immersion space; and forming a second immersion space of a second liquid partly around the first immersion space with a second liquid immersion member, which is disposed at an outer side of the first liquid immersion member with respect to the optical path, the second liquid immersion member having a second supply port and a fluid recovery part, the substrate being capable of opposing the second supply port, the second liquid being capable of being supplied via the second supply port, the fluid recovery part being disposed such that it surrounds the second supply port, the substrate being capable of opposing the fluid recovery part.

A thirteenth aspect of the invention provides an exposing method that exposes a substrate with exposure light through a first liquid, which fills an optical path of the exposure light between the substrate and an optical member wherefrom the exposure light can emerge, the method comprises: forming a first immersion space of the first liquid at an emergent surface side of the optical member with a first liquid immersion member, which is disposed at least partly around the optical path, such that the optical path of the exposure light between the optical member and the substrate is filled with the first liquid; exposing the substrate through the first liquid of the first immersion space; forming a second immersion space of a second liquid with a second liquid immersion member, which is disposed at an outer side of the first liquid immersion member with respect to the optical path, such that the second immersion space is partly around the first immersion space; and recovering fluid by a fluid recovery part of a recovery member, which is disposed at an outer side of the first liquid immersion member with respect to the optical path.

A fourteenth aspect of the invention provides an exposing method that exposes a substrate with exposure light through a first liquid, which fills an optical path of the exposure light between the substrate and an optical member wherefrom the exposure light can emerge, the method comprising: forming a first immersion space of the first liquid at an emergent surface side of the optical member with a first liquid immersion member, which is disposed at least partly around the optical path, such that the optical path of the exposure light between the optical member and the substrate is filled with the first liquid; exposing the substrate through the first liquid of the first immersion space; forming a second immersion space of a second liquid with a second liquid immersion member, which is disposed at an outer side of the first liquid immersion member with respect to the optical path, such that the second immersion space is partly around the first immersion space; and supplying gas via a gas supply port of a gas supply member from an outer side of a space between the first liquid immersion member and the object toward the space.

A fifteenth aspect of the invention provides an exposing method that exposes a substrate with exposure light through a first liquid, which fills an optical path of the exposure light between the substrate and an optical member wherefrom the exposure light can emerge, the method comprises: forming a first immersion space of the first liquid at an emergent surface side of the optical member with a first liquid immersion member, which is disposed at least partly around the optical path, such that the optical path of the exposure light between the optical member and the substrate is filled with the first liquid, the first liquid immersion member having a first lower surface, which is capable of opposing a front surface of the substrate with a first distance therebetween; exposing the substrate through the first liquid of the first immersion space; and forming a second immersion space of a second liquid with a second liquid immersion member, which is disposed at an outer side of the first liquid immersion member with respect to the optical path, such that the second immersion space is partly around the first immersion space, the second liquid immersion member having a second lower surface, which is capable of opposing a front surface of the substrate with a second distance therebetween, the second distance being smaller than the first distance.

A sixteenth aspect of the invention provides an exposing method that exposes a substrate with exposure light through a first liquid, which fills an optical path of the exposure light between the substrate and an optical member wherefrom the exposure light can emerge, the method comprises: forming a first immersion space of the first liquid at an emergent surface side of the optical member with a first liquid immersion member, which is disposed at least partly around the optical path, such that the optical path of the exposure light between the optical member and the substrate is filled with the first liquid; exposing the substrate through the first liquid of the first immersion space; forming a second immersion space of a second liquid with a second liquid immersion member, which is disposed at an outer side of the first liquid immersion member with respect to the optical path, such that the second immersion space is partly around the first immersion space; and supplying gas from a gas supply port, which is disposed at an outer side of the second liquid immersion member with respect to the optical path.

A seventeenth aspect of the invention provides a device fabricating method that comprises the steps ofi exposing a substrate using an exposing method according to one of the tenth to sixteenth aspects; and developing the exposed substrate.

An eighteenth aspect of the invention provides a program that causes a computer to control an immersion exposure apparatus that exposes a substrate with exposure light through a first liquid, which fills an optical path of the exposure light between the substrate and an optical member wherefrom the exposure light can emerge and that comprises the steps of forming a first immersion space of the first liquid at an emergent surface side of the optical member with a first liquid immersion member, which is disposed at least partly around the optical path, such that the optical path of the exposure light between the optical member and the substrate is filled with the first liquid; exposing the substrate through the first liquid of the first immersion space; guiding at least some of the first liquid in the first immersion space to a first guide space, which is partly around the optical path; and forming a second immersion space of a second liquid with a second liquid immersion member, which is disposed at an outer side of the first liquid immersion member with respect to the optical path, such that the second immersion space is partly around the first immersion space and is adjacent to the first guide space.

A nineteenth aspect of the invention provides a program that causes a computer to control an immersion exposure apparatus that exposes a substrate with exposure light through a first liquid, which fills an optical path of the exposure light between the substrate and an optical member wherefrom the exposure light can emerge and that comprises the steps of: forming a first immersion space of the first liquid at an emergent surface side of the optical member with a first liquid immersion member, which is disposed at least partly around the optical path, such that the optical path of the exposure light between the optical member and the substrate is filled with the first liquid; exposing the substrate through the first liquid of the first immersion space; and forming a second immersion space of a second liquid partly around the first immersion space with a second liquid immersion member, which is disposed at the outer side of the first liquid immersion member with respect to the optical path and adjacent to the first liquid immersion member in a first direction in which the substrate moves in a prescribed operation of the substrate.

A twentieth aspect of the invention provides a program that causes a computer to control an immersion exposure apparatus that exposes a substrate with exposure light through a first liquid, which fills an optical path of the exposure light between the substrate and an optical member wherefrom the exposure light can emerge, that comprises the steps of forming a first immersion space of the first liquid at an emergent surface side of the optical member with a first liquid immersion member, which is disposed at least partly around the optical path, such that the optical path of the exposure light between the optical member and the substrate is filled with the first liquid; exposing the substrate through the first liquid of the first immersion space; and forming a second immersion space of a second liquid partly around the first immersion space with a second liquid immersion member, which is disposed at an outer side of the first liquid immersion member with respect to the optical path, the second liquid immersion member having a second supply port and a fluid recovery part, the substrate being capable of opposing the second supply port, the second liquid being capable of being supplied via the second supply port, the fluid recovery part being disposed such that it surrounds the second supply port, the substrate being capable of opposing the fluid recovery part.

A twenty-first aspect of the invention provides a program that causes a computer to control an immersion exposure apparatus that exposes a substrate with exposure light through a first liquid, which flits an optical path of the exposure light between the substrate and an optical member wherefrom the exposure light can emerge, that comprises the steps of: forming a first immersion space of the first liquid at an emergent surface side of the optical member with a first liquid immersion member, which is disposed at least partly around the optical path, such that the optical path of the exposure light between the optical member and the substrate is filled with the first liquid; exposing the substrate through the first liquid of the first immersion space; forming a second immersion space of a second liquid with a second liquid immersion member, which is disposed at an outer side of the first liquid immersion member with respect to the optical path, such that the second immersion space is partly around the first immersion space; and recovering fluid by a fluid recovery part of a recovery member, which is disposed at an outer side of the first liquid immersion member with respect to the optical path.

A twenty-second aspect of the invention provides a program that causes a computer to control an immersion exposure apparatus that exposes a substrate with exposure light through a first liquid, which fills an optical path of the exposure light between the substrate and an optical member wherefrom the exposure light can emerge, that comprises the steps of: forming a first immersion space of the first liquid at an emergent surface side of the optical member with a first liquid immersion member, which is disposed at least partly around the optical path, such that the optical path of the exposure light between the optical member and the substrate is filled with the first liquid; exposing the substrate through the first liquid of the first immersion space; forming a second immersion space of a second liquid with a second liquid immersion member, which is disposed at an outer side of the first liquid immersion member with respect to the optical path, such that the second immersion space is partly around the first immersion space; and supplying gas via a gas supply port of a gas supply member from an outer side of a space between the first liquid immersion member and the object toward the space.

A twenty-third aspect of the invention provides a program that causes a computer to control an immersion exposure apparatus that exposes a substrate with exposure light through a first liquid, which fills an optical path of the exposure light between the substrate and an optical member wherefrom the exposure light can emerge, comprises the steps of: forming a first immersion space of the first liquid at an emergent surface side of the optical member with a first liquid immersion member, which is disposed at least partly around the optical path, such that the optical path of the exposure light between the optical member and the substrate is filled with the first liquid, the first liquid immersion member having a first lower surface, which is capable of opposing a front surface of the substrate with a first distance therebetween; exposing the substrate through the first liquid of the first immersion space: and forming a second immersion space of a second liquid with a second liquid immersion member, which is disposed at an outer side of the first liquid immersion member with respect to the optical path, such that the second immersion space is partly around the first immersion space, the second liquid immersion member having a second lower surface, which is capable of opposing a front surface of the substrate with a second distance therebetween, the second distance being smaller than the first distance.

A twenty-fourth aspect of the invention provides a program that causes a computer to control an immersion exposure apparatus that exposes a substrate with exposure light through a first liquid, which fills an optical path of the exposure light between the substrate and an optical member wherefrom the exposure light can emerge, that comprises the steps of: forming a first immersion space of the first liquid at an emergent surface side of the optical member with a first liquid immersion member, which is disposed at least partly around the optical path, such that the optical path of the exposure light between the optical member and the substrate is filled with the first liquid; exposing the substrate through the first liquid of the first immersion space; forming a second immersion space of a second liquid with a second liquid immersion member, which is disposed at an outer side of the first liquid immersion member with respect to the optical path, such that the second immersion space is partly around the first immersion space; and supplying gas from a gas supply port, which is disposed at an outer side of the second liquid immersion member with respect to the optical path.

A twenty-fifth aspect of the invention provides a computer readable storage medium whereon a program according to one of the eighteenth to twenty-fourth aspects is stored.

According to aspects of the present invention, it is possible to prevent exposure failures from occurring. In addition, according to aspects of the present invention, it is possible to prevent defective devices from being produced.

### BRIEF DESCRIPTION OF THE DRAWINGS

FIG. 1 is a schematic block diagram that shows one example of an exposure apparatus according to a first embodiment.

FIG. 2 is a side cross sectional view that shows one example of a liquid immersion member according to the first embodiment.

FIG. 3 is a side cross sectional view that shows one example of the liquid immersion member according to the first embodiment.

FIG. 4 shows the liquid immersion member according to the first embodiment, viewed from below.

FIG. 5 is a partial enlarged view of FIG. 2.

FIG. 6 is a partial enlarged view of FIG. 3.

FIG. 7 is a schematic drawing for explaining one example of the operation of the exposure apparatus according to the first embodiment.

FIG. 8 is a schematic drawing for explaining one example of the operation of the exposure apparatus according to the first embodiment.

FIG. 9 is a diagram for explaining one example of a guide part according to the first embodiment.

FIG. 10 is a diagram for explaining one example of the guide part according to the first embodiment.

FIG. 11 is a diagram for explaining one example of the liquid immersion member according to the first embodiment.

FIG. 12 is a diagram for explaining one example of the liquid immersion member according to the first embodiment.

FIG. 13 is a diagram for explaining one example of the liquid immersion member according to a second embodiment.

FIG. 14 is a diagram for explaining one example of the liquid immersion member according to the second embodiment.

FIG. 15 is a diagram for explaining one example of the liquid immersion member according to the second embodiment.

FIG. 16 is a diagram for explaining one example of the liquid immersion member according to the second embodiment.

FIG. 17 is a diagram for explaining one example of the liquid immersion member according to the second embodiment.

FIG. 18 is a diagram for explaining one example of the liquid immersion member according to the second embodiment.

FIG. 19 is a diagram for explaining one example of the liquid immersion member according to a third embodiment.

FIG. 20 is a diagram for explaining one example of the liquid immersion member according to the third embodiment.

FIG. 21 is a diagram for explaining one example of the liquid immersion member according to the third embodiment.

FIG. 22 is a diagram for explaining one example of the liquid immersion member according to a fourth embodiment.

FIG. 23 is a diagram for explaining examples of the liquid immersion member according to a fifth embodiment.

FIG. 24 is a diagram for explaining examples of the liquid immersion member according to a sixth embodiment.

FIG. 25 is a diagram for explaining one example of the liquid immersion member according to a seventh embodiment.

FIG. 26 is a diagram for explaining one example of the liquid immersion member according to the seventh embodiment.

FIG. 27 is a diagram for explaining one example of the liquid immersion member according to the seventh embodiment.

FIG. 28 is a diagram for explaining an example of a liquid immersion member.

FIG. 29A is a diagram for explaining an example of a liquid immersion member.

FIG. 29B is a diagram for explaining an example of a liquid immersion member.

FIG. 30 is a diagram for explaining an exposure apparatus.

FIG. 31 is a flow chart for explaining one example of a microdevice fabricating process.

### DESCRIPTION OF EMBODIMENTS

The embodiments of the present invention will now be explained, referencing the drawings; however, the present invention is not limited thereto. The explanation below defines an XYZ orthogonal coordinate system, and the positional relationships among parts are explained referencing this system. Prescribed directions within the horizontal plane are the X axial directions, directions orthogonal to the X axial directions in the horizontal plane are the Y axial directions, and directions orthogonal to the X axial directions and the Y axial directions (i.e., the vertical directions) are the Z axial directions. In addition, the rotational directions (i.e., the tilting directions) around the X, Y, and Z axes are the θX, θY, and θZ directions, respectively.

### First Embodiment

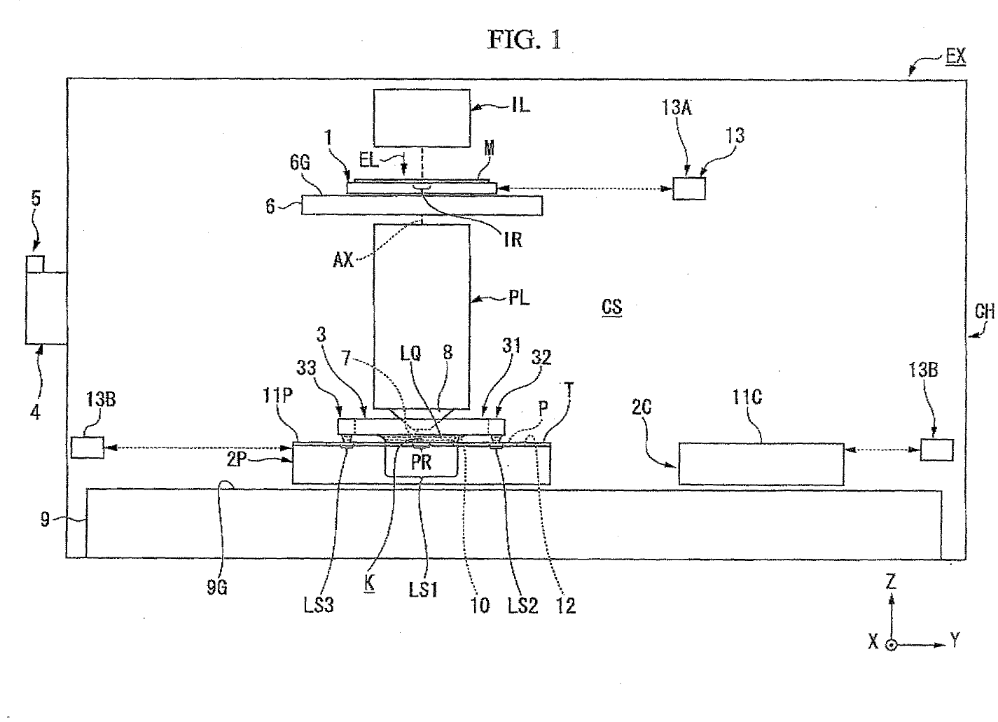

A first embodiment will now be explained. FIG. 1 is a schematic block diagram that shows one example of an exposure apparatus EX according to a first embodiment. The exposure apparatus EX of the present embodiment is an immersion exposure apparatus that exposes a substrate P with exposure light EL that transits a liquid LQ. In the present embodiment, a first immersion space LS1 is formed such that an optical path K of the exposure light EL radiated to the substrate P is filled with the liquid LQ. An immersion space refers to a portion (i.e., a space or an area) that is filled with liquid. The substrate P is exposed with the exposure light EL, which transits the liquid LQ in the first immersion space LS1. In the present embodiment, water (i.e., pure water) is used as the liquid LQ.

In addition, the exposure apparatus EX of the present embodiment comprises a substrate stage and a measurement stage as disclosed in, for example, U.S. Pat. No. 6,897,963 and European Patent Application Publication No, 1713113.

In FIG. 1, the exposure apparatus EX comprises: a movable mask stage 1 that holds a mask M; a movable substrate stage 2P that holds the substrate P; a movable measurement stage 2C that does not hold the substrate P and whereon a measuring member and a measuring instrument that measure the exposure light EL are mounted; an illumination system IL that illuminates the mask M with the exposure light EL; a projection optical system PL that projects an image of a pattern of the mask M, which is illuminated by the exposure light EL, to the substrate P; a liquid immersion member 3, which forms the immersion space; a control apparatus 4, which controls the operation of the entire exposure apparatus EX; and a storage apparatus 5, which is connected to the control apparatus 4 and stores various exposure-related information. The storage apparatus 5 comprises a storage medium such as memory (e.g., RAM), a hard disk, a CD-ROM, and the like. In the storage apparatus 5, an operating system (OS) that controls a computer system is installed and a program for controlling the exposure apparatus EX is stored.

In the present embodiment, the first immersion space LS1, a second immersion space LS2, and a third immersion space LS3 are formed by the liquid immersion member 3. The first immersion space LS1 is formed such that the optical path K of the exposure light EL is filled with the liquid LQ. The second immersion space LS2 is disposed partly around the first immersion space LS1. The third immersion space LS3 is disposed partly around the first immersion space LS1. In the present embodiment, the liquid immersion member 3 includes a first liquid immersion member 31, which forms the first immersion space LS1, a second liquid immersion member 32, which forms the second immersion space LS2, and a third liquid immersion member 33, which forms the third immersion space LS3.

In addition, the exposure apparatus EX comprises a chamber apparatus CH, which forms an internal space CS wherein at least the projection optical system PL, the liquid immersion member 3, the substrate stage 2P, and the measurement stage 2C are disposed. The chamber apparatus CH comprises an environmental control apparatus, which controls the environment (i.e., the temperature, the humidity, the pressure, and the cleanliness level) of the internal space CS.

The mask M may be a reticle on which a device pattern to be projected to the substrate P is formed. The mask M may be a transmissive mask comprising a transpacent plate, such as a glass plate, and the pattern, which is formed on the transpacent plate using a shielding material, such as chrome. Furthermore, a reflective mask can also be used as the mask M.

The substrate P is a substrate for fabricating devices. The substrate P comprises, for example, a base material, such as a semiconductor wafer, and a photosensitive film, which is formed on the base material. The photosensitive film comprises a photosensitive material (e.g., photoresist). In addition to the photosensitive film, the substrate P may comprise a separate film. For example, the substrate P may comprise an antireflection film or a protective film (i.e., a topcoat film) that protects the photosensitive film.

The illumination system IL radiates the exposure light EL to a prescribed illumination area IR. The illumination area IR includes a position whereto the exposure light EL that emerges from the illumination system IL can be radiated. The illumination system IL illuminates at least part of the mask M disposed in the illumination area IR with the exposure light EL, which has a uniform luminous flux intensity distribution. Examples of light that can be used as the exposure light EL that emerges from the illumination system IL include: deep ultraviolet (DUV) light, such as a bright line (i.e., g-line, h-line, or i-line) light emitted from, for example, a mercury lamp, and KrF excimer laser light (with a wavelength of 248 nm); and vacuum ultraviolet (VUV) light, such as ArF excimer laser light (with a wavelength of 193 nm) and F₂ laser light (with a wavelength of 157 nm). In the present embodiment, ArF excimer laser light, which is ultraviolet light (e.g., vacuum ultraviolet light), is used as the exposure light EL.

In the state wherein it holds the mask M, the mask stage 1 is capable of moving on a guide surface 6G of a base member 6 that includes the illumination area IR. The mask stage 1 moves by the operation of a drive system, which comprises a planar motor as disclosed in, for example, U.S. Pat. No. 6,452,292. The planar motor comprises a slider, which is disposed on the mask stage 1, and a stator, which is disposed on the base member 6. In the present embodiment, the mask stage 1 is capable of moving in six directions on the guide surface 6G namely, the X axial, Y axial, Z axial, θX, θY, and θZ directions, by the operation of the drive system.

The projection optical system PL radiates the exposure light EL to a prescribed projection area PR. The projection area PR includes a position whereto the exposure light EL that emerges from the projection optical system PL can be radiated. The projection optical system PL projects with a prescribed projection magnification an image of the pattern of the mask M to at least part of the substrate P, which is disposed in the projection area PR. The projection optical system PL of the present embodiment is a reduction system that has a projection magnification of for example, ¼, ⅕, or ⅛. Furthermore, the projection optical system PL may be a unity magnification system or an enlargement system. In the present embodiment, an optical axis AX of the projection optical system PL is parallel to the Z axis. In addition, the projection optical system PL may be a dioptric system that does not include catoptric elements, a catoptric system that does not include dioptric elements, or a catadioptric system that includes both catoptric and dioptric elements. In addition, the projection optical system PL may form either an inverted or an erect image.

The projection optical system PL has an emergent surface 7 wherefrom the exposure light EL emerges and travels toward an image plane of the projection optical system PL. The emergent surface 7 belongs to a last optical element 8, which is the optical element of the plurality of optical elements of the projection optical system PL that is closest to the image plane of the projection optical system PL. The projection area PR includes a position whereto the exposure light EL that emerges from the emergent surface 7 can be radiated. In addition, in the present embodiment, the projection area PR includes a position that opposes the emergent surface 7. In the present embodiment, the emergent surface 7 faces the −Z direction and is parallel to the XY plane. Furthermore, the emergent surface 7, which faces the −Z direction, may be a convex or a concave surface. The optical axis of the last optical element 8 is parallel to the Z axis. In the present embodiment, the exposure light EL that emerges from the emergent surface 7 proceeds in the −Z direction.

In the state wherein it holds the substrate P, the substrate stage 2P is capable of moving on a guide surface 90 of a base member 9, which includes the projection area PR. The substrate stage 2P moves by the operation of a drive system, which comprises a planar motor as disclosed in, for example, U.S. Pat. No. 6,452,292. The planar motor comprises a slider, which is disposed on the substrate stage 2P, and a stator, which is disposed on the base member 9. In the present embodiment, the substrate stage 2P is capable of moving in six directions on the guide surface 90, namely, the X axial, Y axial, Z axial, θX, θY, and θZ directions, by the operation of the drive system. Furthermore, the drive system that moves the substrate stage 2P does not have to comprise a planar motor. For example, the drive system may comprise a linear motor.

The substrate stage 2P comprises a substrate holding part 10, which releasably holds the substrate P. The substrate holding part 10 holds the substrate P such that the front surface of the substrate P faces the +Z direction. In the present embodiment, the front surface of the substrate P held by the substrate holding part 10 and an upper surface 11P of the substrate stage 2P disposed around the substrate P are disposed within the same plane (i.e., they are flush with one another). The upper surface 11P is flat. In the present embodiment, the front surface of the substrate P, which is held by the substrate holding part 10, and the upper-surface 11P of the substrate stage 2P are substantially parallel to the XY plane.

Furthermore, the upper surface 11P of the substrate stage 2P and the front surface of the substrate P held by the substrate holding part 10 do not have to be disposed within the same plane; furthermore, the front surface of the substrate P or the upper surface 11P, or both, may be nonparallel to the XY plane. In addition, the upper surface 11P does not have to be flat. For example, the upper surface 11P may include a curved surface.

In addition, in the present embodiment, the substrate stage 2P comprises a cover member holding part 12, which releasably holds a cover member T, as disclosed in, for example, U.S. Patent Application Publication No. 2007/0177125 and U.S. Patent Application Publication No. 2008/0049209. In the present embodiment, the upper surface 11P of the substrate stage 2P includes an upper surface of the cover member T held by the cover member holding part 12.

Furthermore, the cover member T does not have to be releasable. In such a case, the cover member holding part 12 could be omitted. In addition, the upper surface 11P of the substrate stage 2P may include the front surface of any sensor, measuring member, or the like installed on the substrate stage 2P.

In the state wherein the measuring member and the measuring instrument, which measure the exposure light EL are mounted thereon, the measurement stage 2C is capable of moving on the guide surface 9G of the base member 9, which includes the projection area PR. The measurement stage 2C moves by the operation of a drive system, which comprises a planar motor as disclosed in, for example, U.S. Pat. No. 6,452,292. The planar motor comprises a slider, which is disposed on the measurement stage 2C, and a stator, which is disposed on the base member 9. In the present embodiment, the measurement stage 2C is capable of moving in six directions on the guide surface 9G, namely, the X axial, Y axial, Z axial, θX, θY, and θZ directions, by the operation of the drive system. Furthermore, the drive system that moves the measurement stage 2C does not have to comprise a planar motor. For example, the drive system may comprise a linear motor.

In the present embodiment, an upper surface 11C of the measurement stage 2C is substantially parallel to the XY plane.

In the present embodiment, an interferometer system 13, which comprises laser interferometer units 13A, 13B, measures the positions of the mask stage 1, the substrate stage 2P, and the measurement stage 2C. The laser interferometer unit 13A is capable of measuring the position of the mask stage 1 using measurement mirrors that are disposed on the mask stage 1. The laser interferometer unit 13B is capable of measuring the positions of the substrate stage 2P and the measurement stage 2C using measurement mirrors disposed on the substrate stage 2P and measurement mirrors disposed on the measurement stage 2C. When an exposing process or a prescribed measurement process is performed on the substrate P, the control apparatus 4 controls, based on the measurement results of the interferometer system 13, the positions of the mask stage 1 (i.e., the mask M), the substrate stage 2P (i.e., the substrate P), and the measurement stage 2C (i.e., the measuring member.

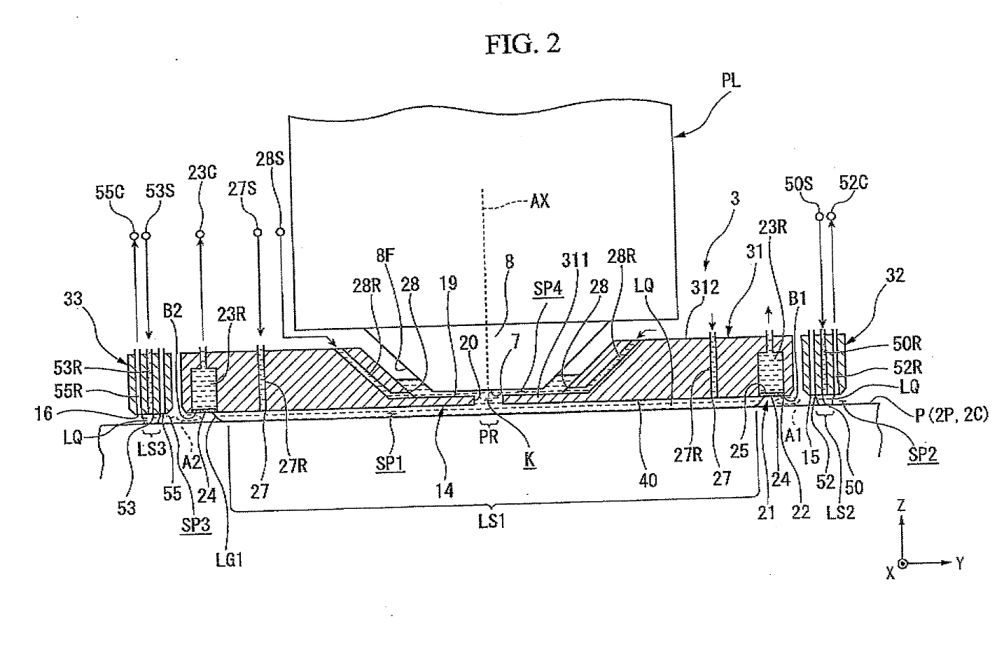

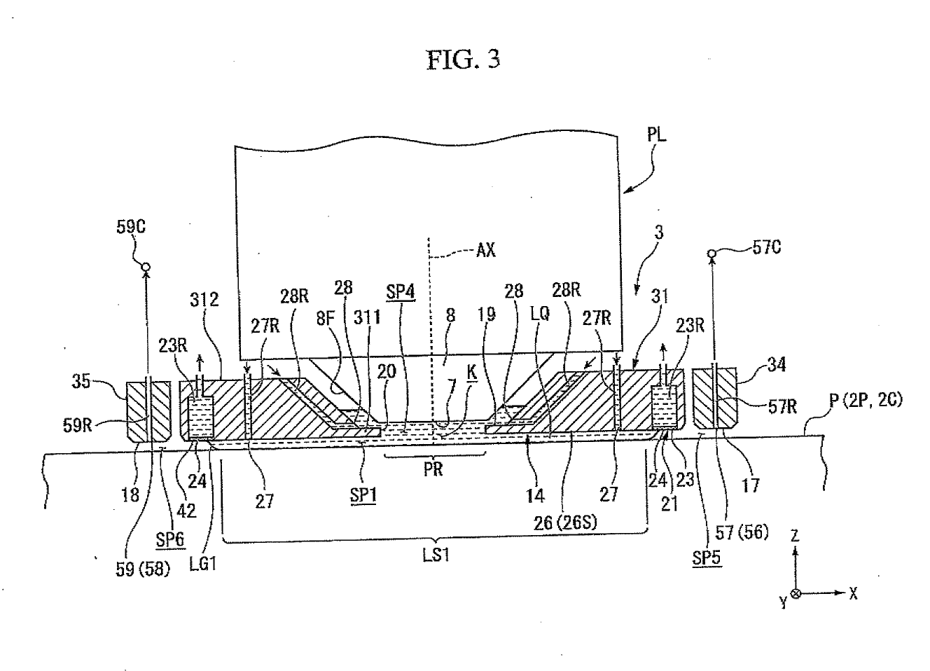

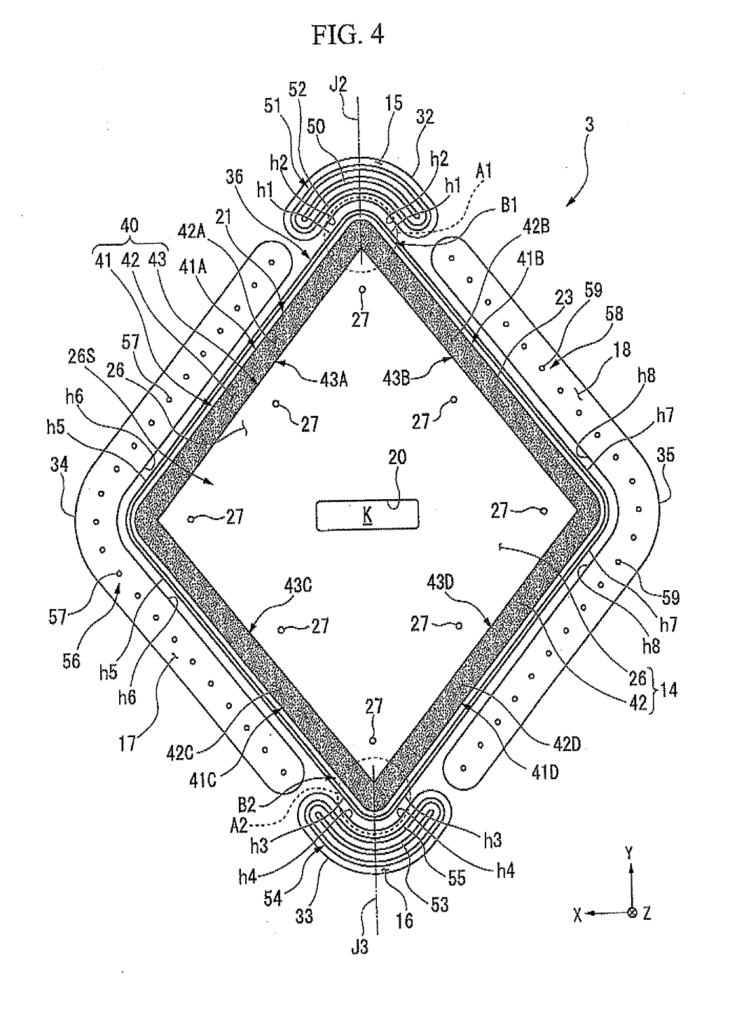

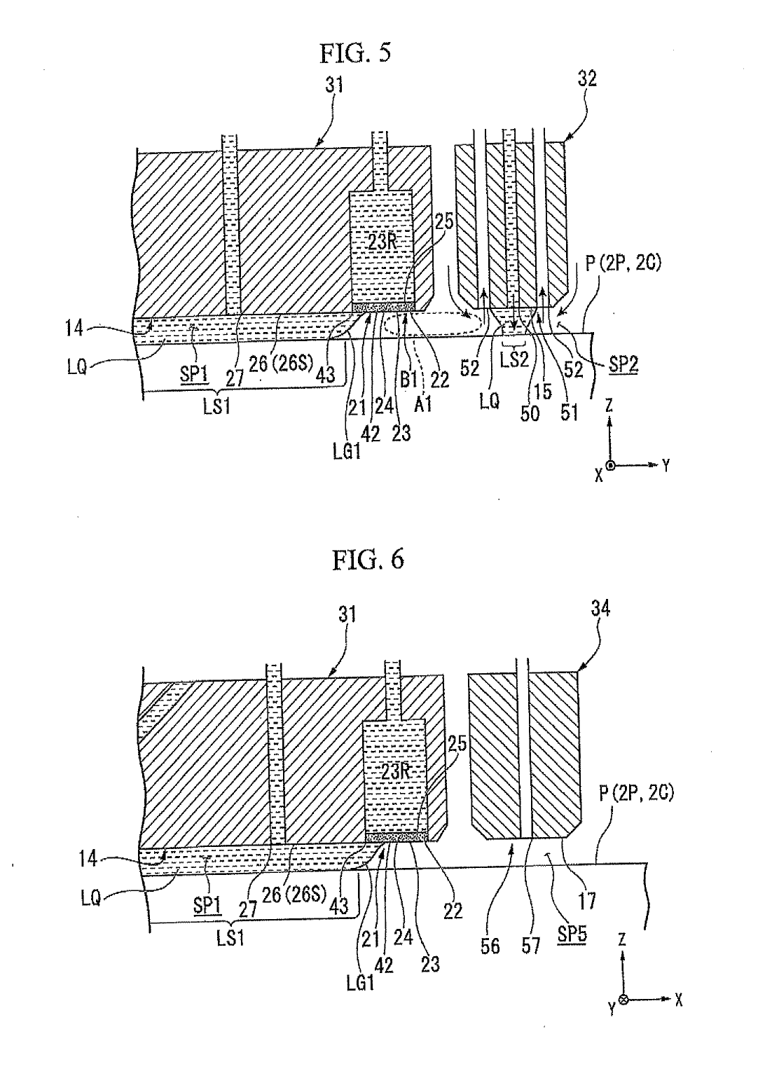

Next, the liquid immersion member 3 according to the present embodiment will be explained. FIG. 2 is a side cross sectional view that is parallel to the YZ plane and shows one example of the liquid immersion member 3 according to the present embodiment; FIG. 3 is a side cross sectional view that is parallel to the XZ plane and shows one example of the liquid immersion member 3 according to the present embodiment; FIG. 4 is a diagram of the liquid immersion member 3, viewed from the lower side (i.e., the −Z side); FIG. 5 is a partial enlarged view of FIG. 2; and FIG. 6 is a partial enlarged view of FIG. 3.

The liquid immersion member 3 is disposed at least partly around the last optical element 8 and the optical path K of the exposure light EL wherethrough the liquid LQ between the last optical element 8 and the object disposed in the projection area PR passes.

In the present embodiment, the object that is capable of being disposed in the projection area PR includes at least one of the following: the substrate stage 2P (i.e., the cover member T), the substrate P, which is held by the substrate stage 2P (i.e., the substrate holding part 10), and the measurement stage 2C. In an exposure of the substrate P, the first immersion space LS1 is formed such that the optical path K of the exposure light EL radiated to the substrate P is filled with the liquid LQ. When the substrate P is being irradiated with the exposure light EL, the first immersion space LS1 is already formed such that only part of the area of the front surface of the substrate P, which includes the projection area PR, is covered with the liquid LQ.

In the present embodiment, the liquid immersion member 3 comprises: the first liquid immersion member 31, which is disposed at least partly around the optical path K of the exposure light EL wherethrough the liquid LQ between the last optical element 8 and the object disposed in the projection area PR passes, that forms the first immersion space LS1 of the liquid LQ at the emergent surface 7 side of the last optical element 8 such that the optical path K of the exposure light EL between the last optical element 8 and the object is filled with the liquid LQ; a guide part 40, which guides at least some of the liquid LQ in the first immersion space LS1 to a first guide space A1, which extends partly around the optical path K; and the second liquid immersion member 32, which is disposed at the outer side of the first liquid immersion member 31 with respect to the optical path K and forms the second immersion space LS2 of the liquid LQ partly around the first immersion space LS1 and adjacent to the first guide space A1.

In the present embodiment, the guide part 40 guides at least some of the liquid LQ in the first immersion space LS1 to a second guide space A2, which extends partly around the optical path. K and is different from the first guide space A1.

Furthermore, in the present embodiment, “around the optical path K” includes a space (i.e., an area) that extends in the peripheral directions of the optical path K. In other words, “around the optical path K” includes a ring shaped space (i.e., an area) that surrounds the optical path K. In the present embodiment, a space that extends partly around the optical path K is referred to as “part of the ring shaped space surrounding the optical path K.” Furthermore, a space that extends around the optical path K can also be referred to as “a space around the optical axis AX of the projection optical system PL.” A space that extends partly around the optical path K can also be referred to as “part of the ring shaped space that extends in the peripheral directions of the optical axis AX”

In addition, in the present embodiment, the liquid immersion member 3 comprises the third liquid immersion member 33, which is disposed at the outer side of the first liquid immersion member 31 with respect to the optical path K and forms the third immersion space LS3 of the liquid LQ, which is different from the second immersion space LS2, partly around the first immersion space LS1 and adjacent to the second guide space A2.

In the present embodiment, the first liquid immersion member 31 and the second liquid immersion member 32 are different members and are spaced apart. The first liquid immersion member 31 and the third liquid immersion member 33 are different members and are spaced apart. The second liquid immersion member 32 and the third liquid immersion member 33 are different members and are spaced apart.

In the present embodiment, the exposure apparatus EX comprises a support member (not shown), which supports the first liquid immersion member 31, the second liquid immersion member 32, and the third liquid immersion member 33. In the present embodiment, the first liquid immersion member 31, the second liquid immersion member 32, and the third liquid immersion member 33 are supported by one support member (i.e., a frame member). Furthermore, the support member may be connected to a support mechanism that supports the projection optical system PL, or may be spaced apart from the support mechanism. Furthermore, the support member that supports the first liquid immersion member 31 and the support member that supports the second liquid immersion member 32 may be different members. The support member that supports the second liquid immersion member 32 and the support member that supports the third liquid immersion member 33 may be different members.

In addition, in the present embodiment, the liquid immersion member 3 comprises a first recovery member 34 and a second recovery member 35, which are disposed at the outer side of the first liquid immersion member 31 with respect to the optical path K and are capable of recovering a fluid.

The first liquid immersion member 31 has a lower surface 14, which the object (e.g., a substrate) disposed in the projection area PR is capable of opposing. The second liquid immersion member 32 has a lower surface 15, which the object (e.g., a substrate) disposed in the projection area PR is capable of opposing. The Third liquid immersion member 33 has a lower surface 16, which the object (e.g., a substrate) disposed in the projection area PR is capable of opposing. The first recovery member 34 has a lower surface 17, which the object (e.g., a substrate) disposed in the projection area PR is capable of opposing. The second recovery member 35 has a lower surface 18, which the object (e.g., a substrate) disposed in the projection area PR is capable of opposing.

In the present embodiment, the first liquid immersion member 31 is annular. In the present embodiment, part of the first liquid immersion member 31 is disposed around the last optical element 8. In addition, in the present embodiment, part of the first liquid immersion member 31 is disposed around the optical path K of the exposure light EL between the last optical element 8 and the object. The first immersion space L81 is formed such that the optical path K of the exposure light L between the last optical element 8 and the object (e.g., a substrate) disposed in the projection area PR is filled with the liquid LQ.

Furthermore, the first immersion member 31 does not have to be annular. For example, the first immersion member 31 may be disposed partly around the last optical element 8 and the optical path K. In addition, the first liquid immersion member 31 does not have to be disposed at least partly around the last optical element 8. For example, the first liquid immersion member 31 may be disposed at least partly around the optical path K between the emergent surface 7 and the object and not around the last optical element 8. In addition, the first liquid immersion member 31 does not have to be disposed at least partly around the optical path K between the emergent surface 7 and the object. For example, the first liquid immersion member 31 may be disposed at least partly around the last optical element 8 and not around the optical path K between the emergent surface 7 and the object.

In the present embodiment, the first liquid immersion member 31 comprises a plate part 311, at least part of which is disposed such that it opposes the emergent surface 7, and a main body part 312, at least part of which is disposed such that it opposes a side surface 8F of the last optical element 8. Furthermore, the side surface 8F is disposed around the emergent surface 7. In the present embodiment, the side surface 8F is inclined upward toward the outer side in radial directions with respect to the optical path K. Furthermore, the radial directions with respect to the optical path K include the radial directions with, respect to the optical axis AX of the projection optical system PL as well as the directions perpendicular to the Z axis.

In the present embodiment, the first liquid immersion member 31 has an upper surface 19, at least part of which opposes the emergent surface 7. The upper surface 19 is disposed in the plate part 311. In addition, the first liquid immersion member 31 has a hole 20 (i.e., an opening) that the emergent surface 7 faces. The exposure light EL that emerges from the emergent surface 7 can be radiated through the hole 20 to the substrate P. The upper surface 19 is disposed around an upper end of the hole 20. The lower surface 14 is disposed around a lower end of the hole 20. The hole 20 is formed such that it connects the upper surface 19 and the lower surface 14. Alternatively, in the embodiment, the upper surface 19 can be substantially perpendicular to the optical axis AX, or can be inclined with respect to a surface perpendicular to the optical axis AX. In one example, the upper surface 19 can be upwardly inclined toward the outer side in a radial direction with respect to the optical axis AX.

The first liquid immersion member 31 is capable of holding the liquid LQ between the lower surface 14 and the object. The first liquid immersion member 31 holds the liquid LQ between itself and the object and thereby forms the first immersion space LS1 at the emergent surface 7 side such that the optical path K is filled with the liquid LQ. In the present embodiment, some of the liquid LQ in the first immersion space LS1 is held between the last optical element 8 and the object (e.g., the substrate P) disposed such that it opposes the emergent surface 7 of the last optical element 8. In addition, some of the liquid LQ in the first immersion space LS1 is held between the first liquid immersion member 31 and the object disposed such that it opposes the lower surface 14 of the first liquid immersion member 31. Holding the liquid LQ between the emergent surface 7 and the lower surface 14 on one side and the front surface (i.e., the upper surface) of the object on the other side forms the first immersion space LS1 such that the optical path K of the exposure light EL between the last optical element 8 and the object is filled with the liquid LQ.

For example, in the exposure of the substrate P, the first liquid immersion member 31 forms the first immersion space LS1 by holding the liquid LQ between itself and the substrate P such that the optical path K of the exposure light EL radiated to the substrate P is filled with the liquid LQ. When the substrate P is being irradiated with the exposure light EL, the first immersion space LS1 is already formed such that part of the area of the front surface of the substrate P, which includes the projection area PR, is covered with the liquid LQ.

In the present embodiment, at least part of an interface LG1 (i.e., a meniscus or an edge) of the liquid LQ of the first immersion space LS1 is formed between the lower surface 14 and the front surface of the object (i.e., the substrate P). Namely, the exposure apparatus EX of the present embodiment adopts a local liquid immersion system. The outer side of the first immersion space LS1 (i.e., the outer side of the interface LG1) is a gas space.

The second liquid immersion member 32 is disposed at the outer side of the first liquid immersion member 31 with respect to the optical path K. The second liquid immersion member 32 is disposed partly around the first liquid immersion member 31. The second liquid immersion member 32 is disposed such that it opposes an outer surface of the first liquid immersion member 31. Namely, the second liquid immersion member 32 is disposed in the part of the ring shaped space that the outer surface of the first liquid immersion member 31 faces. In other words, the second liquid immersion member 32 is disposed in part of the spade around the optical path K (i.e., the first liquid immersion member 31) such that it opposes the outer surface of the first liquid immersion member 31.

The second liquid immersion member 32 is capable of holding the liquid LQ between the lower surface 15 and the object. The second liquid immersion member 32 forms the second immersion space LS2 partly around the first immersion space LS1 by holding the liquid LQ between itself and the object. The second immersion space LS2 is formed in part of the ring shaped space that the interface LG1 of the first immersion space LS1 faces. In other words, the second immersion space LS2 is formed in part of the space around the optical path K (i.e., the first immersion space LS1) such that it opposes the interface LG1 of the first immersion space LS1.

The third liquid immersion member 33 is disposed at the outer side of the first liquid immersion member 31 with respect to the optical path K. The third liquid immersion member 33 is disposed partly around the first liquid immersion member 31. The third liquid immersion member 33 is disposed such that it opposes the outer surface of the first liquid immersion member 31. Namely, the third liquid immersion member 33 is disposed in part of the ring shaped space that the outer surface of the first liquid immersion member 31 faces. In other words, the third liquid immersion member 33 is disposed in part of the space around the optical path K (i.e., the first liquid immersion member 31) such that it opposes the outer surface of the first liquid immersion member 31.

The third liquid immersion member 33 is capable of holding the liquid LQ between the lower surface 16 and the object. The third liquid immersion member 33 forms the third immersion space LS3 partly around the first immersion space LS1 by holding the liquid LQ between itself and the object. The third immersion space LS3 is formed in part of the ring shaped space that the interface LG1 of the first immersion space LS1 faces. In other words, the third immersion space LS3 is formed in part of the space around the optical path K (i.e., the first immersion space LS1) such that it opposes the interface LG1 of the first immersion space LS1.

In the present embodiment, the second immersion space LS2 and the third immersion space LS3 are formed such that they are substantially spaced apart. In addition, in the present embodiment, the second immersion space LS2 is formed substantially spaced apart from the first immersion space LS1. In addition, in the present embodiment, the third immersion space LS3 is formed substantially spaced apart from the first immersion space LS1. In one example, in a state wherein an object, which is opposing the liquid immersion member 3, is substantially stationary, the first immersion space LS1, the second immersion space LS2, and the third immersion space LS3 are formed substantially spaced apart from each other.

In the present embodiment, the second immersion space LS2 is smaller than the first immersion space LS1. The third immersion space LS3 is smaller than the first immersion space LS1. In the present embodiment, the sizes of the second immersion space LS2 and the third immersion space LS3 are substantially equal. Furthermore, the size of an immersion space can also mean the volume of the liquid that forms that immersion space. In addition, the size of an immersion space can also mean the weight of the liquid that forms that immersion space. In addition, the size of an immersion space can also mean the surface area of the immersion space within, for example, the plane (i.e., the XY plane) parallel to the front surface of the substrate P. In addition, the size of an immersion space can also mean the dimensions of the immersion space in, for example, prescribed directions (e.g., the X axial directions or the Y axial directions) within the plane (i.e., the XY plane) parallel to the front surface of the substrate P. In the present embodiment, the second immersion space LS2 and the third immersion space LS3 are smaller than the first immersion space LS1 within the plane (i.e., the XY plane) parallel to the front surface of the substrate P. Furthermore, the second immersion space LS2 may be larger or smaller than the third immersion space LS3.

In the present embodiment, the third liquid immersion member 33 is disposed at the opposite side of the optical path K to the second liquid immersion member 32. In the present embodiment, the third immersion space LS3 is formed at the opposite side of the optical path K to the second immersion space LS2.

In the present embodiment, the second liquid immersion member 32 is disposed at the +Y side of the first liquid immersion member 31. The third liquid immersion member 33 is disposed at the −Y side of the first liquid immersion member 31. In the present embodiment, the second immersion space LS2 is formed at the +Y side of the first immersion space LS1. The third immersion space LS3 is formed at the −Y side of the first immersion space LS1.

The first recovery member 34 is disposed at the outer side of the first liquid immersion member 31 with respect to the optical path K. The first recovery member 34 is disposed partly around the first liquid immersion member 31. The first recovery member 34 is disposed such that it opposes the outer surface of the first liquid immersion member 31. Namely, the first recovery member 34 is disposed in part of the ring shaped space that the outer surface of the first liquid immersion member 31 faces. In other words, the first recovery member 34 is disposed in part of the space around the optical path K (i.e., the first liquid immersion member 31) such that it opposes the outer surface of the first liquid immersion member 31.

The second recovery member 35 is disposed at the outer side of the first liquid immersion member 31 with respect to the optical path K. The second recovery member 35 is disposed partly around the first liquid immersion member 31. The second recovery member 35 is disposed such that it opposes the outer surface of the first liquid immersion member 31. Namely, the second recovery member 35 is disposed in part of the ring shaped space that the outer surface of the first liquid immersion member 31 faces. In other words, the second recovery member 35 is disposed in part of the space around the optical path K (i.e., the first liquid immersion member 31) such that it opposes the outer surface of the first liquid immersion member 31.

In the present embodiment, the second recovery member 35 is disposed at the opposite side of the optical path K to the first recovery member 34.

In the present embodiment, the first recovery member 34 is disposed at the +X side of the first liquid immersion member 31. The second recovery member 35 is disposed at the −X side of the first liquid immersion member 31.

The guide part 40 is capable of guiding at least some of the liquid LQ in the first immersion space LS1 to the first guide space A1. In addition, the guide part 40 is capable of guiding at least some of the liquid LQ in the first immersion space LS1 to the second guide space A2.

The first guide space A1 is part of the space around the optical path K. The second guide space A2 is part of the space around the optical path K. In the present embodiment, the first guide spate A1 and the second guide space A2 are spaced apart.

In the present embodiment, the first guide space A1 includes part of a space SP1 (i.e., a portion) between the lower surface 14 of the first liquid immersion member 31 and the front surface of the object. The lower surface 14 faces the space SP1. The second guide space A2 includes part of the space SP1 (i.e., a portion). Alternatively, in the embodiment, the first guide space A1 and/or the second guide space A2 can be that not having a part of the space SP (i.e., a portion) between the lower surface 14 of the first liquid immersion member 31 and the front surface of the object.

In the present embodiment, the first guide space A1 includes a space between a first portion B1 (i.e., a first area) of the lower surface 14 and the object The second guide space A2 includes a space between a second portion B2 (i.e., a second area) of the lower surface 14 and the object. The first portion B1 and the second portion B2 are spaced apart. The first guide space A1 is adjacent to the first portion B1. The second guide space A2 is adjacent to the second portion B2.

In the present embodiment, the first guide space A1 includes a space between part of a peripheral edge part 36 of the first liquid immersion member 31 and the object. The second guide space A2 includes a space between part of the peripheral edge part 36 of the first liquid immersion member 31 and the object.

The peripheral edge part 36 of the first liquid immersion member 31 includes a peripheral edge part of the lower surface 14. The first guide space A1 includes a space between the object and the first portion B1, which is defined as part of the peripheral edge part 36 of the lower surface 14. The second guide space A2 includes a space between the object and the second portion B2, which is defined as part of the peripheral edge part 36 of the lower surface 14.

In the present embodiment, the second guide space A2 is disposed at the opposite side of the optical path K to the first guide space A1. In the present embodiment, the first guide space A1 is the part of the space SP1 around the optical path K that is at the +Y side of the optical path K. The second guide space A2 is the part of the space SP1 around the optical path. K that is at the −Y side of the optical path K.

Namely, in the present embodiment, the second portion B2 is disposed at the opposite side of the optical path. K to the first portion B1. In the present embodiment, the first portion B1 is the part of the area of the lower surface 14 at the +Y side of the optical path K. The second portion B2 is the part of the area of the lower surface 14 at the −Y side of the optical path. K.

Furthermore, the first guide space A1 or the second guide space A2, or both, do not have to be a space between part of the peripheral edge part 36 of the lower surface 14 and the object. For example, the first guide space A1 or the second guide apace A2, or both, may be a space between part of an area at the inner side of the peripheral edge part 36 of the lower surface 14 and the object. For example, the first guide space A1 or the second guide space A2, or both, may be a space between part of a center part of the lower surface 14 and the object. Namely, the first portion 131 and the second portion B2 of the lower surface 14, or both, may be defined as an area other than the peripheral edge part 36 of the lower surface 14. For example, the first portion B1 or the second portion B2, or both, may be defined as the inner side of the peripheral edge part 36, or as, for example, the center part of the lower surface 14.

In the present embodiment, the first guide space A1 is defined as the space between the second immersion space LS2, which is formed by the second liquid immersion member 32, and the optical path K. In the present embodiment, the second liquid immersion member 32 is disposed such that at least part thereof is adjacent to the first guide space A1. The second liquid immersion member 32 is disposed in the vicinity of the first guide space A1 such that it is adjacent to the first guide space A1 (i.e., the first portion B1) at the outer side of the first guide space A1 (i.e., the first portion B1) with respect to the optical path K. The first guide space A1 is formed such that it includes, for example, a virtual line that connects the optical path. K and the second immersion space LS2 (Lee, the second liquid immersion member 32).

In the present embodiment, the second guide space A2 is defined as the space between the third immersion space LS3, which is formed by the third liquid immersion member 33, and the optical path K. In the present embodiment, the third liquid immersion member 33 is disposed such that at least part thereof is adjacent to the second guide space A2. The third liquid immersion member 33 is disposed in the vicinity of the second guide space A2 such that it is adjacent to the second guide space A2 (i.e., the second portion B2) at the outer side of the second guide space A2 (i.e., the second portion B2) with respect to the optical path. K. The second guide space A2 is formed such that it includes, for example, a virtual line that connects the optical path K and the third immersion space LS3 (i.e., the third liquid immersion member 33).

Furthermore, the first guide space A1 or the second guide space A2, or both, may include the space at the outer side of the space SP1 between the lower surface 14 and the object. For example, the first guide space A1 may include at least part of a space SP2 between the lower surface 15 of the second liquid immersion member 32 and the front surface of the object. In addition, the second guide space A2 may include at least part of a space SF3 between the lower surface 16 of the third liquid immersion member 33 and the front surface of the object. In addition, the first guide space A1 may include a space below a gap between the outer surface of the first liquid immersion member 31 and an inner surface of the second liquid immersion member 32. In addition, the second guide space A2 may include a space below a gap between the outer surface of the first liquid immersion member 31 and the inner surface of the third liquid immersion member 33.

In the present embodiment, at least part of the guide part 40 is disposed in the first liquid immersion member 31. In the present embodiment, at least part of the guide part 40 is disposed in the lower surface 14 of the first liquid immersion member 31, which the object is capable of opposing. The guide part 40 can guide at least some of the liquid LQ in the first immersion space LS1 between the lower surface 14 and the object to the first guide space A1 or the second guide space A2, or both.

In the present embodiment, the guide part 40 includes, for example, an edge 41 of the first liquid immersion member 31. The edge 41 of the first liquid immersion member 31 includes an edge of the peripheral edge part 36. In addition, the edge 41 of the first liquid immersion member 31 includes an edge of the lower surface 14. The edge 41 of the first liquid immersion member 31 is capable of guiding at least some of the liquid LQ in the first immersion space LS1 to the first guide space A1 or the second guide space A2, or both.

At least some of the liquid LQ in the first immersion space LS1 is guided to the edge 41 of the first liquid immersion member 31 and then flows toward the first guide space A1 or the second guide space A2, or both.

In the present embodiment, the first liquid immersion member 31 comprises a liquid recovery part 21, which is disposed such that the object opposes it and is capable of recovering the liquid LQ. In the present embodiment, the guide part 40 includes at least part of the liquid recovery part 21.

In the present embodiment, the main body part 312 has an internal space 23R, at the lower end of which an opening 22 is formed. The first liquid immersion member 31 comprises a porous member 24, which is disposed in the opening 22. The opening 22 is formed such that it faces the space SP1. The porous member 24 is disposed such that it faces the space SP1. The porous member 24 has a plurality of holes (i.e., openings or pores) wherethrough the liquid LQ is capable of circulating. A mesh filter, which is a porous member wherein numerous small holes are formed as a mesh, may be disposed in the opening 22.

The liquid recovery part 21 includes at least part of a lower surface 42 of the porous member 24, which is disposed such that the object opposes such. In the present embodiment, the porous member 24 is plate shaped. The porous member 24 has the lower surface 42, which faces the space SP1, an upper surface 25, which faces the internal space 23R, and a plurality of holes, which are formed such that they connect the upper surface 25 and the lower surface 42. The liquid recovery part 21 is capable of recovering the liquid LQ (i.e., the liquid LQ in the space SP1) on the object, which the lower surface 42 opposes, via the holes of the porous member 24. In the present embodiment, the holes of the porous member 24 function as a recovery port 23, which is capable of recovering the liquid LQ in the space SP1. The liquid LQ recovered via the holes of the porous member 24 (i.e., the recovery port 23) flows through the internal space 23R (i.e., the recovery passageway).

In the present embodiment, substantially only the liquid LQ is recovered via the porous member 24, and gas is not recovered. The control apparatus 4 adjusts the difference between the pressure on the lower surface 42 side of the porous member 24 (i.e., the pressure in the space SP1) and the pressure on the upper surface 25 side of the porous member 24 (i.e., the pressure in the recovery passageway 23k) such that the liquid LQ in the space SP1 passes through the holes of the porous member 24 and flows into the recovery passageway 23R, while the gas does not. Furthermore, one example of a technology that recovers only a liquid via a porous member is disclosed in, for example, U.S. Pat. No. 7,292,313.

Furthermore, both the liquid LQ and the gas may be recovered via the porous member 24.

In the present embodiment, the guide part 40 includes at least part of the lower surface 42 of the porous member 24. The lower surface 42 of the porous member 24 is capable of guiding at least some of the liquid LQ in the first immersion space LS1 to the first guide space A1 or the second guide space A2, or both.

At least some of the liquid LQ in the first immersion space LS1 is guided to the lower surface 42 of the porous member 24 and then flows toward the first guide space A1 or the second guide space A2, or both.

In addition, in the present embodiment, the first liquid immersion member 31 comprises a flat part 265, which adjoins the liquid recovery part 21 and is disposed such that the object opposes the flat part 265. In the present embodiment, the guide part 40 includes a boundary 43 between the liquid recovery part 21 and the flat part 26S.

In the present embodiment, the fiat part 265 includes a lower surface 26, which is disposed such that it adjoins the lower surface 42 of the porous member 24. At least part of the lower surface 26 is flat. The lower surface 26 is capable of holding the liquid LQ between itself and the object such that the liquid LQ cannot circulate. In the present embodiment, the lower surface 14 of the first liquid immersion member 31 includes the lower surface 42 of the porous member 24 and the lower surface 26. In the present embodiment, the boundary 43 includes a boundary between the lower surface 42 and the lower surface 26.

In the present embodiment, the state (i.e., the surface state) of the lower surface 42 and the state (i.e., the surface state) of the lower surface 26 are different. The lower surface 42 is disposed around the lower end of the holes of the porous member 24. The lower surface 42 is uneven. Furthermore, the contact angle of the liquid LQ with respect to the lower surface 42 and the contact angle of the liquid LQ with respect to the lower surface 26 may be different. For example, the contact angle of the liquid LQ with respect to the lower surface 42 may be smaller than the contact angle of the liquid LQ with respect to the lower surface 26. Furthermore, the contact angle of the liquid LQ with respect to the lower surface 42 may be larger than the contact angle of the liquid LQ with respect to the lower surface 26. Furthermore, the contact angle of the liquid LQ with respect to the lower surface 42 may be equal to the contact angle of the liquid LQ with respect to the lower surface 26.

The boundary 43 is capable of guiding at least some of the liquid LQ in the first immersion space LS1 to the first guide space A1 or the second guide space A2, or both. Alternatively, the height of the lower surface 42 can be different from the height of the lower surface 26. In other words, the boundary 43 can include a step configuration.

At least some of the liquid LQ in the first immersion space LS1 is guided to the boundary 43 and then flows toward the first guide space A1 or the second guide space A2, or both.

In the present embodiment, the peripheral edge part 36 of the first liquid immersion member 31 comprises the liquid recovery part 21. In the present embodiment, the peripheral edge part 36 includes the lower surface 42 of the porous member 24. In the present embodiment, the edge 41 includes an edge of the lower surface 42 of the porous member 24. Furthermore, the edge 41 may include an edge of the main body part 312.

In the present embodiment, the lower surface 26 is disposed at a position that is closer to the optical path K than the lower surface 42 is. In the present embodiment, the lower surface 42 is disposed at least partly around the lower surface 26. In the present embodiment, the lower surface 26 is disposed around the lower end of the opening 20. The lower surface 42 is disposed around the lower surface 26.

In the present embodiment, the first guide space A1 includes a space between at least part of the liquid recovery part 21 and the object. In the present embodiment, the first portion B1 includes part of the area of the lower surface 42 of the porous member 24, and the first guide space A1 includes a space between at least part of the lower surface 42 of the porous member 24 and the object.

In the present embodiment, the second guide space A2 includes a space between at least part of the liquid recovery part 21 and the object. In the present embodiment, the second portion B2 includes part of the area of the lower surface 42 of the porous member 24, and the second guide space A2 includes a space between at least part of the lower surface 24 of the porous member 24 and the object.

In the present embodiment, the edge 41 includes a portion 41A and a portion 41B, which extend linearly toward the first guide space A1, and a portion 41C and a portion 41D, which extend linearly toward the second guide space A2.

In addition, in the present embodiment, the lower surface 42 of the porous member 24 includes a portion 42A and a portion 42B, which extend in strips toward the first guide space A1, and a portion 42C and a portion 42D, which extend in strips toward the second guide space A2.

In addition, in the present embodiment, the boundary 43 includes a portion 43A and a portion 43B, which extend linearly toward the first guide space A1, and a portion 43C and a portion 43D, which extend linearly toward the second guide space A2.

In the present embodiment, the portion 41A of the edge 41 is disposed such that it extends, within a plane (i.e., the XY plane) that is substantially parallel to the front surface of the object, from the +X side of an axis J2, which passes through the space SP2, toward the first guide space A1. The portion 41B of the edge 41 is disposed such that it extends, within a plane (i.e., the XY plane) that is substantially parallel to the front surface of the object, from the −X side of the axis J2, which passes through the space SP2, toward the first guide space A1.

The axis J2 is a virtual axis (i.e., a virtual line) that passes through the space SP2. The axis J2 that passes through the space SP2 passes through the second immersion space LS2. The axis J2 connects, within the XY plane, the optical path K and the space SP2 (i.e., the second immersion space LS2). The axis J2 connects, for example, the optical path K and the center of the space SP2 (i.e., the second immersion space LS2) in the X axial directions. In the present embodiment, the axis J2 is substantially parallel to the Y axis.

In the present embodiment, within the plane (i.e., within the XY plane) that is substantially parallel to the object, a spacing between the portion 41A and the portion 41B in the directions (i.e., the X axial directions) perpendicular to the axis J2 becomes smaller as it approaches the first guide space A1.

In addition, in the present embodiment, the spacing between the portion 41A and the portion 418 becomes smaller as it becomes more spaced apart from the optical path K.

In the present embodiment, the portion 42A of the lower surface 42 is disposed such that it extends, within the plane (i.e., within the XY plane) that is substantially parallel to the front surface of the object, from the +X side of the axis J2 toward the first guide space A1. The portion 428 of the lower surface 42 is disposed such that it extends, within the plane (i.e., within the XY plane) that is substantially parallel to the front surface of the object, from the −X side of the axis J2 toward the first guide space A1.

In the present embodiment, within the plane (i.e., within the XY plane) that is substantially parallel to the object, the spacing between the portion 42A and the portion 42B in the directions (i.e., the X axial directions) perpendicular to the axis J2 becomes smaller as it approaches the first guide space A1.

In addition, in the present embodiment, the spacing between the portion 42A and the portion 42B becomes smaller as it becomes more spaced apart from the optical path K.

In the present embodiment, the portion 43A of the boundary 43 is disposed such that it extends, within the plane (i.e., within the XY-plane) that is substantially parallel to the front surface of the object, from the +X side of the axis J2 toward the first guide space A1. The portion 43B of the boundary 43 is disposed such that it extends, within the plane (i.e., within the XY plane) that is substantially parallel to the front surface of the object, from the −X side of the axis J2 toward the first guide space A1.

In the present embodiment, within the plane (i.e., within the XY plane) that is substantially parallel to the object, the spacing between the portion 43A and the portion 43B in the directions (i.e., the X axial directions) perpendicular to the axis J2 becomes smaller as it approaches the first guide space A1.

In addition, in the present embodiment, the spacing between the portion 43A and the portion 43B becomes smaller as it becomes more spaced apart from the optical path K.

In the present embodiment, the portion 41C of the edge 41 is disposed such that it extends, within the plane (i.e., within the XY plane) that is substantially parallel to the front surface of the object, from the +X side of an axis J3, which passes through the space SP3, toward the second guide space A2. The portion 41D of the edge 41 is disposed such that it extends, within the plane (i.e., within the XV plane) that is substantially parallel to the front surface of the object, from the −X side of the axis J3, which passes through the space SP3, toward the second guide space A2.

The axis J3 is a virtual axis (i.e., a virtual line) that passes through the space SP3. The axis J3, which passes through the space SP3, passes Through the third immersion space LS3. The axis J3 connects, within the XY plane, the optical path K and the space SP3 the third immersion space LS3). The axis J3 connects, for example, the optical path K and the center of the space SP3 (i.e., the third immersion space LS3) in the X axial directions. In the present embodiment, the axis J3 is substantially parallel to the Y axis.

In the present embodiment, within the plane (i.e., within the XY plane) that is substantially parallel to the object, the spacing between the portion 41C and the portion 41D in the directions (i.e., the X axial directions) perpendicular to the axis J3 becomes smaller as it approaches the second guide space A2.

In addition, in the present embodiment, the spacing between the portion 41C and the portion 41D becomes smaller as it becomes more spaced apart from the optical path K.

In the present embodiment, the portion 42C of the lower surface 42 is disposed such that it extends, within the plane (i.e., within the XY plane) that is substantially parallel to the front surface of the object, from the +X side of the axis J3 toward the second guide space A2. The portion 42D of the lower surface 42 is disposed such that it extends, within the plane within the XY plane) that is substantially parallel to the front surface of the object, from the −X side of the axis J3 toward the second guide space A2.

In the present embodiment, within the plane (i.e., within the XY plane) that is substantially parallel to the object, the spacing between the portion 42C and the portion 42D in the directions (i.e., the X axial directions) perpendicular to the axis J3 becomes smaller as it approaches the second guide space A2.

In addition, in the present embodiment, the spacing between the portion 42C and the portion 42D becomes smaller as it becomes more spaced apart from the optical path K.

In the present embodiment, the portion 43C of the boundary 43 is disposed such that it extends, within the plane (i.e., within the XY plane) that is substantially parallel to the front surface of the object, from the +X side of the axis J3 toward the second guide space A2. The portion 43D of the boundary 43 is disposed such that it extends, within the plane (i.e., within the XY plane) that is substantially parallel to the front surface of the object, such that it extends from the −X side of the axis J3 toward the second guide space A2.

In the present embodiment, within the plane (i.e., within the XY plane) that is substantially parallel to the object, the spacing between the portion 43C and the portion 43D in the directions (i.e., the X axial directions) perpendicular to the axis J3 becomes smaller as it approaches the second guide space A2.

In addition, in the present embodiment, the spacing between the portion 43C and the portion 431D becomes smaller as it becomes more spaced apart from the optical path K.

In the present embodiment, the external shape of the lower surface 14 is substantially a quadrangle. Furthermore, as shown in FIG. 4 and the like, in the present embodiment, the angles (i.e., the vertices) of the lower surface 14, whose external shape is a quadrangle, are rounded. In the present embodiment, the angles of the lower surface 14 are disposed at the +Y side, the −Y side, the +X side, and the −X side of the optical path K. In the present embodiment, the first portion B1 includes the angle at the +Y side of the lower surface 14, and the second portion B2 includes the angle at the −Y side of the lower surface 14.

In the present embodiment, the first liquid immersion member 31 has supply ports 27, which are capable of supplying the liquid LQ and disposed such that the object opposes them. The supply ports 27 are disposed in at least part of the lower surface 14 of the first liquid immersion member 31 such that they face the space SP1. In the present embodiment, the supply ports 27 are capable of supplying the liquid LQ to the space SP1.

In the present embodiment, the supply ports 27 are disposed in the lower surface 26. The lower surface 26 is disposed around the supply ports 27. In the present embodiment, a plurality of the supply ports 27 is disposed around the optical path K the opening 20).

The liquid recovery part 21 is disposed at the outer side of the supply ports 27 in the radial directions with respect to the optical path K. In the present embodiment, the supply ports 27 are disposed adjacent to the liquid recovery part 21. The plurality of the supply ports 27 is disposed along the inner side edge of the lower surface 42 of the porous member 24.

In addition, the first liquid immersion member 31 has supply ports 28, which are capable of supplying the liquid W. The supply ports 28 are disposed in at least part of an inner side surface of the first liquid immersion member 31 such that they face a space SP4, which the emergent surface 7 faces. In the present embodiment, the supply ports 28 are capable of supplying the liquid LQ to the space SP4. The space SP4 includes the space between the emergent surface 7 and the upper surface 19. In the present embodiment, a plurality of the supply parts 28 is disposed around the optical path K (i.e., the space SP4). Furthermore, the supply ports 28 may be disposed such that they oppose the side surface 8F of the last optical element 8.

The supply ports 28 are connected to a liquid supply apparatus 28S, which is capable of supplying the liquid LQ, via supply passageways 28R, which are formed inside the first liquid immersion member 31. The liquid supply apparatus 28S is capable of supplying the liquid LQ, which is clean and temperature adjusted. The supply ports 28 supply the liquid LQ from the liquid supply apparatus 28S to the space SP4. At least some of the liquid LQ supplied via the supply ports 28 to the space SP4 flows to the space SP1 via the opening 20.

The supply ports 27 are connected to a liquid supply apparatus 27S, which is capable of supplying the liquid LQ, via supply passageways 27R, which are formed inside the first liquid immersion member 31. The liquid supply apparatus 27S is capable of supplying the liquid LQ, which is clean and temperature adjusted. The supply ports 27 supply the liquid. LQ from the liquid supply apparatus 27S to the space SP1.

At least some of the liquid LQ in the space SP1 is recovered via the holes of the porous member 24. As discussed above, in the present embodiment, the holes of the porous member 24 function as the recovery port 23, which is capable of recovering the liquid LQ from the space SP1. The recovery port 23 is connected to a liquid recovery apparatus 23C, which is capable of recovering (i.e., by suction) the liquid LQ via the recovery passageway 23R, which is formed inside the first liquid immersion member 31. The liquid recovery apparatus 23C comprises, for example, a vacuum system and is capable of recovering (i.e., by suction) the liquid LQ.

The liquid supply apparatus 278, the liquid supply apparatus 288, and the liquid recovery apparatus 23C are controlled by the control apparatus 4. In the present embodiment, the first immersion space LS1 is formed with the liquid LQ between the last optical element 8 and the first liquid immersion member 31 on one side and the object on the other side by recovering the liquid LQ via the recovery port 23 in parallel with supplying the liquid LQ via the supply ports 28. In addition, in the present embodiment, the supply of the liquid LQ via the supply ports 28, the recovery of the liquid LQ via the recovery port 23, and the supply of the liquid LQ via the supply ports 27 are performed in parallel. In the present embodiment, the first immersion space LS1 is formed with the liquid LQ, which is supplied via the supply ports 28. In addition, in the present embodiment, the first immersion space LS1 is formed with the liquid LQ supplied via the supply ports 27.

The second liquid immersion member 32 has a supply port 50, which is capable of supplying the liquid LQ. In the present embodiment, the object is capable of opposing the supply port 50. The supply port 50 is disposed in at least part of the lower surface 15 of the second liquid immersion member 32 such that it faces the space SP2. In the present embodiment, the supply port 50 is capable of supplying the liquid LQ to the space SP2. In the present embodiment, the axis J2 passes through the supply port 50.

The second liquid immersion member 32 comprises a fluid recovery part 51, which is capable of recovering the fluid. The fluid includes the liquid or the gas, or both. In the present embodiment, the object is capable of opposing the fluid recovery part 51. The fluid recovery part 51 is disposed in at least part of the lower surface 15 of the second liquid immersion member 32 such that it faces the space SP2. In the present embodiment, the fluid recovery part 51 is capable of recovering the liquid LQ from the space SP2. In addition, the fluid recovery part 51 is capable of recovering the gas from the space SP2. In the present embodiment, the fluid recovery part 51 includes a recovery port 52, which is disposed in at least part of the lower surface 15 such that it faces the space SP2.

In the present embodiment, at least part of the fluid recovery part 51 (i.e., the recovery port 52) is disposed at the outer side of the first liquid immersion member 31 in the radial directions with respect to the optical path K. In the present embodiment, at least part of the fluid recovery part 51 (i.e., the recovery port 52) is disposed between the first liquid immersion member 31 and the supply port 50. In addition, in the present embodiment, at least part of the fluid recovery part 51 (i.e., the recovery port 52) is disposed at the outer side of the first portion 131 in the radial directions with respect to the optical path K.

In the present embodiment, at least part of the fluid recovery part 51 (i.e., the recovery port 52) is disposed at the outer side of the supply port 50 with respect to the first liquid immersion member 31. In the present embodiment, at least part of the fluid recovery part 51 (i.e., the recovery port 52) is disposed at the outer side of the supply port 50 in the radial directions with respect to the optical path K.

In the present embodiment, the axis J2 passes through the fluid recovery part 51 (i.e., the recovery port 52) between the first liquid immersion member 31 and the supply port 50. In the present embodiment, the axis J2 passes through the fluid recovery part 51 the recovery port 52) at the outer side of the supply port 50 with respect to the first liquid immersion member 31.

In the present embodiment, the fluid recovery part 51 (i.e., the recovery port 52) is provided such that it surrounds the supply port 50.

The third liquid immersion member 33 has a supply port 53, which is capable of supplying the liquid LQ. In the present embodiment, the object is capable of opposing the supply port 53. The supply port 53 is disposed in at least part of the lower surface 16 of the third liquid immersion member 33 such that it faces the space SP3. In the present embodiment, the supply port 53 is capable of supplying the liquid LQ to the space SP3. In the present embodiment, the axis J3 passes through the supply port 53. The third liquid immersion member 33 comprises a fluid recovery part 54, which is capable of recovering the fluid. The fluid includes the liquid or the gas, or both. In the present embodiment, the object is capable of opposing the fluid recovery part 54. The fluid recovery part 54 is disposed in at least part of the lower surface 16 of the third liquid immersion member 33 such that it opposes the space SP3. In the present embodiment, the fluid recovery part 54 is capable of recovering the liquid LQ from the space SP3. In addition, the fluid recovery part 54 is capable of recovering the gas from the space SP3. In the present embodiment, the fluid recovery part 54 includes a recovery port 55, which is disposed in at least part of the lower surface 16 such that it faces the space SP3.

In the present embodiment, at least part of the fluid recovery part 54 (i.e., the recovery port 55) is disposed at the outer side of the first liquid immersion member 31 in the radial directions with respect to the optical path K. In the present embodiment, at least part of the fluid recovery part 54 (i.e., the recovery port 55) is disposed between the first liquid immersion member 31 and the supply port 53. In addition, in the present embodiment, at least part of the fluid recovery part 54 (i.e., the recovery port 55) is disposed at the outer side of the second portion B2 in the radial directions with respect to the optical path K.

In the present embodiment, at least part of the fluid recovery part 54 (i.e., the recovery port 55) is disposed at the outer side of the supply port 53 with respect to the first liquid immersion member 31. In the present embodiment, at least part of the fluid recovery part 54 (i.e., the recovery port 55) is disposed at the outer side of the supply port 53 in the radial directions with respect to the optical path K.

In the present embodiment, the axis J3 passes through the fluid recovery part 54 the recovery port 55) between the first liquid immersion member 31 and the supply port 53. In the present embodiment, the axis J3 passes through the fluid recovery part 54 (i.e., the recovery port 55) at the outer side of the supply port 53 with respect to the first liquid immersion member 31.

In the present embodiment, the fluid recovery part 54 (i.e., the recovery port 55) is provided such that it surrounds the supply port 53.

In the present embodiment, the lower surface 15 is disposed such that it surrounds part of the first portion B1. The lower surface 15 has an angle at the +Y side of the lower surface 14 and has two sides h1 and two sides h2, which are substantially parallel to the sides h1, that are connected at that angle. Namely, the lower surface 15 has an external shape that follows the angle at the +Y side of the lower surface 14. The supply port 50 is slit shaped and substantially parallel to the sides h1, h2. The put of the recovery port 52 between the first liquid immersion member 31 and the supply port 50 is slit shaped and substantially parallel to the supply port 50. The part of the recovery port 52 at the outer side of the supply port 50 with respect to the first liquid immersion member 31 is slit shaped and substantially parallel to the supply port 50.

In the present embodiment, the lower surface 16 is disposed such that it surrounds part of the second portion B2. The lower surface 16 has an angle at the −Y side of the lower surface 14 and has two sides h3 and two sides h4, which are substantially parallel to the sides h3, that are connected at that angle. Namely, the lower surface 16 has an external shape that follows the angle at the −Y side of the lower surface 14. The supply port 53 is slit shaped and substantially parallel to the sides h3, h4. The part of the recovery port 55 between the first liquid immersion member 31 and the supply port 53 is slit shaped and substantially parallel to the supply port 53. The part of the recovery port 55 at the outer side of the supply port 53 with respect to the first liquid immersion member 31 is slit shaped and substantially parallel to the supply port 53.

Furthermore, a plurality of the recovery ports 52 may be disposed around the supply port 50. Namely, the recovery ports 52 may be disposed such that they are distributed around the supply port 50. In addition, a plurality of the recovery ports 55 may be disposed around the supply port 53.

The supply port 50 is connected to a liquid supply apparatus 50S, which is capable of supplying the liquid LQ, via a supply passageway 50R, which is formed inside the second liquid immersion member 32. The liquid supply apparatus 50S is capable of supplying the liquid LQ, which is clean and temperature adjusted. The supply port 50 supplies the liquid LQ from the liquid supply apparatus 50S to the space SP2.

At least some of the liquid LQ is recovered from the space SP2 via the fluid recovery part 51 (i.e., the recovery port 52). The fluid recovery part 51 (i.e., the recovery port 52) of the second liquid immersion member 32 is capable of recovering the liquid LQ from the space SP1 between the first liquid immersion member 31 and the object.

The recovery port 52 is connected to a liquid recovery apparatus 52C, which is capable of recovering (i.e., by suction) the liquid LQ via a recovery passageway 52R, which is formed inside the second liquid immersion member 32. The liquid recovery apparatus 52C comprises, for example, a vacuum system and is capable of recovering (i.e., by suction) the liquid LQ. In addition, the recovery port 52 is also capable of recovering the gas from the space SP2.

The supply port 53 is connected to a liquid supply apparatus 53S, which is capable of supplying the liquid LQ, via a supply passageway 53R, which is formed inside the third liquid immersion member 33. The liquid supply apparatus 53S is capable of supplying the liquid LQ, which is clean and temperature adjusted. The supply port 53 supplies the liquid LQ from the liquid supply apparatus 53S to the space SP3.

At least some of the liquid LQ is recovered from the space SP3 via the fluid recovery part 54 (i.e., the recovery port 55). The fluid recovery part 54 (i.e., the recovery port 55) of the third liquid immersion member 33 is capable of recovering the liquid LQ from the space SP1 between the first liquid immersion member 31 and the object.

The recovery port 55 is connected to a liquid recovery apparatus 55C, which is capable of recovering (i.e., by suction) the liquid LQ, via a recovery passageway 55R, which is formed inside the third liquid immersion member 33. The liquid recovery apparatus 55C comprises, for example, a vacuum system, and is capable of recovering (i.e., by suction) the liquid LQ. In addition, the recovery port 55 is also capable of recovering the gas from the space SP3.

In the present embodiment, the second immersion space LS2 is formed with the liquid LQ supplied via the supply port 50. In addition, in the present embodiment, the third immersion space LS3 is formed with the liquid LQ supplied via the supply port 53.

The first recovery member 34 comprises a fluid recovery part 56, which is disposed at least partly around the first liquid immersion member 31 and is capable of recovering the fluid. The fluid includes the liquid or the gas, or both. In the present embodiment, the object is capable of opposing the fluid recovery part 56. The fluid recovery part 56 is disposed in at least part of the lower surface 17 of the first recovery member 34 such that it faces a space SP5 between the lower surface 17 and the front surface of the object. In the present embodiment, the fluid recovery part 56 is capable of recovering the liquid LQ or the gas, or both, from the space SP5. In the present embodiment, the fluid recovery part 56 includes recovery ports 57, which are disposed in at least part of the lower surface 17 and such that they face the space SP5. In the present embodiment, a plurality of the recovery ports 57 is disposed in the lower surface 17.

In the present embodiment, at least part of the fluid recovery part 56 (i.e., the recovery ports 57) is disposed at the outer side of the first liquid immersion member 31 in the radial directions with respect to the optical path K. In the present embodiment, at least part of the fluid recovery part 56 (i.e., the recovery ports 57) is disposed at the outer side of the liquid recovery part 21 in the radial directions with respect to the optical path K.

In the present embodiment, the lower surface 17 is disposed such that it surrounds the angle at the +X side of the lower surface 14. The lower surface 17 has the angle at the +X side of the lower surface 14 and has two sides h5 and two sides h6, which are substantially parallel to the sides h5, that are connected at that angle. Namely, the lower surface 17 has an external shape that follows the angle at the +X side of the lower surface 14.

Furthermore, the recovery ports 57 may be slit shapes that follow along the sides h6.

The second recovery member 35 comprises a fluid recovery part 58, which is disposed at least partly around the first liquid immersion member 31 and is capable of recovering the fluid. The fluid includes the liquid or the gas, or both. In the present embodiment, the object is capable of opposing the fluid recovery part 58. The fluid recovery part 58 is disposed in at least part of the lower surface 18 of the second recovery member 35 such that it faces a space SP6 between the lower surface 18 and the front surface of the object. In the present embodiment, the fluid recovery part 58 is capable of recovering the liquid LQ or the gas, or both, from the space SP6. In the present embodiment, the fluid recovery part 58 has recovery ports 59, which are disposed in at least part of the lower surface 18 and such that they face the space SP6. In the present embodiment, a plurality of the recovery ports 59 is disposed in the tower surface 18.

In the present embodiment, at least part of the fluid recovery part 58 (i.e., the recovery ports 59) is disposed at the outer side of the first liquid immersion member 31 in the radial directions with respect to the optical path K. In the present embodiment, at least part of the fluid recovery part 58 (i.e., the recovery ports 59) is disposed at the outer side of the liquid recovery part 21 in the radial directions with respect to the optical path K.

In the present embodiment, the lower surface 18 is disposed such that it surrounds the angle at the −X side of the lower surface 14. The lower surface 18 has the angle at the X side of the lower surface 14 and has two sides h7 and two sides h8, which are substantially parallel to the sides h7, that are connected at that angle. Namely, the lower surface 18 has an external shape that follows along the angle at the −X side of the lower surface 14.

Furthermore, the recovery ports 59 may be slit shapes that follow along the sides h8.

At least some of the liquid LQ is recovered from the space SP5 via the recovery ports 57. The recovery ports 57 are capable of recovering (or suctioning) the liquid LQ from, for example, the space SP1 between the first liquid immersion member 31 and the object. The recovery ports 57 are connected to a liquid recovery apparatus 57C, which is capable of recovering (i.e., by suction) the liquid LQ, via recovery passageways 57R, which are formed inside the first recovery member 34. The liquid recovery apparatus 57C comprises, for example, a vacuum system and is capable of recovering (i.e., by suction) the liquid LQ. In addition, the recovery ports 57 are also capable of recovering the gas from the space SP5.

The first recovery member 34 has no liquid recovery port for forming a liquid immersion space between the lower surface 17 and the opposing object, so that no liquid immersion space is formed between the lower surface 17 and the opposing object and that the liquid LQ from the space SP1 is recovered via the liquid recovery ports 57. In other words, the liquid recovery ports 57 of the first recovery member 34 recover the liquid LQ being from the space SP1 and having been leaked to a space, which is a part of the space around the liquid immersion member 31 and between the second liquid immersion space LS2 and the third liquid immersion space LS3 and in which the second immersion space LS2 and the third immersion space LS3 are not formed.

At least some of the liquid LQ is recovered from the space SP6 via the recovery ports 59. The recovery ports 59 are capable of recovering (or suctioning) the liquid LQ from, for example, the space SP1 between the first liquid immersion member 31 and the object. The recovery ports 59 are connected to a liquid recovery apparatus 59C, which is capable of recovering (i.e., by suction) the liquid LQ, via recovery passageways 59R, which are formed inside the second recovery member 35. The liquid recovery apparatus 59C comprises, for example, a vacuum system and is capable of recovering (i.e., by suction) the liquid LQ. In addition, the recovery ports 59 are also capable of recovering the gas from the space SP6.

The second recovery member 35 has no liquid recovery port for forming a liquid immersion space between the lower surface 18 and the opposing object, so that no liquid immersion space is formed between the lower surface 18 and the opposing object and that the liquid LQ from the space SP1 is recovered via the liquid recovery ports 59. In other words, the liquid recovery ports 59 of the second recovery member 35 recover the liquid LQ being from the space SP1 and having been leaked to a space, which is a part of the space around the liquid immersion member 31 and between the second liquid immersion space LS2 and the third liquid immersion space LS3 and in which the second immersion space LS2 and the third immersion space LS3 are not formed.

In the present embodiment, at least part of the lower surface 14 is substantially parallel to the XY plane. In addition, in the present embodiment, at least part of the lower surface 15 is substantially parallel to the XY plane. In addition, in the present embodiment, at least part of the lower surface 16 is substantially parallel to the XY plane. In addition, in the present embodiment, at least part of the lower surface 17 is substantially parallel to the XY plane. In, addition, in the present embodiment, at least part of the lower surface 18 is substantially parallel to the XY plane.

Furthermore, at least part of the lower surface 14 may be tilted with respect to the XY plane and may include a curved surface. At least part of the lower surface 15 may be tilted with respect to the XY plane and may include a curved surface. At least part of the lower surface 16 may be tilted with respect to the XY plane and may include a carved surface. At least part of the lower surface 17 may be tilted with respect to the XY plane and may include a curved surface. At least part of the lower surface 18 may be tilted with respect to the XY plane and may include a curved surface.

In the present embodiment, the position (i.e., the height) of the lower surface 14 and the position (i.e., the height) of the lower surface 15 in the Z axial directions are substantially equal. In addition, in the present embodiment, the position (i.e., the height) of the lower surface 14 and the position (i.e., the height) of the lower surface 16 in the Z axial directions are substantially equal. In addition, in the present embodiment, the position (i.e., the height) of the lower surface 14 and the position (i.e., the height) of the lower surface 17 in the Z axial directions are substantially equal. In addition, in the present embodiment, the position (i.e., the height) of the lower surface 14 and the position (i.e., the height) of the lower surface 18 in the Z axial directions axe substantially equal.

In other words, in the present embodiment, the distance between the lower surface 14 and the front surface of the object, the distance between the lower surface 15 and the front surface of the object, the distance between the lower surface 16 and the front surface of the object, the distance between the lower surface 17 and the front surface of the object, and the distance between the lower surface 18 and the front surface of the object are substantially equal.

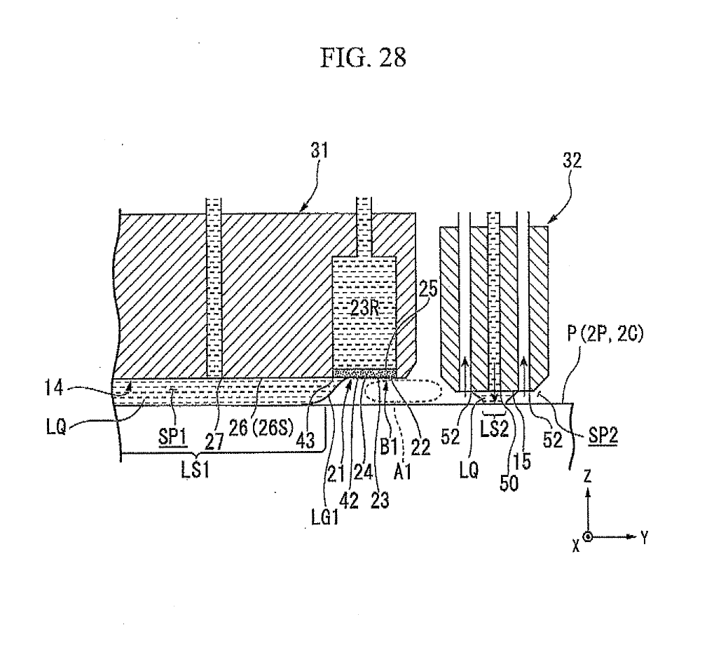

Furthermore, the height of the lower surface 14 and the height of the lower surface 15 may be different. For example, the lower surface 15 may be disposed at a higher position than the lower surface 14 is, or, as shown in FIG. 28, the lower surface 15 may be disposed at a lower position than the lower surface 14 is. Namely, the distance between the lower surface 14 and the front surface of the object may be larger or smaller than the distance between the lower surface 15 and the front surface of the object. In addition, the distance between the lower surface 14 and the front surface of the object may be larger than the distance between the lower surface 16 and the front surface of the object, or smaller than the distance between the lower surface 16 and the front surface of the object. In addition, the distance between the lower surface 14 and the front surface of the object may be larger or smaller than the distance between the lower surface 17 and the front surface of the object. In addition, the distance between the lower surface 14 and the front surface of the object may be larger or smaller than the distance between the lower surface 18 and the front surface of the object.

A method of using the exposure apparatus EX that has the configuration discussed above to expose the substrate P will now be explained.

The control apparatus 4 performs a process that loads the unexposed substrate P onto the substrate holding part 10. To load the unexposed substrate P onto the substrate holding part 10, the control apparatus 4 moves the substrate stage 2P to a substrate exchange position, which is spaced apart from the liquid immersion member 3.

Furthermore, for example, if the exposed substrate P is already held by the substrate holding part 10, then the process of loading the unexposed substrate P onto the substrate holding part 10 is performed after the process of unloading the unexposed substrate P from the substrate holding part 10 has been performed.

The substrate exchange position is a position at which the substrate P exchanging process can be performed. The substrate P exchanging process includes at least one of the following processes performed using a transport apparatus: a process that unloads the exposed substrate P, which is held by the substrate holding part 10, from the substrate holding part 10, and a process that loads the unexposed substrate P onto the substrate holding part 10. The control apparatus 4 moves the substrate stage 2P to the substrate exchange position, which is spaced apart from the liquid immersion member 3, and performs the substrate P exchanging process.

During at least part of the interval during which the substrate stage 2P is spaced apart from the liquid immersion member 3, the control apparatus 4 disposes the measurement stage 2C at a prescribed position with respect to the liquid immersion member 3 and forms the first immersion space LS1 by holding the liquid LQ between the last optical element 8 and the first liquid immersion member 31 on one side and the measurement stage 2C on the other side. Namely, the control apparatus 4 forms, using the first liquid immersion member 31, at the emergent surface 7 side of the last optical element 8, the first immersion space LS1 of the liquid LQ in the state wherein the last optical element 8 and the first liquid immersion member 31 on one side and the measurement stage 2C on the other side are opposed to one another.

The control apparatus 4 performs the recovery of the liquid LQ via the recovery port 23 in parallel with the supply of the liquid LQ via the supply ports 28. Thereby, the first immersion space LS1 is formed. In addition, in the present embodiment, the control apparatus 4 performs the supply of the liquid LQ via the supply ports 27 in parallel with the supply of the liquid LQ via the supply ports 28 and the recovery of the liquid LQ via the recovery port 23.

Supplying the LQ via the supply ports 27 adjusts, for example, the shape of the interface LG1. For example, supplying the liquid LQ via the supply ports 27 adjusts the shape of the interface LG1 in the case wherein the object has moved within the XY plane in the state wherein the first immersion space LS1 is formed between the last optical element 8 and the first liquid immersion member 31 on one side and the object on the other side.

Furthermore, in the state wherein the first immersion space LS1 is formed, the amount of the liquid supplied per unit of time via the supply ports 27 may be constant or may vary. Furthermore, the amount of the liquid supplied per unit of time via each of the supply ports 77 of the plurality of supply ports 27 may be the same or different. For example, in the state wherein the first immersion space LS1 is formed, control may be performed such that the amount of the liquid supplied per unit of time via each of the supply ports 27 of the plurality of supply ports 27 differs in accordance with the movement direction of the object (i.e., the substrate P) within the XY plane.

Furthermore, in the state wherein the first immersion space LS1 is formed by the supply of the liquid LQ via the supply ports 28 and the recovery of the liquid LQ via the recovery port 23, the supply of the liquid LQ via the supply ports 27 may be stopped. Furthermore, the supply ports 27 may be omitted.

In addition, the control apparatus 4 forms, using the second liquid immersion member 32, the second immersion space LS2 of the liquid LQ partly around the first immersion space LS1. The second immersion space LS2 is formed with the liquid LQ supplied via the supply port 50. In addition, the control apparatus 4 forms, using the third liquid immersion member 33, the third immersion space LS3 of the liquid LQ partly around the first immersion space LS1. The third immersion space LS3 is formed with the liquid LQ supplied via the supply port 53.

In addition, during at least part of the interval during which the substrate stage 2P is spaced apart from the liquid immersion member 3, the measuring process may be performed, as needed, using the ramming-member (the measuring instrument) mounted on the measurement stage 2C. When the measuring process using the measuring member (the measuring instrument) is to be performed, the control apparatus 4 causes the last optical element 8 and the first liquid immersion member 31 on one side and the measurement stage 2C on the other side to oppose one another and forms the first immersion space LS1 such that the optical path K between the last optical element 8 and the measuring member is filled with the liquid LQ. The control apparatus 4 performs the measuring process using the measuring member by radiating the exposure light EL to the measuring member through the projection optical system PL and the liquid LQ. The result of that measuring process is reflected in the exposing process to be performed on the substrate P.

After the unexposed substrate P is loaded onto the substrate holding part 10 and the measuring process that uses the measurement member (the measuring instrument) has ended, the control apparatus 4 moves the substrate stage 2P to the projection area PR and forms the first immersion space LS1 of the liquid LQ between the last optical element 8 and the first liquid immersion member 31 on, one side and the substrate stage 2P (i.e., the substrate P) on the other side.

Furthermore, during the movement of the substrate stage 2P from the substrate exchange position to the projection area PR (i.e., an exposure position), the position of the substrate P (i.e., the substrate stage 2P) may be detected using a detection system that comprises an encoder system, an alignment system, and a surface position detection system, as disclosed in, for example, U.S. Patent Application Publication No. 2007/0288121.

In the present embodiment, for example, as disclosed in U.S. Patent Application Publication No, 2006/0023186 and U.S. Patent Application Publication No. 2007/0127006, the control apparatus 4 can—in the state wherein the upper surface of the substrate stage 2P and the upper surface of the measurement stage 2C have been brought into close proximity or contact with one another such that the first immersion space LS1 of the liquid LQ continues to be formed between the last optical element 8 and the first liquid immersion member 31 on one side and the substrate stage 2P or the measurement stage 2C, or both, on the other side—move the substrate stage 2P and the measurement stage 2C within the XY plane with respect to the last optical element 8 and the liquid immersion member 3 while causing the last optical element 8 and the first liquid immersion member 31 on one side and the substrate stage 2P or the measurement stage 2C, or both, on the other side to oppose one another.

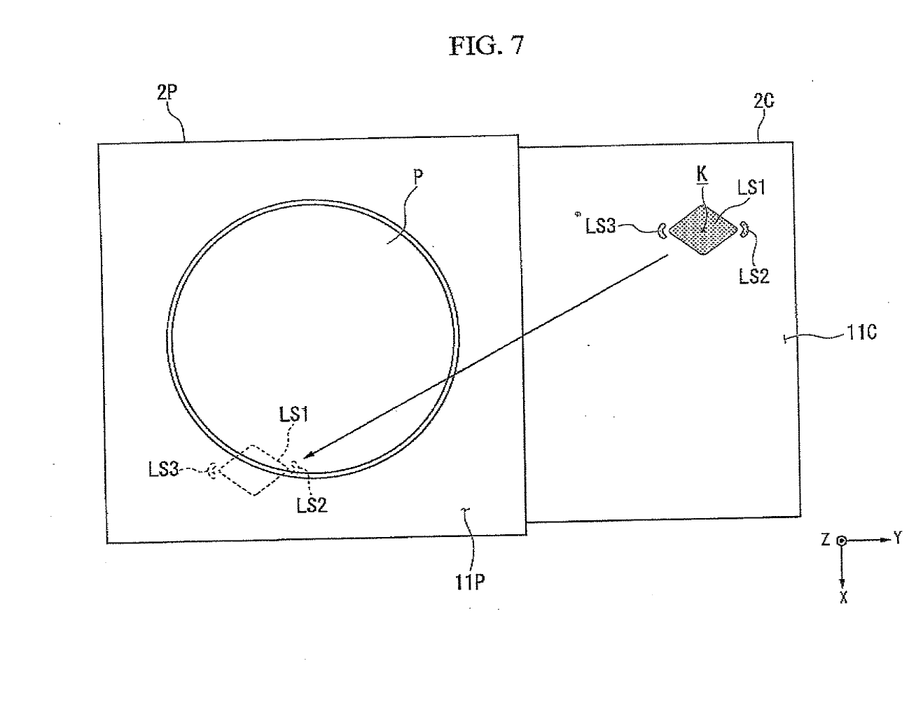

Thereby, as shown in FIG. 7, while the liquid LQ is being prevented from leaking, the first immersion space LS1 transitions from the state wherein the first immersion space LS1 is formed between the last optical element 8 and the first liquid immersion member 31 on one side and the measurement stage 2C on the other side to the state wherein the first immersion space LS1 is formed between the last optical element 8 and the first liquid immersion member 31 on one side and the substrate stage 2P on the other side. In addition, the control apparatus 4 can also cause the first immersion space LS1 to transition from the state wherein the first immersion space LS1 is formed between the last optical element 8 and the first liquid immersion member 31 on one side and the substrate stage 2P on the other side to the state wherein the first immersion space LS1 is formed between the last optical element 8 and the first liquid immersion member 31 on one side and the measurement stage 2C on the other side.

In the explanation below, the operation of synchronously moving the substrate stage 2P and the measurement stage 2C within the XY plane with respect to the last optical element 8 and the liquid immersion member 3 in the state wherein the upper surface 11P of substrate stage 2P and the upper surface 11C of the measurement stage 2C are brought into close proximity or contact with one another is called a “rugby scrum operation” where appropriate.

As shown in FIG. 7, in the rugby scrum operation, the substrate stage 2P and the measurement stage 2C move, in the state wherein the upper surface 11P and the upper surface 11C have been brought into close proximity or contact with one another, in a direction that includes a Y axis directional component. In the movement of the substrate stage 2P and the measurement stage 2C in the direction that includes a Y axis directional component, the upper surface 11P of the substrate stage 2P and the upper surface 11C of the measurement stage 2C traverse the optical path K of the exposure light EL.

Furthermore, the movement in the direction that includes a Y axis directional component includes at least one of the following movements: movement in the +Y direction, movement in the −Y direction, movement in the +Y direction and the +X direction, movement in the +Y direction and the −X direction, movement in the −Y direction and the +X direction, and movement in the −Y direction and the −X direction.

In the present embodiment, the second immersion space LS2 and the third immersion space LS3 also continue to be formed partly around the first immersion space LS1 during the rugby scram operation.

The control apparatus 4 starts the substrate P exposing process after performing the rugby scrum operation, forming the first immersion space LS1 of the liquid LQ between the last optical element 8 and the first liquid immersion member 31 on one side and the substrate stage 2P (i.e., the substrate P) on the other side, and forming the second immersion space LS2 and the third immersion space LS3 partly around the first immersion space LS1.

When performing the substrate P exposing process, the control apparatus 4 causes the last optical element 8 and the liquid immersion member 3 on one side and the substrate stage 2P on the other side to oppose one another and forms with the first liquid immersion member 31 the first immersion space LS1 of the liquid LQ at the emergent surface 7 side of the last optical element 8 such that the optical path K between the last optical element 8 and the substrate P is filled with the liquid LQ. The control apparatus 4 causes the exposure light EL to be emitted from the illumination system IL. The illumination system IL illuminates the mask M with the exposure light EL. The exposure light EL that emerges from the mask M is radiated to the substrate P through the projection optical system PL and the liquid LQ. Thereby, the substrate P is exposed with the exposure light EL, which transits the liquid LQ in the first immersion space LS1, and thus the image of the pattern of the mask M is projected to the substrate P.

The exposure apparatus EX of the present embodiment is a scanning type exposure apparatus (i.e., a so-called scanning stepper) that projects the image of the pattern of the mask M to the substrate P while synchronously moving the mask M and the substrate P in prescribed scanning directions. In the present embodiment, the scanning directions (i.e., the synchronous movement directions) of both the substrate P and the mask M are the Y axial directions. The control apparatus 4 both moves the substrate P in the Y axial direction with respect to the projection area PR of the projection optical system PL and radiates the exposure light EL to the substrate P through the projection optical system. PL and the liquid LQ in the first immersion space LS1 on the substrate P while, at the same time, moving the mask M in the Y axial direction with respect to the illumination area IR of the illumination system IL such that this movement is synchronized with the movement of the substrate P.

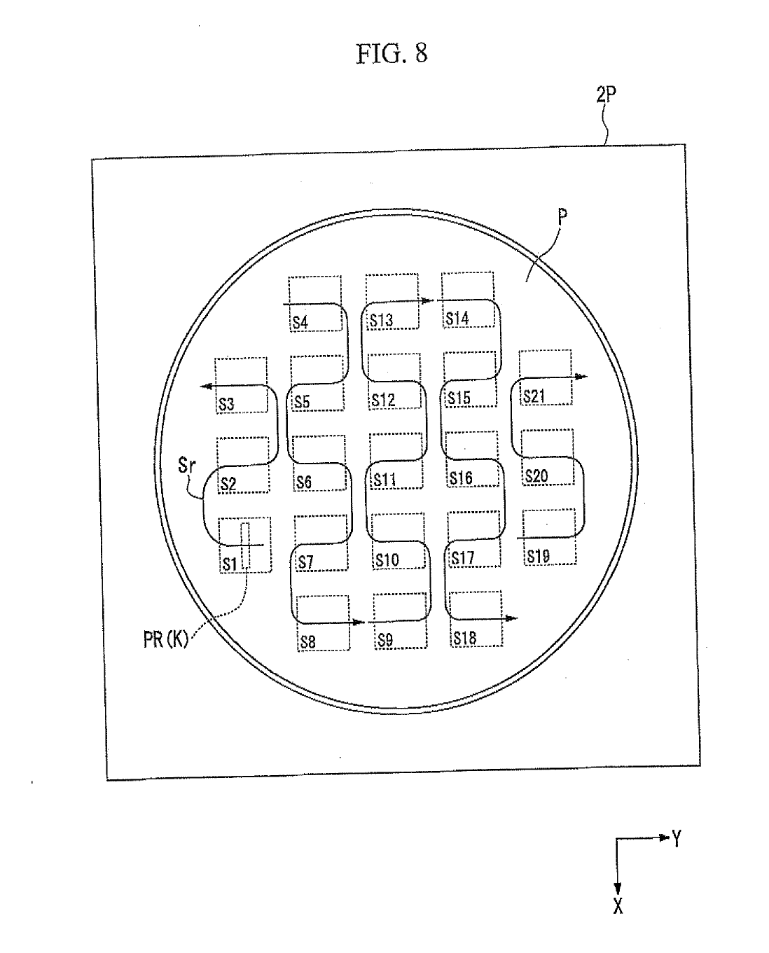

FIG. 8 shows one example of the substrate P held by the substrate stage 2P. In the present embodiment, multiple shot regions S1-S21, which are exposure target areas, are disposed on the substrate P in a matrix. In an exposure of the substrate P, the first immersion space LS1 is formed on the substrate P such that the optical path K of the exposure light EL on the emergent surface 7 side of the last optical element 8 is filled with the liquid LQ. The control apparatus 4 successively exposes the multiple shot regions S1-S21 on the substrate P, which is held by the substrate holding part 10, with the exposure light EL through the liquid LQ of the first immersion space LS1. The shot regions S1-S21 of the substrate P are exposed by the exposure light EL, which passes through the liquid LQ.

To expose, for example, the first shot region S1 of the substrate P, the control apparatus 4 both moves the substrate P (i.e., the first shot region S1) in the Y axial direction with respect to the projection area PR of the projection optical system PL and radiates the exposure light EL to the first shot region S1 through the projection optical system PL and the liquid LQ in the first immersion space LS1 on the substrate P while, at the same time moving the mask M in the Y axial direction with respect to the illumination area IR of the illumination system IL such that this movement is synchronized with the movement of the substrate P. Thereby, an image of the pattern of the mask M is projected to the first shot region S1 of the substrate P and that first shot region S1 is exposed with the exposure light EL, which emerges from the emergent surface 7. After the exposure of the first shot region S1 has ended, the control apparatus 4, in order to start the exposure of the second shot region S2, which is the next shot region, moves the second shot region S2 to an exposure start position by moving the substrate P in prescribed directions (e.g., the X axial directions or directions tilted with respect to the X axial directions within the XY plane) within the XY plane in the state wherein the first immersion space LS1 is formed. Subsequently, the control apparatus 4 starts the exposure of the second shot region S2.

The control apparatus 4 sequentially exposes a plurality of shot regions on the substrate P by repetitively performing: an operation that, while moving a shot region in the y axial direction with respect to the projection area PR, exposes that shot region; and an operation that, after the exposure of that shot region is complete, moves the next shot region to the exposure start position.

In the explanation below, the operation of moving the substrate P in the Y axial directions with respect to the last optical element 8 in order to expose one shot region is called a scanning operation where appropriate. In addition, to expose the next shot region after the exposure of a certain shot region has ended, the operation of moving the substrate P with respect to the last optical element 8 such that the next shot region is disposed in the exposure start position is called a stepping operation where appropriate.

In the present embodiment, during the scanning operation, too, the second immersion space LS2 and the third immersion space LS3 continue to be formed partly around the first immersion space LS1. In addition, in the present embodiment, during the stepping operation, too, the second immersion space LS2 and the third immersion space LS3 continue to be formed partly around the first immersion space LS1.

The control apparatus 4 moves the substrate P (i.e., the substrate stage 2P) based on the exposure condition of the shot regions S1-S21 on the substrate P. The exposure condition of the shot regions S1-S21 is defined by, for example, exposure control information, which is called an exposure recipe. The exposure control information is stored in the storage apparatus 5. The control apparatus 4 successively exposes the shot regions S1-S21 while moving the substrate P under a prescribed movement condition based on the exposure condition stored in the storage apparatus 5. The movement condition of the substrate P (i.e., the object) includes at least one of the following: a movement velocity, a movement distance, and a locus of movement with respect to the optical path K (i.e., the first immersion space LS1).

In the present embodiment, the control apparatus 4 successively exposes the shot regions S1-S21 of the substrate P with the exposure light EL through the liquid LQ by radiating the exposure light EL to the projection area PR while moving the substrate stage 2P such that the projection area PR of the projection optical system PL and the substrate P move relative to one another along the locus of movement shown by arrows Sr in FIG. 8.

As shown in FIG. 8, during at least part of the scanning operation and of the stepping operation, the substrate P (i.e., the substrate stage 2P) moves in a direction that includes a Y axis directional component. In the movement of the substrate P (i.e., the substrate stage 2P) in the direction that includes a Y axis directional component, the front surface of the substrate P (i.e., the upper surface of the substrate stage 2P) traverses the optical path K of the exposure light EL.

Furthermore, the movement in the direction that includes a Y axis directional component includes at least one of the following: movement in the +Y direction, movement in the −Y direction, movement in the +Y direction and the +X direction, movement in the +Y direction and the −X direction, movement in the −Y direction and the +X direction, and movement in the −Y direction and the −X direction.

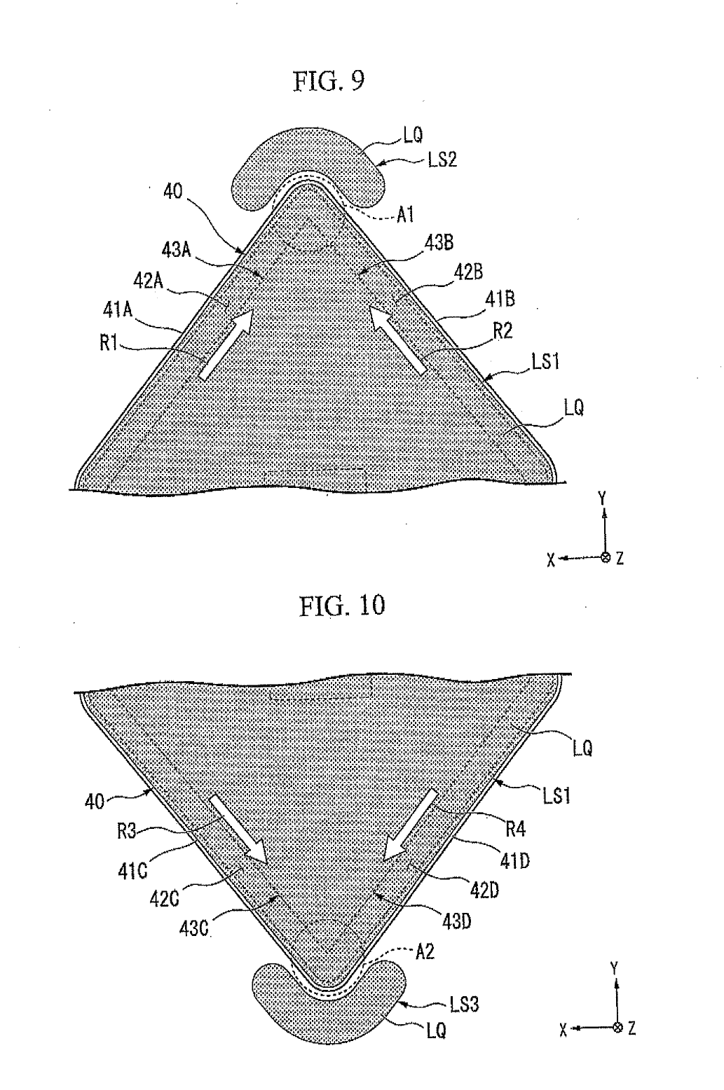

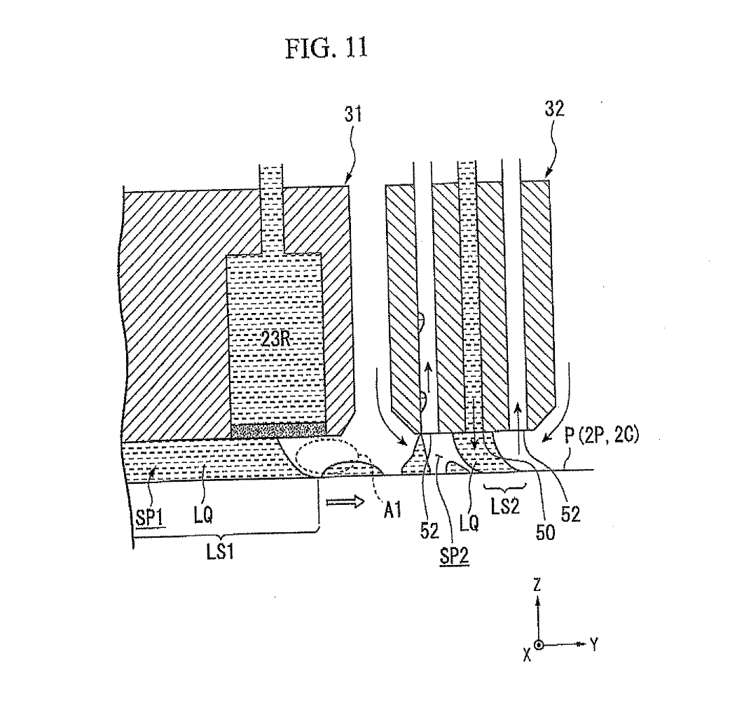

FIG. 9 and FIG. 10 schematically show one example of a state of the liquid LQ that forms the first immersion space LS1 when the object, such as the substrate P, moves in the Y axial directions parallel to the axes J2, J3 in the state wherein the first immersion space LS1 is formed.

In the present embodiment, the guide part 40, which guides at least some of the liquid LQ that forms the first immersion space LS1 to the first guide space A1 or the second guide space A2, or both, is provided.

As shown in FIG. 9, if, for example, the object moves in the +Y direction, that movement causes at least some of the liquid LQ that forms the first immersion space LS1 to flow in the space SP1. At least some of the liquid LQ that forms the first immersion space LS1 and flows by the movement of the object in the +Y direction flows, by virtue of the guide part 40, in, for example, the directions indicated by arrows R1, R2, and is guided to the first guide space A1. For example, at least some of the liquid LQ that forms the first immersion space LS1 flows in the direction indicated by the arrow R1 by virtue of, for example, at least part of the portion 41A, the portion 42A, and the portion 43A of the guide part 40, and is guided to the first guide space A1. In addition, at least some of the liquid LQ that forms the first immersion space LS1 flows in the direction indicated by the arrow R2 by virtue of for example, at least part of the portion 41B, the portion 42B, and the portion 43B of the guide part 40, and is guided to the first guide space A1.

Furthermore, even if the object has moved in a direction other than the +Y direction, the guide part 40 can still guide the liquid LQ to the first guide space A1. Namely, if the object moves in a direction that includes +Y directional component, the guide part 40 can guide the liquid LQ to the first guide space A1. For example, if the object moves in the +X direction while moving in the +Y direction, the guide part 40 can guide the liquid LQ to the first guide space A1. In addition, if the object moves in the −X direction while moving in the +Y direction, the guide part 40 can guide the liquid LQ to the first guide space A1. Thus, the guide part 40 can guide to the first guide space A1 at least some of the liquid LQ that forms the first immersion space LS1 and flows by virtue of the movement of the object that includes the +Y direction.

As shown in FIG. 10, if, for example, the object moves in the −Y direction, that movement causes at least some of the liquid LQ that forms the first immersion space LS1 to flow in the space SP1. At least some of the liquid LQ that forms the first immersion space LS1 and flows by the movement of the object in the −Y direction flows, by virtue of the guide part 40, in, for example, the directions indicated by arrows R3, R4, and is guided to the second guide space A2. For example, at least some of the liquid LQ that forms the first immersion space LS1 flows in the direction indicated by the arrow 123 by virtue of, for example, at least part of the portion 41C, the portion 42C, and the portion 43C of the guide part 40, and is guided to the second guide space A2. In addition, at least some of the liquid LQ that forms the first immersion space LS1 flows in the direction indicated by the arrow R4 by virtue of, for example, at least part of the portion 410, the portion 420, and the portion 430 of the guide part 40, and is guided to the second guide space A2.

Furthermore, even if the object has moved in a direction other than the −Y direction, the guide part 40 can still guide the liquid LQ to the second guide space A2. Namely, if the object moves in a direction that includes a −Y directional component, the guide part 40 can guide the liquid LQ to the second guide space A2. For example, if the object moves in the +X direction while moving in the −Y direction, the guide part 40 can guide the liquid LQ to the second guide space A2. In addition, if the object moves in the −X direction while moving in the −Y direction, the guide part 40 can guide the liquid LQ to the second guide space A2. Thus, the guide part 40 can guide to the second guide space A2 at least some of the liquid LQ that forms the first immersion space LS1 and flows by virtue of the movement of the object that includes the −Y direction.

If in the state wherein the first immersion space LS1 is formed the object has moved under a prescribed movement condition in a prescribed operation of the exposure apparatus EX, then at least some of the liquid LQ in the first immersion space LS1 might adversely flow out of the first immersion space LS1 to the outer side of the space SP1.

For example, in the rugby scrum operation of the exposure apparatus EX, at least some of the liquid LQ in the first immersion space LS1 might flow out to the outer side of the space SP1.

In addition, in the scanning operation of the exposure apparatus EX, at least some of the liquid LQ in the first immersion space LS1 might flow out to the outer side of the space SP1.

In addition, in the stepping operation of the exposure apparatus EX, at least some of the liquid LQ in the first immersion space LS1 might flow out to the outer side of the space SP1.

For example, in at least one of the prescribed operations, namely, the rugby scrum operation, the scanning operation, or the stepping operation, there is a possibility that the object will move in the Y axial directions under a condition wherein a prescribed permissible condition under which the first immersion space LS1 of the liquid LQ can be maintained between the first liquid immersion member 31 and the object is not satisfied.

For example, in the prescribed operation, there is a possibility that the object will move in the Y axial directions over a distance longer than a prescribed permissible distance at which it is possible to maintain the first immersion space LS1 of the liquid LQ between the first liquid immersion member 31 and the object.

In addition, in the prescribed operation, there is a possibility that the object will move in the Y axial directions at a velocity higher than a prescribed permissible velocity at which the first immersion space LS1 of the liquid LQ can be maintained between the first liquid immersion member 31 and the object.

FIG. 11 schematically shows one example of a state wherein the object is moving in the Y axial directions under a condition wherein a prescribed permissible condition under which the first immersion space LS1 of the liquid LQ can be maintained between the first liquid immersion member 31 and the object is not satisfied. As shown in FIG. 11, there is a possibility that, for example, if the object has moved in the Y axial directions under a condition in which the permissible condition is not satisfied, at least some of the liquid LQ in the first immersion space LS1 will flow out of the first immersion space LS1 to the outer side of the space SP1.

In the present embodiment, if the object has moved in the +Y direction, the liquid LQ in the first immersion space LS1 is guided by the guide part 40 to the first guide space A1. Accordingly, if the object has moved in the +Y direction under a condition in which the permissible condition is not satisfied, then there is a strong possibility that the liquid LQ in the first immersion space LS1 will collect in the first guide space A1 and then flow out of the first guide space A1 to the outer side of the space SP1. Namely, if the object has moved in the +Y direction, there is a strong possibility that the liquid LQ in the first immersion space LS1 will collect in the first guide space A1 and then flow out to the +Y side of the first guide space A1.

In the present embodiment, the second immersion space LS2 of the liquid LQ is formed by the second liquid immersion member 32 such that the second immersion space LS2 is adjacent to the first guide space A1. In the present embodiment, the second liquid immersion member 32 is disposed adjacent to the first liquid immersion member 31 in the Y axial directions in which the object moves in the prescribed operation of the exposure apparatus EX. The second immersion space LS2 is disposed such that it is at the +Y side of and adjacent to the first guide space A1.

Accordingly, the liquid LQ that flows out of the first guide space A1 to the outer side of the space SP1 is hindered by the second immersion space LS2 from flowing out to the outer side of the space SP2. Namely, the second immersion space LS2 stops the liquid LQ from flowing out of the first guide space A1. For example, the liquid LQ that flows out of the first guide space A1 to the outer side of the space SP1 combines with the liquid LQ of the second immersion space LS2 in the space SP2. In addition, the liquid LQ that flows out of the first guide space A1 to the outer side of the space SP1 is recovered via the recovery port 52 between the first liquid immersion member 31 and the supply port 50.

In addition, if the object has moved in the −Y direction, the liquid LQ in the first immersion space LS1 is guided by the guide part 40 to the second guide space A2. Accordingly, if the object has moved in the −Y direction under a condition in which the permissible condition is not satisfied, then there is a strong possibility that the liquid LQ in the first immersion space LS1 will collect in the second guide space A2 and than flow out of the second guide space A2 to the outer side of the space SP1. Namely, if the object has moved in the −Y direction, there is a strong possibility that the liquid LQ in the first immersion space LS1 will collect in the second guide space A2 and then flow out to the −Y side of the second guide space A2.

In the present embodiment, the third immersion space LS3 of the liquid LQ is formed by the third liquid immersion member 33 such that the third immersion space LS3 is adjacent to the second guide space A2. In the present embodiment, the third liquid immersion member 33 is disposed adjacent to the first liquid immersion member 31 in the Y axial directions in which the object moves in the prescribed operation of the exposure apparatus EX. The third immersion space LS3 is disposed such that it is at the −Y side of and adjacent to the second guide space A2.

Accordingly, the liquid LQ that flows out of the second guide space A2 to the outer side of the space SP1 is hindered by the third immersion space LS3 from flowing out to the outer side of the space SP3. Namely, the third immersion space LS3 stops the liquid LQ from flowing out of the second guide space A2. For example, the liquid LQ that flows out of the second guide space A2 to the outer side of the space SP1 combines with the liquid LQ of the third immersion space LS3 in the space SP3. In addition, the liquid LQ that flows out of the second guide space A2 to the outer side of the space SP1 is recovered via the recovery port 55 between the first liquid immersion member 31 and the supply port 53.

In the present embodiment, the second immersion space LS2 is smaller than the first immersion space LS1. Consequently, even if the object has moved in the Y axial directions under a condition wherein the prescribed permissible condition under which the first immersion space LS1 of the liquid LQ can be maintained in the space SP1 is not satisfied, the liquid LQ in the second immersion space LS2 is hindered from flowing out of the space SP2.

In addition, in the present embodiment, the third immersion space LS3 is smaller than the first immersion space LS1. Consequently, even if the object has moved in the Y axial directions under a condition wherein the prescribed permissible condition under which the first immersion space LS1 of the liquid LQ can be maintained in the space SP1 is not satisfied, the liquid LQ in the third immersion space LS3 is hindered from flowing out of the space SP3.

In addition, there is a possibility that the liquid LQ in the first immersion space LS1 will flow out to the outer side of the space SP1 without transiting the first guide space A1 and the second guide space A2. In the present embodiment, the fluid recovery parts 56, 58 of the first and second recovery members 34, 35, respectively, are provided, and therefore the liquid LQ that flows out is recovered by the liquid recovery parts 56, 58.

In the present embodiment, a fluid recovery operation of the fluid recovery parts 56, 58 is performed in at least part of the interval during which the object moves in the state wherein the first immersion space LS1 is formed. In the present embodiment, the fluid recovery operation of the fluid recovery part 56, 58 is performed at least while the substrate P is being exposed through the liquid LQ of the first immersion space LS1. Furthermore, the fluid recovery operation of the fluid recovery parts 56, 58 may be performed during part of the exposure of the substrate P. For example, when the substrate P moves in the X axial directions or when the substrate P moves at a velocity higher than a prescribed velocity, the fluid recovery operation of the fluid recovery parts 56, 58 may be performed; furthermore, when the substrate P moves in the Y axial directions or when the substrate P moves at a velocity lower than a prescribed velocity, the fluid recovery operation of the fluid recovery parts 56, 58 may be stopped. In addition, after the fluid recovery operation of the fluid recovery parts 56, 58 during an exposure of the substrate P has stopped and the exposure of the substrate P has ended, the operation of recovering the residual liquid LQ on the front surface (i.e., the upper surface) of the object (i.e., the substrate P, the substrate stage 2P, and the like) by the fluid recovery parts 56, 58 may be performed.

Furthermore, the fluid recovery parts 56, 58 (i.e., the first and second recovery members 34, 35, respectively) may be omitted.

After the exposure of the substrate P has ended, the substrate stage 2P is moved to the substrate exchange position. At the substrate exchange position, a substrate exchanging process is performed. Subsequently, a plurality of the substrates P is successively exposed by performing the same processes as discussed above.

As explained above, because the guide part 40 is provided according to the present embodiment, the liquid LQ in the first immersion space LS1 can be guided to the first guide space A1. Accordingly, even if, for example, the liquid LQ adversely flows out of the first immersion space LS1, it is possible to limit the position of that outflow (i.e., that portion) to the first guide space A1. In addition, because a configuration is adopted wherein the second liquid immersion member 32 forms the second immersion space LS2 adjacent to the first guide space A1, the liquid LQ that flows out of the first guide space A1 is hindered by the second immersion space LS2 from flowing out to the outer side of the space SP2. Likewise, the liquid LQ that flows out of the second guide space A2 is hindered by the third liquid immersion member 33 front flowing out to the out side of the space SP3. Accordingly, exposure failures are prevented from occurring and defective devices are prevented from being produced.

For example, if the liquid LQ and the gas are recovered together via the recovery port 52 of the second liquid immersion member 32, there is a possibility that heat of vaporization will attend that recovery. Disposing the first liquid immersion member 31 and the second liquid immersion member 32 spaced from one another apart hinders the temperature of the first liquid immersion member 31 from changing even if the temperature of the second liquid immersion member 32 changes attendant with the heat of vaporization produced in the second liquid immersion member 32. Likewise, disposing the first liquid immersion member 31 and the third liquid immersion member 33 spaced apart from one another hinders the temperature of the first liquid immersion member 31 from changing even if the temperature of the third liquid immersion member 33 changes. Furthermore, to hinder a change in the temperature of the second liquid immersion member 32 owing to heat of vaporization and the like, a temperature adjusting apparatus that adjusts the temperature of the second liquid immersion member 32 may be provided. For example, a temperature adjusting apparatus such as a Peltier device may be disposed in the second liquid immersion member 32. Likewise, a temperature adjusting apparatus that adjusts the temperature of the third liquid immersion member 33 may be provided.

Furthermore, the first liquid immersion member 31 and the second liquid immersion member 32 may be integrated. Furthermore, a temperature adjusting apparatus that adjusts the temperature of the integrated first liquid immersion member 31 and second liquid immersion member 32 may be provided. Likewise, the first liquid immersion member 31 and the third liquid immersion member 33 may be integrated, and a temperature adjusting apparatus that adjusts the temperature of the integrated first liquid immersion member 31 and third liquid immersion member 33 may be provided. In other words, the first immersion member 31, the second immersion member 32, and the third immersion member 33 can be connected with each other.

Furthermore, in the present embodiment, the guide part 40 includes the edge 41, the lower surface 42, and the boundary 43; however, the guide part 40 may comprise the edge 41 alone, the lower surface 42 alone, the boundary 43 alone, the edge 41 and the lower surface 42, the edge 41 and the boundary 43, or the lower surface 42 and the boundary 43.

Furthermore, in the present embodiment, the second immersion space LS2 is formed at the +Y side of the first immersion space LS1; of course, the second immersion space LS2 may be formed at a position other than the +Y side. For example, if the first guide space A1 is provided at the +X side with respect to the optical path K, then the second immersion space LS2 may be formed at the +X side of the first immersion spate LS1. Likewise, in the present embodiment, the third immersion space LS3 is formed at the −Y side of the first immersion space LS1, but may be formed at a position other than the −Y side, for example, at the −X side.

Furthermore, in the present embodiment, the guide part 40 is provided; however, the guide part 40 can be omitted. If, for example, in a prescribed operation of the exposure apparatus EX the object is moved in a first direction under a condition wherein the prescribed permissible condition under which the first immersion space LS1 can be maintained is not satisfied, then, instead of providing the guide part 40, the second liquid immersion member 32 that forms the second immersion space LS2 may be disposed at a position adjacent to the first liquid immersion member 31 in the first direction in which the object moves. For example, if the liquid LQ in the first immersion space LS1 tends to collect in a known space owing to a prescribed operation (e.g., the object movement condition) of the exposure apparatus EX, then the second immersion space LS2 may be formed at a position adjacent to that space.

Furthermore, in the present embodiment, the liquid recovery part 21 includes the porous member 24, but the porous member 24 may be omitted. For example, the liquid LQ may be recovered from the space SP1 via, for example, the opening 22, wherein the porous member 24 is not disposed.

Furthermore, in the present embodiment, a porous member may be disposed in the recovery port 52. A porous member may be disposed in the recovery port 55.

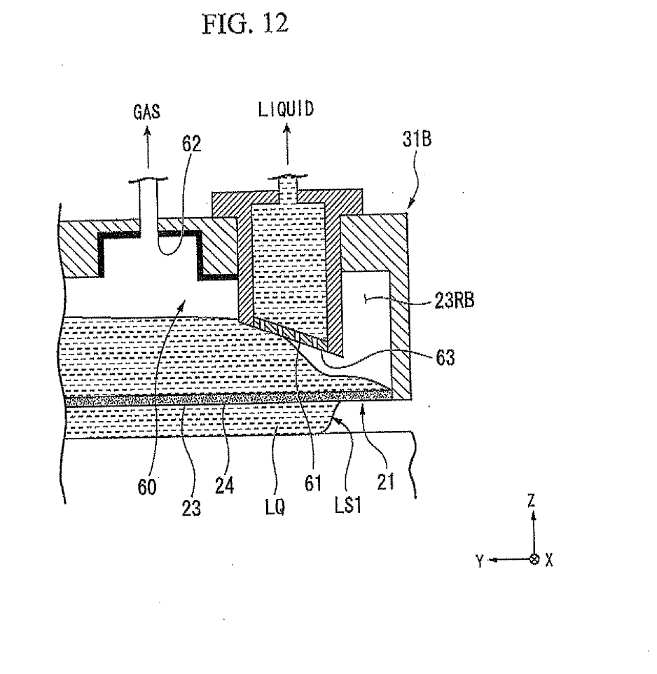

Furthermore, in the present embodiment, as shown in, for example, FIG. 12, a first liquid immersion member 313 may comprise a discharge part 60, which separately discharges the liquid LQ and the gas from a recovery passageway 23RB. For example, if the liquid recovery part 21 recovers the liquid LQ and the gas together, then the liquid LQ and the gas flow from the space SP1 into the recovery passageway 23RD. The discharge part 60 separately discharges the liquid LQ and the gas from the recovery passageway 23RB.

In FIG. 12, the discharge part 60 has first discharge ports 61, which face the recovery passageway 23RD and are for discharging the liquid LQ from the recovery passageway 23RD, and a second discharge port 62, which faces the recovery passageway 23RD and is for discharging the gas from the recovery passageway 23RB. The first discharge ports 61 and the second discharge port 62 each face downward. The first discharge ports 61 are disposed at the outer side of the second discharge port 62 in the radial directions with respect to the optical path K. The first discharge ports 61 are disposed below the second discharge port 62. The first discharge ports 61 hinder the inflow of the gas more than the second discharge port 62 does. The second discharge port 62 hinders the inflow of the liquid LQ more than the first discharge ports 61 do. Namely, the percentage of the liquid LQ in the fluid discharged via the first discharge ports 61 is greater than the percentage of the liquid LQ in the fluid discharged via the second discharge port 62. The first discharge ports 61 discharge substantially only the liquid LQ from the recovery passageway 23RB. The second discharge port 62 discharges substantially only the gas from the recovery passageway 23RB. In the example shown in FIG. 12, the first liquid immersion member 31B comprises a porous member 63, which has the first discharge ports 61. The porous member 63 has a plurality of holes capable of discharging the liquid LQ. The holes of the porous member 63 function as the first discharge ports 61. By adjusting the difference between the pressure on the lower surface side of the first discharge ports 61 and the pressure on the upper surface side of the first discharge ports 61, substantially only the liquid LQ is discharged via the first discharge ports 61.

### Second Embodiment

A second embodiment will now be explained. In the explanation below, constituent parts that are identical or equivalent to those in the embodiments discussed above are assigned identical symbols, and the explanations thereof are therefore abbreviated or omitted.

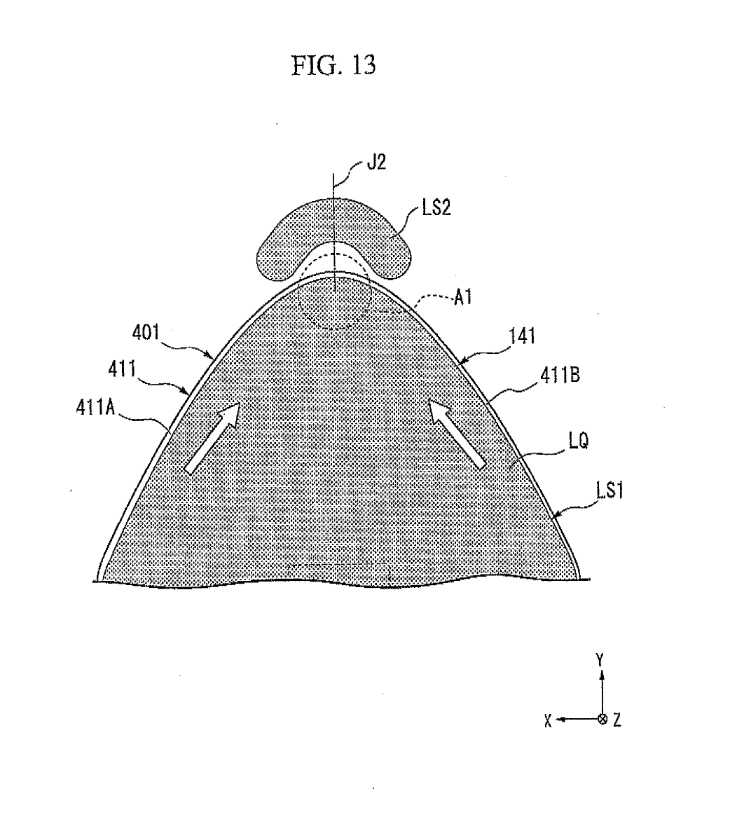

FIG. 13 through FIG. 18 show examples of guide parts 401-406 disposed in lower surfaces 141-146. Furthermore, to simplify the explanation, the text below explains exemplary cases wherein the guide parts 401-406 are the edges of the lower surfaces 141-146; however, the guide parts 401-406 may include the lower surface 42 of the porous member 24, or may include the boundary between the lower surface 42 of the porous member 24 and the flat part 268. In addition, the text below explains the guide parts 401-406, which guide the liquid LQ to the first guide space A1; however, the liquid LQ may be guided to the second guide space A2 by a guide part whose structure is similar to the structures of the guide parts 401-406 shown in FIG. 13 through FIG. 18. Here, FIGS. 13 to 18 each schematically show a liquid immersion member. For example, the liquid recovery part 21 and the lower surface 26 (the flat part 26S) are not shown in FIGS. 13 to 18.

The guide part 401 shown in FIG. 13 includes an edge 411 of the lower surface 141, which extends linearly toward the first guide space A1. The edge 411 has a portion 411A, which extends from the +X side of the axis J2 that passes through the second immersion space LS2 and which extends toward the first guide space A1, and a portion 411B, which extends from the −X side of the axis J2 toward the first guide spate A1. A spacing between the portion 411A and the portion 411E in the X axial directions within the XY plane becomes smaller as it approaches the first guide space A1. In the present embodiment, at least part of the edge 411 is curved.

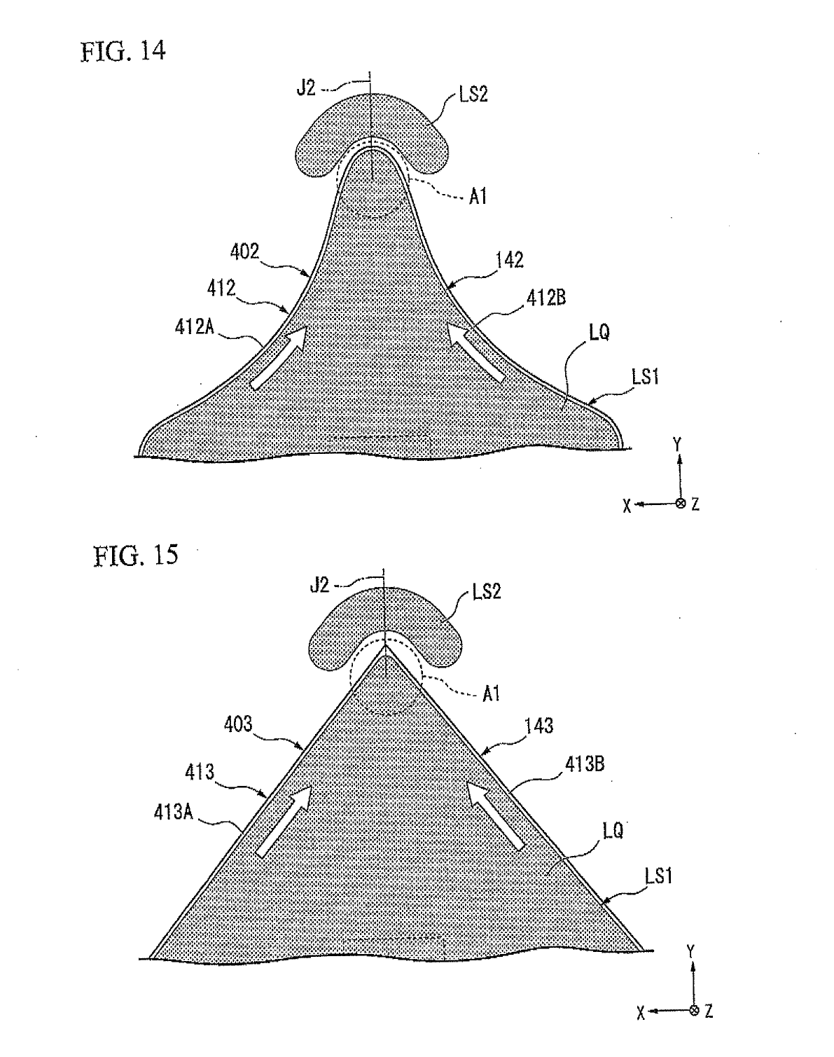

The guide part 402 shown in FIG. 14 includes an edge 412 of the lower surface 142, which extends linearly toward the first guide space A1. The edge 412 has a portion 412A, which extends from the +X side of the axis J2 toward the first guide space A1, and a portion 412B, which extends from the −X side of the axis J2 toward the first guide space A1. A spacing between the portion 412A and the portion 412B in the X axial directions within the XY plane becomes smaller as it approaches the first guide space A1. At least part of the edge 412 is curved. The portions 412A, 412B are curved such that they indent toward the inner side.

The guide part 403 shown in FIG. 15 includes an edge 413 of the lower surface 143, which extends linearly toward the first guide space A1. The edge 413 has a portion 413A, which extends from the +X side of the axis J2 toward the first guide space A1, and a portion 413B, which extends from the −X side of the axis J2 toward the first guide space A1. A spacing between the portion 413A and the portion 413B in the X axial directions within the XY plane becomes smaller as it approaches the first guide space A1. The portion 413A and the portion 413B are each rectilinear. The angle formed between the portion 413A and the portion 413B is sharp.

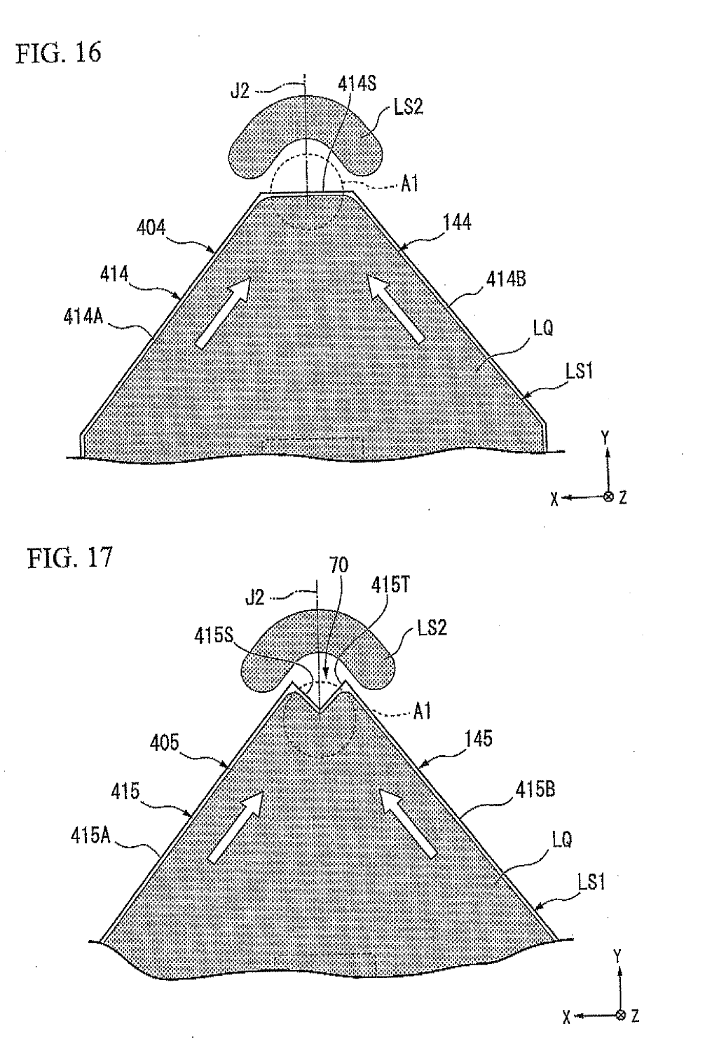

The guide part 404 shown in FIG. 16 includes an edge 414 of the lower surface 144, which extends linearly toward the first guide space A1. The edge 414 has a portion 414A, which extends from the +X side of the axis J2 toward the first guide space A1, and a portion 414B, which extends from the −X side of the axis J2 toward the first guide space A1. A spacing between the portion 414A and the portion 414B in the X axial directions within the XY plane becomes smaller as it approaches the first guide space A1. The portion 414A and the portion 414B are each rectilinear. In addition, the lower surface 144 includes an edge 414S, which connects the tip of the portion 414A and the tip of the portion 414B. The edge 414S is rectilinear and substantially parallel to the X axis.

The guide part 405 shown in FIG. 17 includes an edge 415 of the lower surface 145, which extends linearly toward the first guide space A1. The edge 415 has a portion 415A, which extends from the +X side of the axis J2 toward the first guide space A1, and a portion 415B, which extends from the −X side of the axis J2 toward the first guide space A1. A spacing between the portion 415A and the portion 415B in the X axial directions within the XY plane becomes smaller as it approaches the first guide-space A1. The portion 415A and the portion 415B are each rectilinear. In addition, the lower surface 145 includes an edge 415S and an edge 415T, which connect the tip of the portion 415A and the tip of the portion 415B. The edge 415S and the edge 415T extend in different directions. The edge 415S and the edge 415T form a recessed part 70, which is indented away from the second immersion space LS2.

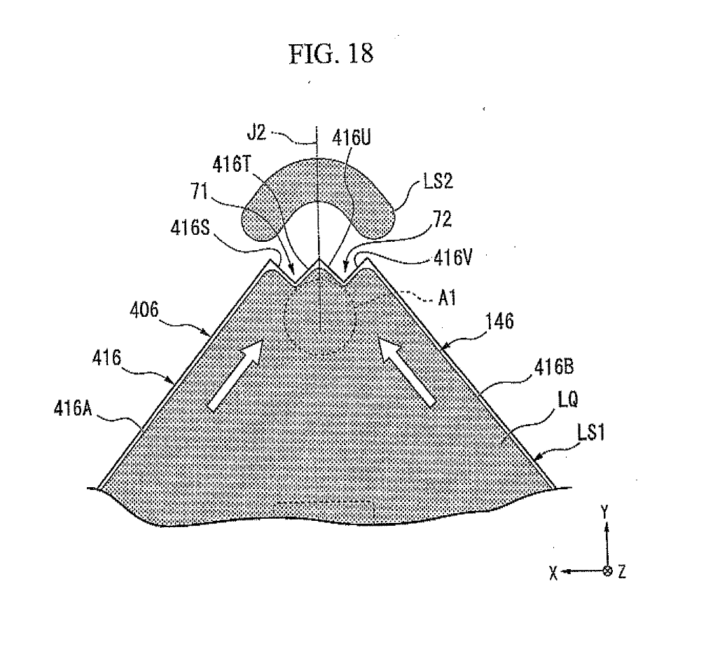

The guide part 406 shown in FIG. 18 is a modified example of the guide part 405 shown in FIG. 17. The guide part 406 includes an edge 416 of a lower surface 146, which extends linearly toward the first guide space A1. The edge 416 has a portion 416A and a portion 416B. In addition, the lower surface 146 includes an edge 4168 and edges 416T, 416U, 416V, which connect the tip of the portion 416A and the tip of the portion 416B. The edge 4168 and the edge 416T form a first recessed part 71, which is indented away from the second immersion space LS2, and the edge 416U and the edge 416V form a second recessed part 72.

### Third Embodiment

A third embodiment will now be explained. In the explanation below, constituent parts that are identical or equivalent to those in the embodiments discussed above are assigned identical symbols, and the explanations thereof are therefore abbreviated or omitted.

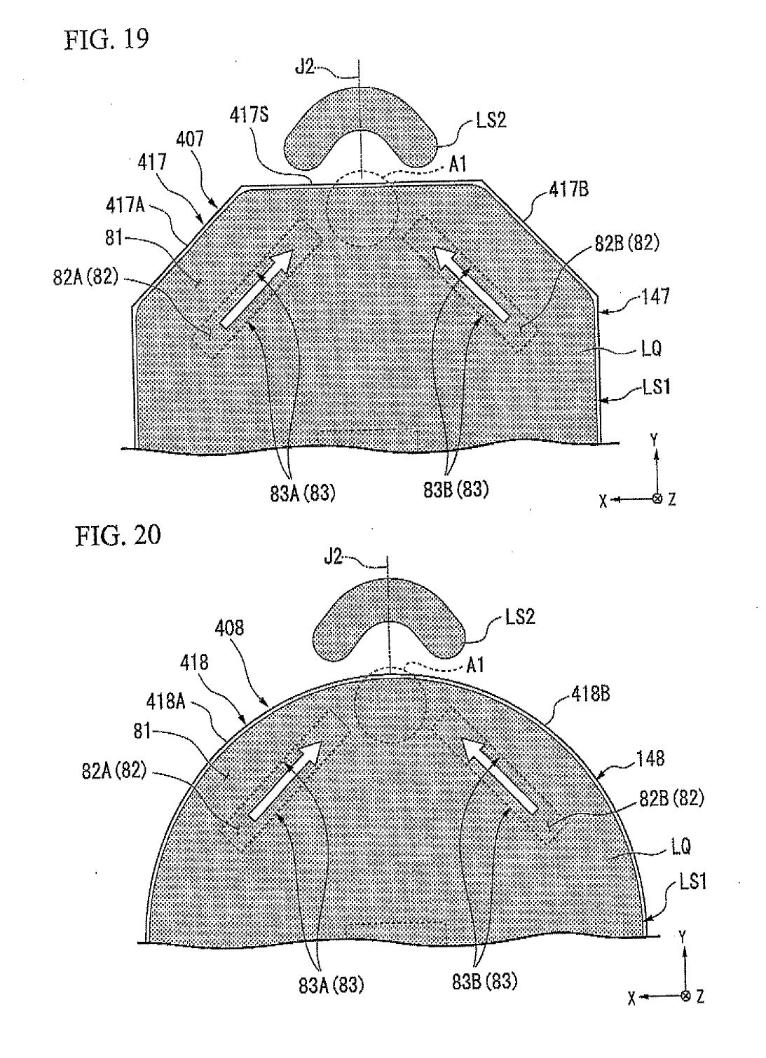

FIG. 19 through FIG. 21 show examples of guide parts 407-409, which are disposed in lower surfaces 147-149. Here, FIGS. 19 to 21 each schematically show a liquid immersion member. For example, the liquid recovery part 21 and the lower surface 26 (the flat part 268) are not shown in FIGS. 19 to 21.

The guide part 407 shown in FIG. 19 includes an edge 417, which extends linearly toward the first guide space A1. The edge 417 has a portion 417A, which extends from the +X side of the axis J2 toward the first guide space A1, and a portion 417B, which extends from the −X side of the axis J2 toward the first guide space A1. A spacing between the portion 417A and the portion 417B in the X axial directions within the XY plane becomes smaller as it approaches the first guide space A1. In addition, the lower surface 147 includes an edge 4178, which connects the tip of the portion 417A and tip of the portion 417B. The edge 417S is rectilinear and substantially parallel to the X axis.

In the present embodiment, the lower surface 147 includes a first area 81, which is disposed such that the object opposes it, and second areas 82, which are disposed such that the object opposes them and wherein the contact angle of the liquid LQ with respect to the second areas 82 is smaller than the contact angle of the liquid LQ with respect to the first area 81. The guide part 407 includes the second areas 82. Each of the second areas 82 extends in a strip toward the first guide space A1. The second areas 82 include a portion 82A, which extends from the +X side of the axis J2 toward the first guide space A1, and a portion 82B, which extends from the −X side of the axis J2 toward the first guide space A1. A spacing between the portion 82A and the portion 82B in the X axial directions within the XY plane becomes smaller as it approaches the first guide space A1.

In addition, in the example shown in FIG. 19, the guide part 407 includes boundaries 83 between the first area 81 and the second areas 82. The boundaries 83 extend linearly toward the first guide space A1. The boundaries 83 include a portion 83A, which extends from the +X side of the axis J2 toward the first guide space A1, and a portion 83B, which extends from the −X side of the axis J2 toward the first guide space A1. A spacing between the portion 83A and the portion 83B in the X axial directions within the XY plane becomes smaller as it approaches the first guide space A1.

The guide part 408 shown in FIG. 20 includes an edge 418, which extends linearly toward the first guide space A1: The edge 418 has a portion 418A, which extends from the +X side of the axis J2 toward the first guide space A1, and a portion 418B, which extends from the −X side of the axis J2 toward the first guide space A1. A spacing between the portion 418A and the portion 418B in the X axial directions within the XY plane becomes smaller as it approaches the first guide space A1. In the present embodiment, the portion 418A and the portion 418B are curved. In the present embodiment, the external shape of the lower surface 148 is circular.

In the present embodiment, the lower surface 148 includes the first area 81 and the second areas 82, wherein the contact angle of the liquid LQ with respect to the second areas 82 is smaller than the contact angle of the liquid LQ with respect to the first area 81. The guide part 408 includes the second areas 82. In addition, the guide part 408 includes the boundaries 83 between the first area 81 and the second areas 82. The second areas 82 and the boundaries 83 are the same as those that were explained referencing FIG. 19.

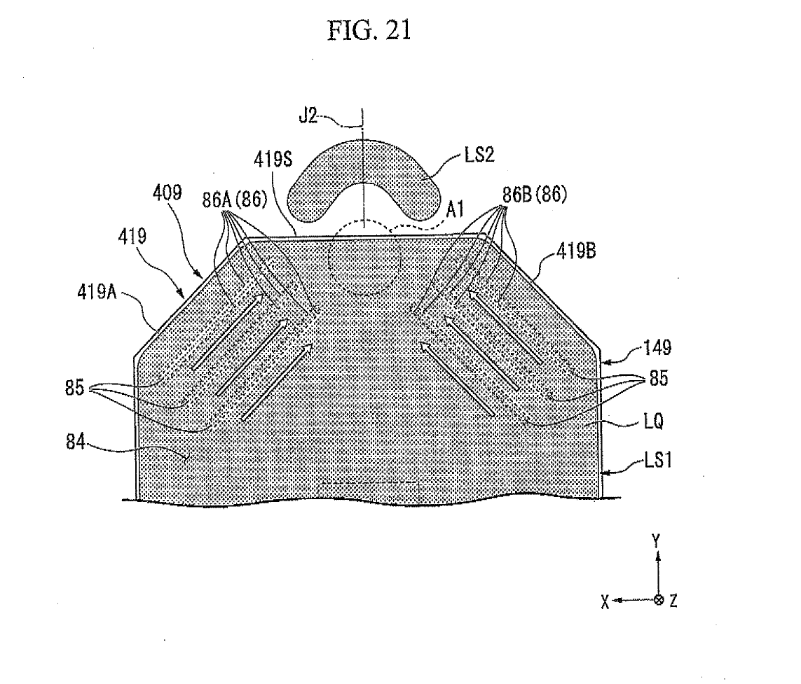

The guide part 409 shown in FIG. 21 includes an edge 419, which extends linearly toward the first guide space A1. The edge 419 has a portion 419A, which extends from the +X side of the axis J2 toward the first guide space A1, and a portion 419B, which extends from the −X side of the axis J2 toward the first guide space A1. A spacing between the portion 419A and the portion 419B in the X axial directions within the XY plane becomes smaller as it approaches the first guide space A1. The lower surface 149 includes an edge 419S, which connects the tip of the portion 419A and the tip of the portion 419B.

In the present embodiment, the lower surface 149 includes a first area 84, which is disposed such that the object opposes it, and second areas 85, which are disposed such that the object opposes them and whose heights are different from that of the first area 84. In the present embodiment, the lower surface 149 has recessed parts (i.e., grooves). The inner surfaces of the recessed parts are the second areas 85. The first area 84 is disposed around the recessed parts. The distance between each of the second areas 85 and the object is greater than the distance between the first area 84 and the front surface of the object.

In the present embodiment, the guide part 409 includes boundaries 86 between the first area 84 and the second areas 85. Each of the boundaries 86 extends linearly toward the first guide space A1. The boundaries 86 include portions 86A, each of which extends from the +X side of the axis J2 toward the first guide space A1, and portions 86B, each of which extends from the −X side of the axis J2 toward the first guide space A1. A spacing between each of the portions 86A and the corresponding portion 86B in the X axial directions within the XY plane becomes smaller as it approaches the first guide space A1.

Furthermore, protruding parts may be provided to the lower surface 149, and the second areas 85 may be disposed in the surfaces of the protruding part opposing the object. The first area 84 is disposed around the protruding parts. If the protruding parts that have the second areas 85 are provided to the lower surface 149, then the distance between each of the second areas 85 and the object would be smaller than the distance between the first area 84 and the front surface of the object.

### Fourth Embodiment

A fourth embodiment will now be explained. In the explanation below, constituent parts that are identical or equivalent to those in the embodiments discussed above are assigned identical symbols, and the explanations thereof are therefore abbreviated or omitted.

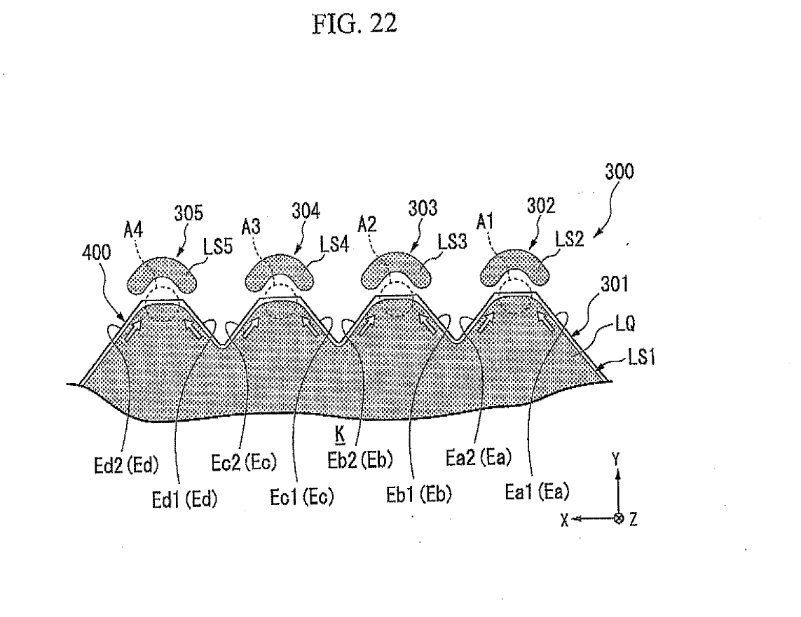

FIG. 22 shows one example of a liquid immersion member 300 according to the present embodiment. Here, FIG. 22 schematically shows a liquid immersion member. For example, the liquid recovery part 21 and the lower surface 26 (the flat part 26S) are not shown in FIG. 22.

In FIG. 22, the liquid immersion member 300 comprises: a first liquid immersion member 301, which forms the first immersion space LS1; a guide part 400, which guides at least some of the liquid LQ in the first immersion space LS1 to the first guide space A1, which extends partly around the optical path K; a second liquid immersion member 302, which is disposed at the outer side of the first liquid immersion member 301 with respect to the optical path K and forms the second immersion space LS2 of the liquid LQ partly around the first immersion space LS1 and adjacent to the first guide space A1; and a third liquid immersion member 303, which is disposed at the outer side of the first liquid immersion member 301 with respect to the optical path K and forms the third immersion space LS3 of the liquid LQ, which is different from the second immersion space LS2, partly around the first immersion space LS1 and adjacent to the second guide space A1. In the present embodiment, the third immersion space LS3 is formed at the same side as the second immersion space LS2 with respect to the optical path K. The guide part 400 guides at least some of the liquid LQ in the first immersion space LS1 to the second guide space A2.

In addition, in the present embodiment, the liquid immersion member 300 comprises: a fourth liquid immersion member 304, which is disposed at the outer side of the first liquid immersion member 301 with respect to the optical path K and forms a fourth immersion space LS4 of the liquid LQ partly around the first immersion space LS1 and adjacent to a third guide space A3; and a fifth liquid immersion member 305, which is disposed at the outer side of the first liquid immersion member 301 with respect to the optical path K and forms a fifth immersion space LS5 of the liquid LQ partly around the first immersion space LS1 and adjacent to a fourth guide space A4. In the present embodiment, the third immersion space LS3, the fourth immersion space LS4, and the fifth immersion space LS5 are formed at the same side as the second immersion space LS2 with respect to the optical path K. The guide part 400 guides at least some of the liquid LQ of the first immersion space LS1 to the third guide space A3 and the fourth guide space A4.

The guide part 400 includes: a portion Eat and a portion Eat of an edge Ea, which extend toward the first guide space A1; a portion Eb1 and a portion Eb2 of an edge Eb, which extend toward the second guide space A2; a portion Eel and a portion Ec2 of an edge Bc, which extend toward the third guide space A3; and a portion Ed1 and a portion Ed2 of an edge Ed, which extend toward the fourth guide space A4.

### Fifth Embodiment

A fifth embodiment will now be explained. In the explanation below, constituent parts that are identical or equivalent to those in the embodiments discussed above are assigned identical symbols, and the explanations thereof are therefore abbreviated or omitted.

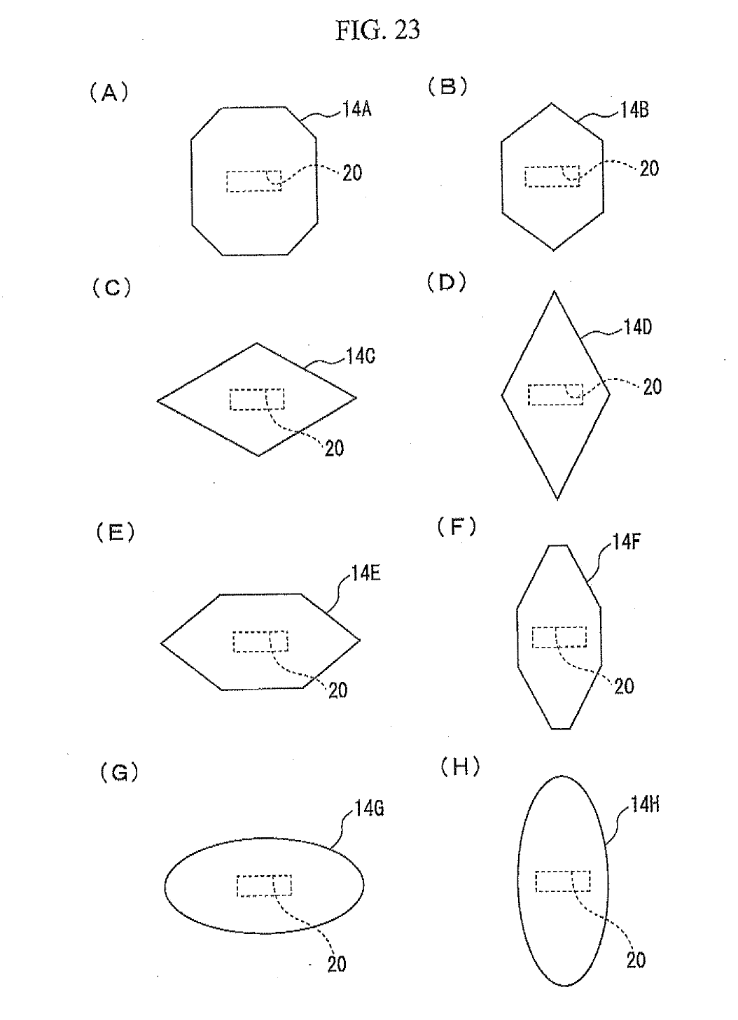

FIG. 23(A)-(H) show examples of lower surfaces 14A-14H of a first liquid immersion member. Here, parts (A)-(H) of FIG. 23 each schematically show a liquid immersion member. For example, the liquid recovery part 21 and the lower surface 26 (the flat part 265) are not shown in FIG. 23. As shown in FIG. 23(A), the external shape of the lower surface 14A may be octagonal. As shown in FIG. 23(B), the external shape of the lower surface 14B may be hexagonal. As shown in FIG. 23(C) and FIG. 23(D), the external shapes of the lower surfaces 14C, 14D may be diamond shaped. In the lower surface 14C shown in FIG. 23(C), the size in the X axial directions is larger than the size in the Y axial directions. In the lower surface 14D shown in FIG. 23(D), the size in the X axial directions is smaller than the size in the Y axial directions. As shown in FIG. 23(E), the external shape of the lower surface 14E may be a hexagon that is long in the X axial directions. As shown in FIG. 23(P), the external shape of the lower mike 14F may be an octagon that is long in the Y axial directions. As shown in FIG. 23(G) and FIG. 23(H), the external shapes of the lower surfaces 14G, 14H may be elliptical. In the lower surface 14G shown in FIG. 23(G), the size in the X axial directions is larger than the size in the Y axial directions. In the lower surface 14H shown in FIG. 23(H), the size in the X axial directions is smaller than the size in the Y axial directions.

### Sixth Embodiment

A sixth embodiment will now be explained. In the explanation below, constituent parts that are identical or equivalent to those in the embodiments discussed above are assigned identical symbols, and the explanations thereof are therefore abbreviated or omitted.

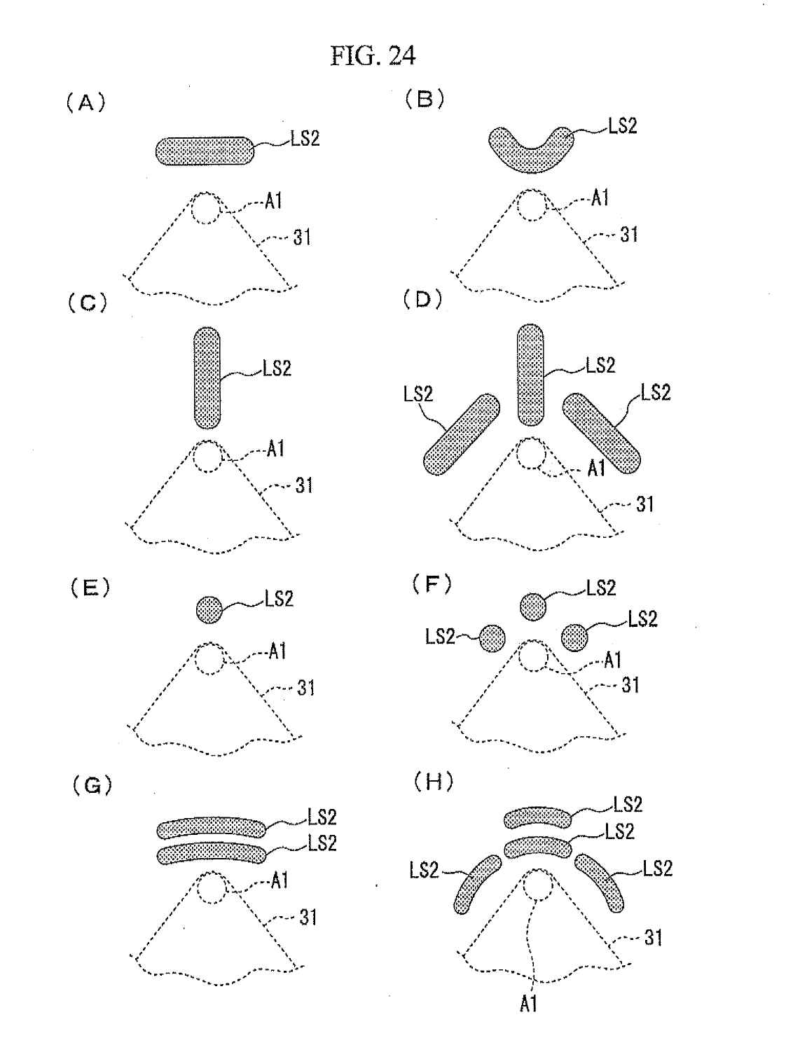

FIGS. 24(A)-(H) show examples of shapes of the second immersion space LS2 within the XY plane. Here, parts (A)-(H) of FIG. 24 each schematically show a liquid immersion member. For example, the liquid recovery part 21 and the lower surface 26 (the flat part 26S) are not shown in FIG. 24. As shown in FIG. 24(A), the shape of the second immersion, space LS2 within the XY plane may be a rectilinear strip) shape that is long in the Y axial directions. As shown in FIG. 24(B), within the XY plane, the second immersion space LS2 is curved such that its center part is disposed at a position closer to the first liquid immersion member 31 than its end parts are. As shown in FIG. 24(C), the shape of the second immersion space LS2 within the XY plane may be a rectilinear (i.e., strip) shape that is long in the X axial directions. As shown in FIG. 24(D), a plurality of the second immersion spaces LS2 may be disposed adjacent to the first guide space A1. In FIG. 24(D), each of the second immersion spaces LS2 extends in a strip within the XY plane. As shown in FIG. 24(E), the shape of the second immersion space LS2 within the XY plane may be circular. As shown in FIG. 24(F), a plurality of the circular second immersion spaces LS2 may be disposed within the XY plane adjacent to the first guide space A1. As shown in FIG. 24(G), a plurality of the second immersion spaces LS2 may be disposed in the radial directions with respect to the optical path K. As shown in FIG. 24(H), a plurality of the second immersion spaces LS2 may be disposed in the radial directions with respect to the optical path K and a plurality of the second immersion spaces LS2 may be disposed in the peripheral directions of the optical path K.

Here, the above-described embodiments with reference to FIGS. 13 to 22, the above-described embodiments with reference to FIG. 23, and the above-described embodiments with reference to FIG. 24 can be combined as appropriate.

### Seventh Embodiment

A seventh embodiment will now be explained. In the explanation below, constituent parts that are identical or equivalent to those in the embodiments discussed above are assigned identical symbols, and the explanations thereof are therefore abbreviated or omitted.

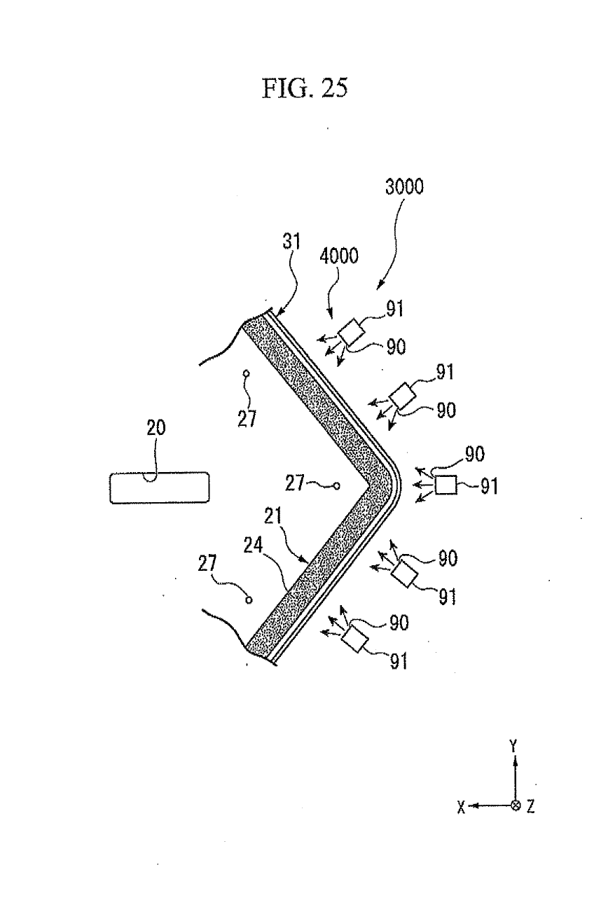

FIG. 25 is a view that shows one example of a liquid immersion member 3000 according to the seventh embodiment. The present embodiment explains an exemplary case wherein a guide part 4000 includes gas supply ports 90, which supply the gas from the outer side of the first immersion space LS1 toward the first immersion space LS1.

As shown in FIG. 25, the liquid immersion member 3000 comprises gas supply members 91, each of which has one of the gas supply ports 90 that supply the gas from the outer side of the first immersion space LS1 toward the first immersion space LS1. In the present embodiment, the gas supply ports 90 function as the guide part 4000. In the example shown in FIG. 25, the plurality of the gas supply ports 90 (i.e., gas supply members 91) is disposed at the outer side of the first liquid immersion member 31. The gas supply ports 90 are capable of supplying the gas from the outer side of the space SP1 toward the space SP1. The gas supply ports 90 are disposed such that they face the space SP1. The gas supply ports 90 are capable of supplying the gas to the interface LG1 of the liquid LQ in the first immersion space LS1.

The force of the gas supplied via the gas supply ports 90 to the first immersion space LS1 hinders the outflow of the liquid LQ from the first immersion space LS1 to the outer side of the space SP1. In addition, the gas supplied via the gas supply ports 90 causes at least some of the liquid LQ in the first immersion space LS1 to flow and to be guided to the first guide space A1. In addition, the gas supplied via the gas supply ports 90 causes at least some of the liquid LQ in the first immersion spaceLS1 to flow and to be guided to the second guide space A2.

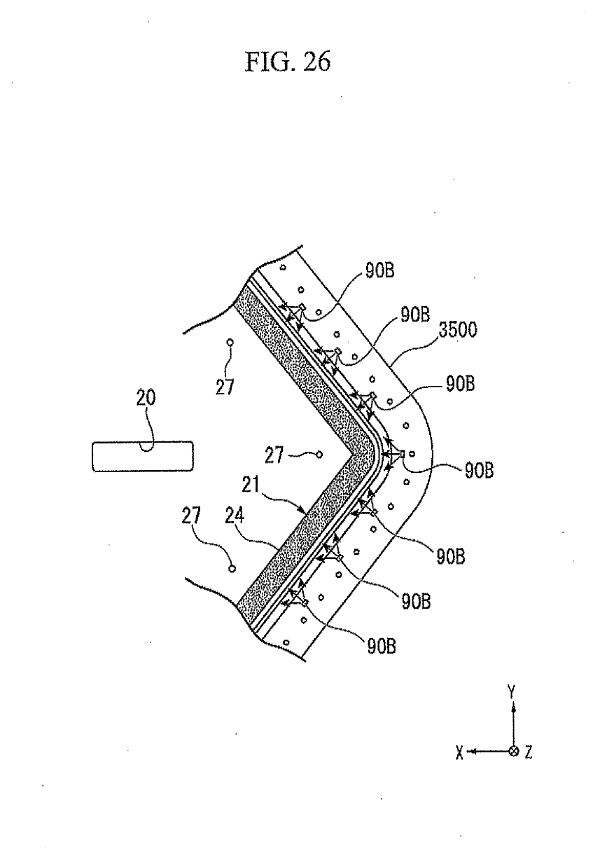

Furthermore, as shown in FIG. 26, gas supply ports 90B may be disposed in at least part of a second recovery member 3500. In addition, the gas supply ports 90B may be disposed in at least part of the first recovery member.

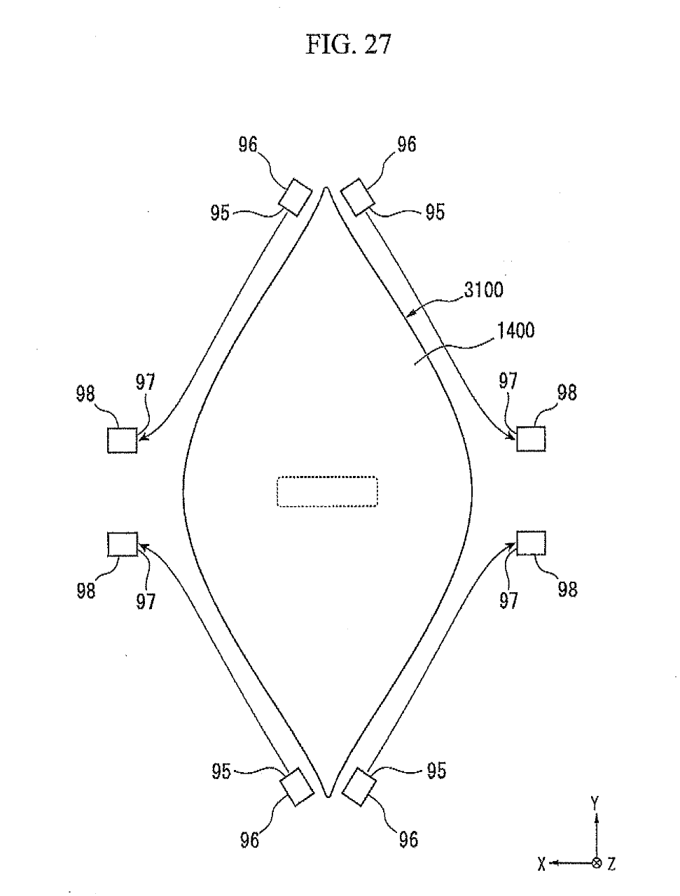

Furthermore, a lower surface 14G0 of a first liquid immersion member 3100 may have a shape as shown in FIG. 27. In addition, as shown in FIG. 27, gas supply members 96, each of which has a gas supply port 95 that is capable of generating a gas current around the space SP1 (i.e., the first immersion space LS1), and suction members 98, each of which has a suction port 97 that sucks at least some of the gas from the corresponding gas supply port 95, may be disposed. Generating gas currents around the space SP1 hinders the outflow of the liquid LQ from the first immersion space LS1 to the outer side of the space SP1. Here, FIG. 27 schematically shows a liquid immersion member. For example, the liquid recovery part 21 and the lower surface 26 (the flat part 268) are not shown in FIG. 27.

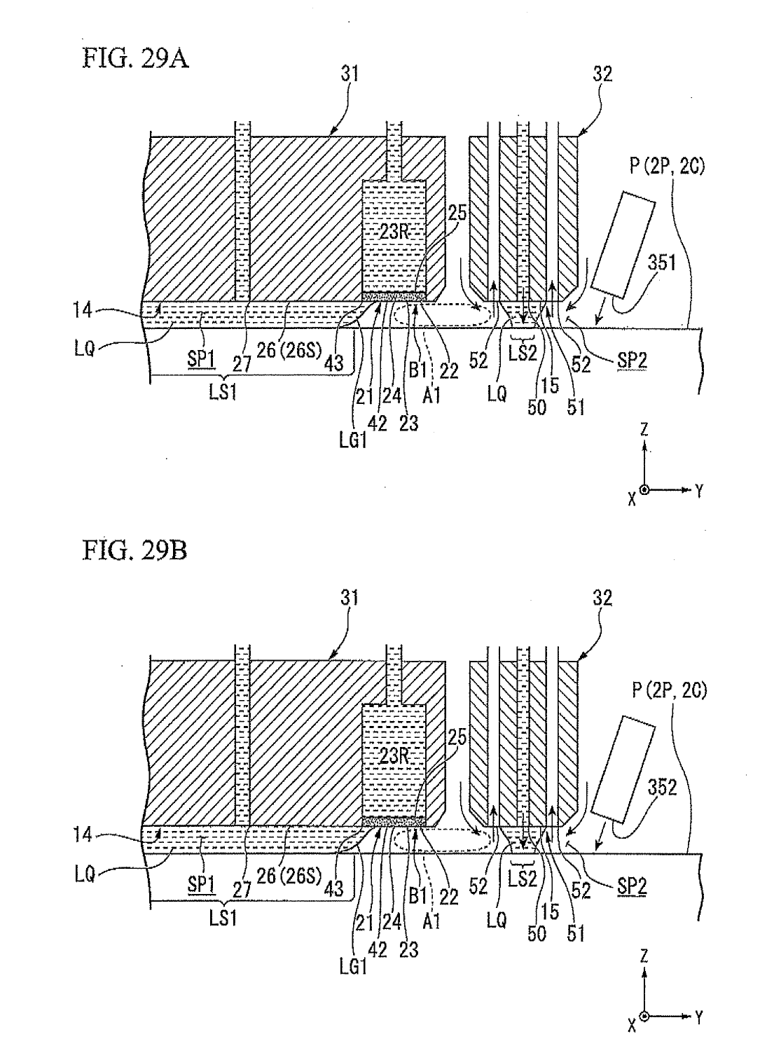

Furthermore, in the first through seventh embodiments discussed above, as shown in FIG. 29A, a gas supply port 351 may be provided adjacent to the outer side of the recovery port 52 of the second liquid immersion member (32, etc.) with respect to the optical path K. The gas supply port 351 supplies the gas from outside the recovery port 52 (the second liquid immersion member 32 and the like) toward the space SP2 (i.e., the second immersion space LS2). The gas supplied via the gas supply port 351 hinders the outflow of the liquid LQ from the space SP2 to the outer side of the space SP2. In this case, the gas supplied from the gas supply port 351 can be the same gas (e.g., air) as the gas supplied from the environmental control apparatus to the chamber CH, or can be a different gas (e.g., nitrogen) from the gas supplied to the chamber CH. Furthermore, in the first through seventh embodiments discussed above, as shown in FIG. 29B, a liquid supply port 352 may be provided adjacent to the outer side of the recovery port 52 of the second liquid immersion member (32, etc.) with respect to the optical path K. The liquid supply port 352 supplies the liquid from outside the recovery port 52 (the second liquid immersion member 32 and the like) toward the space SP2 (i.e., the second immersion space LS2). The liquid supplied via the liquid supply port 352 binders the outflow of the liquid LQ from the space SP2 to the outer side of the space SP2. The liquid supplied from the liquid supply port 352 can be the same liquid (e.g., pure water) as the liquid supplied from the supply port 50, or can be a different gas. Likewise, a gas supply port and/or a liquid supply port may be provided adjacent to the outer side of the recovery port 55 of the third liquid immersion member (33, etc.) with respect to the optical path K.

Furthermore, in the first through seventh embodiments discussed above, at least one of the liquid supply apparatus 27S, the liquid supply apparatus 28S, the liquid supply apparatus 50S, and the liquid supply apparatus 53S can be shared. In one example, the liquid LQ from the liquid supply apparatus 28S can be supplied to the supply ports 27, 28, 50, and 53. Or, the liquid LQ from the liquid supply apparatus 28S can be supplied to the supply ports 27 and 28, and the liquid LQ from the liquid supply apparatus 50S can be supplied to the supply ports 50 and 53.

Furthermore, in the first through seventh embodiments discussed above, the liquid LQ that forms the first immersion space LS1 and the liquid LQ that forms the second immersion space LS2 are the same liquid pure water), but they may be different liquids. Namely, the liquid supplied via the supply ports 28 (27) and the liquid supplied via the supply port 50 may be different types of liquid. In addition, the liquid supplied via the supply ports 28 (27) and the liquid supplied via the supply port 50 may be of different cleanliness levels, different temperatures, or different viscosities. In addition, the liquid LQ that forms the first immersion space LS1 and the liquid LQ that forms the third immersion space LS3 may be the same liquid (i.e., pure water) or different liquids. Namely, the liquid supplied via the supply ports 28 (27) and the liquid supplied via the supply port 53 may be the same liquid or different types of liquid. In addition, the liquid LQ that forms the second immersion space LS2 and the liquid LQ that forms the third immersion space LS3 may be the same liquid (i.e., pure water) or different liquids.

Furthermore, in each of the embodiments discussed above, the second immersion space LS2 is formed partly around the first immersion space LS1, but may be formed entirely around the first liquid immersion space LS1. In other words, the second immersion space LS2 may be formed in a ring such that it surrounds the first immersion space LS1. Thereby, the liquid LQ from the guide part (40, etc.) can be trapped by the second immersion space LS1. The liquid LQ from the first liquid immersion space LS1 can be recovered by the second immersion space LS2 without providing a guide part (e.g., the guide part 40).

Furthermore, in each of the embodiments discussed above, the “radial directions with respect to the optical path K” may be regarded as the radial directions with respect to the optical axis AX of the projection optical system PL in the vicinity of the projection area PR.

Furthermore, as discussed above, the control apparatus 4 comprises a computer system, which comprises a CPU and the like. In addition, the control apparatus 4 comprises an interface, which is capable of conducting communication between the computer system and an external apparatus. The storage apparatus 5 comprises a storage medium such as memory (e.g., RAM), a hard disk, a CD-ROM, and the like. In the storage apparatus 5, an operating system (OS) that controls a computer system is installed and a program for controlling the exposure apparatus EX is stored.

Furthermore, the control apparatus 4 may be connected to an input apparatus that is capable of inputting an input signal. The input apparatus comprises input equipment, such as a keyboard and a mouse, or a communication apparatus, which is capable of inputting data from the external apparatus. In addition, a display apparatus, such as a liquid crystal display, may be provided.

Various information, including the program stored in the storage apparatus 5, can be read by the control apparatus 4 (i.e., the computer system). In the storage apparatus 5, a program is stored that causes the control apparatus 4 to control the exposure apparatus EX such that the substrate P is exposed with the exposure light EL, which transits the liquid LQ.

The program stored in the storage apparatus 5 may cause the control apparatus 4 to execute the following processes in accordance with, the embodiments discussed above: a process that forms the first immersion space LS1 of the liquid LQ at the emergent surface 7 side of the last optical element 8 with the first liquid immersion member 31, which is disposed at least partly around the optical path K, such that the optical path K of the exposure light EL between the last optical element $ and the substrate P is filled with the liquid LQ; a process that exposes the substrate P through the liquid LQ of the first immersion space LS1; a process that guides at least some of the liquid LQ in the first immersion space LS1 to the first guide space A1, which extends partly around the optical path K; and a process that forms the second immersion space LS2 of the liquid LQ partly around the first immersion space LS1 and adjacent to the first guide space A1 with the second liquid immersion member 32, which is disposed at the outer side of the first liquid immersion member 31 with respect to the optical path K.

In addition, the program stored in the storage apparatus 5 may cause the control apparatus 4 to execute the following processes in accordance with the embodiments discussed above: a process that forms the first immersion space LS1 of the liquid LQ at the emergent surface 7 side of the last optical element 8 with the first liquid immersion member 31, which is disposed at least partly around the optical path K, such that the optical path K of the exposure light EL between the last optical element 8 and the substrate P is filled with the liquid LQ; a process that exposes the substrate P through the liquid LQ of the first immersion space LS1; and a process that forms the second immersion space LS2 of the liquid LQ partly around the first immersion space LS1 with the second liquid immersion member 32, which is disposed at the outer side of the first liquid immersion member 31 with respect to the optical path K and adjacent to the first liquid immersion member 31 in the first direction in which the substrate P moves in the prescribed operation of the substrate P.

In addition, the program stored in the storage apparatus 5 may cause the control apparatus 4 to execute the following processes in accordance with the embodiments discussed above: a process that forms a first immersion space of the first liquid at an emergent surface side of the optical member with a first liquid immersion member, which is disposed at least partly around the optical path, such that the optical path of the exposure light between the optical member and the substrate is filled with the first liquid; a process that exposes the substrate through the first liquid of the first immersion space; and a process that forms a second immersion space of a second liquid partly around the first immersion space with a second liquid immersion member, which is disposed at an outer side of the first liquid immersion member with respect to the optical path, the second liquid immersion member having a second supply port and a fluid recovery part, the substrate being capable of opposing the second supply port, the second liquid being capable of being supplied via the second supply port, the fluid recovery part being disposed such that it surrounds the second supply port, the substrate being capable of opposing the fluid recovery part.

In addition, the program stored in the storage apparatus 5 may cause the control apparatus 4 to execute the following processes in accordance with the embodiments discussed above: a process that forms a first immersion space of the first liquid at an emergent surface side of the optical member with a first liquid immersion member, which is disposed at least partly around the optical path, such that the optical path of the exposure light between the optical member and the substrate is filled with the first liquid; a process that exposes the substrate through the first liquid of the first immersion space; a process that forms a second immersion space of a second liquid with a second liquid immersion member, which is disposed at an outer side of the first liquid immersion member with, respect to the optical path, such that the second immersion space is partly around the first immersion space; and a process that recovers fluid by a fluid recovery part of a recovery member, which is disposed at an outer side of the first liquid immersion member with respect to the optical path.

In addition, the program stored in the storage apparatus 5 may cause the control apparatus 4 to execute the following processes in accordance with the embodiments discussed above: a process that forms a first immersion space of the first liquid at an emergent surface side of the optical member with a first liquid immersion member, which is disposed at least partly around the optical path, such that the optical path of the exposure light between the optical member and the substrate is filled with the first liquid; a process that exposes the substrate through the first liquid of the first immersion space; a process that forms a second immersion space of a second liquid with a second liquid immersion member, which is disposed at an outer side of the first liquid immersion member with respect to the optical path, such that the second immersion space is partly around the first immersion space; and a process that supplies gas via a gas supply port of a gas supply member from an outer side of a space between the first liquid immersion member and the object toward the space.

In addition, the program stored in the storage apparatus 5 may cause the control apparatus 4 to execute the following processes in accordance with the embodiments discussed above: a process that forms a first immersion space of the first liquid at an emergent surface side of the optical member with a first liquid immersion member, which is disposed at least partly around the optical path, such that the optical path of the exposure light between the optical member and the substrate is filled with the first liquid, the first liquid immersion member having a first lower surface, which is capable of opposing a front surface of the substrate with a first distance therebetween; a process that exposes the substrate through the first liquid of the first immersion space; and a process that forms a second immersion space of a second liquid with a second liquid immersion member, which is disposed at an outer side of the first liquid immersion member with respect to the optical path, such that the second immersion space is partly around the first immersion space, the second liquid immersion member having a second lower surface, which is capable of opposing a front surface of the substrate with a second distance therebetween, the second distance being smaller than the first distance.

In addition, the program stored in the storage apparatus 5 may cause the control apparatus 4 to execute the following processes in accordance with the embodiments discussed above: a process that forms a first immersion space of the first liquid at an emergent surface side of the optical member with a first liquid immersion member, which is disposed at least partly around the optical path, such that the optical path of the exposure light between the optical member and the substrate is filled with the first liquid; a process that exposes the substrate through the first liquid of the first immersion space; forms a second immersion space of a second liquid with a second liquid immersion member, which is disposed at an outer side of the first liquid immersion member with respect to the optical path, such that the second immersion space is partly around the first immersion space; and supplies gas from a gas supply port, which is disposed at an outer side of the second liquid immersion member with respect to the optical path.

The program stored in the storage apparatus 5 is read by the control apparatus 4, and thereby the various processes, such as the immersion exposure of the substrate P in the state wherein the first immersion space LS1 is formed, are executed in cooperation with the various apparatuses of the exposure apparatus EX, such as the substrate stage 2P, the measurement stage 2C, and the liquid immersion member 3.

Furthermore, in the each of the embodiments discussed above, the optical path K on the emergent surface 7 (i.e., the image plane) side of the last optical element 8 of the projection optical system PL is filled with the liquid LQ; however, the projection optical system PL may be a projection optical system wherein the optical path on the incident (i.e., the object plane) side of the last optical element 8 is also filled with the liquid LQ, as disclosed in for example, PCT International Publication No. WO2004/019128.

Furthermore, in each of the embodiments discussed above, the liquid LQ is water but may be a liquid other than water. Preferably, the liquid LQ is a liquid that is transparent with respect to the exposure light EL, has a high refractive index With respect to the exposure light EL, and is stable with respect to the projection optical system PL or the film of, for example, the photosensitive material (i.e., the photoresist) that forms the front surface of the substrate P. For example, the liquid LQ may be a fluorine-based liquid such as hydro-fluoro-ether (HFE), perfluorinated polyether (PFPE), or Fomblin® oil. In addition, the liquid LQ may be any of various fluids, for example, a supercritical fluid.

Furthermore, the substrate P in each of the embodiments discussed above is a semiconductor wafer for fabricating semiconductor devices, but it may be, for example, a glass substrate for display devices, a ceramic wafer for thin film magnetic heads, or the original plate of a mask or a reticle (e.g., synthetic quartz or a silicon wafer) used by an exposure apparatus.

Furthermore, the exposure apparatus EX in each of the embodiments discussed above is a step-and-scan type scanning exposure apparatus (i.e., a scanning stepper), which scans and exposes the pattern of the mask M by synchronously moving the mask M and the substrate P, but the exposure apparatus EX may be for example, a step-and-repeat type projection exposure apparatus (i.e., a stepper), which performs a full field exposure of the pattern of the mask M—with the mask M and the substrate P in a stationary state—and then sequentially steps the substrate P.

In addition, the exposure apparatus EX may be a full-field exposure apparatus (i.e., a stitching type full-field exposure apparatus), which performs a full-field exposure of the substrate P; in this case, a step-and-repeat type exposure is performed using the projection optical system to transfer a reduced image of a first pattern onto the substrate P in a state wherein the first pattern and the substrate P are substantially stationary, after which the projection optical system is used to partially superpose a reduced image of a second pattern onto the transferred first pattern in the state wherein the second pattern, and the substrate P are substantially stationary. In addition, the stitching type exposure apparatus may be a step-and-stitch type exposure apparatus that successively transfers at least two patterns onto the substrate P such that they are partially superposed and steps the substrate P.

In addition, the exposure apparatus EX may be an exposure apparatus that combines on the substrate the patterns of two masks through a projection optical system and double exposes, substantially simultaneously, a single shot region on the substrate using a single scanning exposure, as disclosed in, for example, U.S. Pat. No. 6,611,316. In addition, the exposure apparatus EX may be a proximity type exposure apparatus, a mirror projection aligner, or the like.

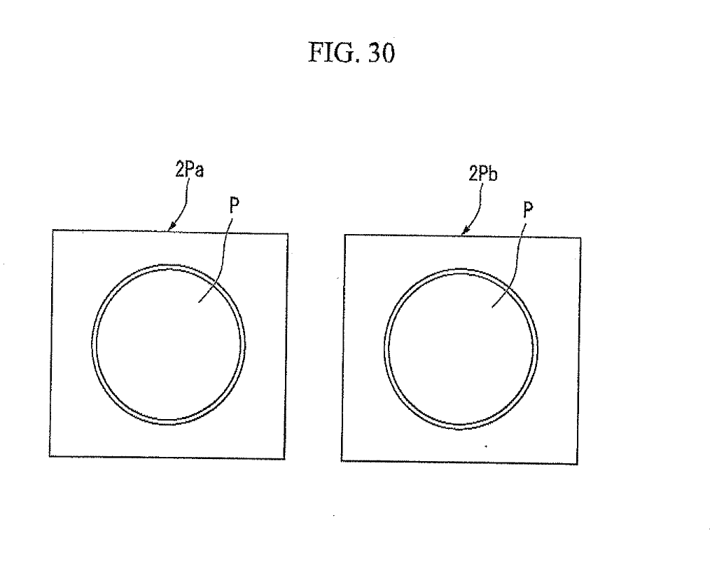

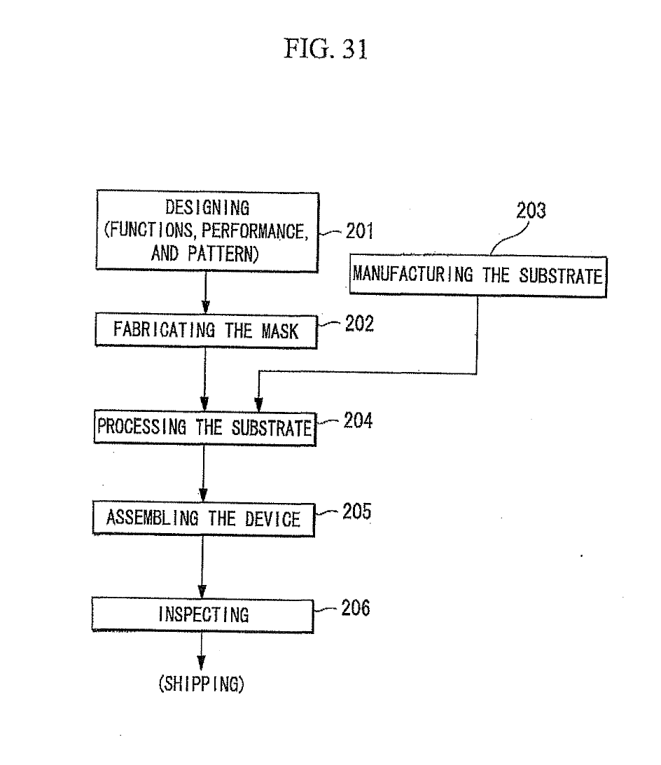

In addition, the exposure apparatus EX may be a twin stage type exposure apparatus, which comprises a plurality of substrate stages, as disclosed in, for example, U.S. Pat. Nos. 6,341,007, 6,208,407, and 6,262,796. For example, as shown in FIG. 30, if the exposure apparatus EX comprises two of the substrate stages 2Pa and 2Pb, then the object that is capable of being disposed such that it opposes the emergent surface 7 is one of the substrate stages, a substrate held by a substrate holding part on that substrate stage, the other of the substrate stages, the substrate held by a substrate holding part on that other substrate stage, or combinations thereof.

In addition, the exposure apparatus EX may be an exposure apparatus that comprises a plurality of the substrate stages and the measurement stages.

The exposure apparatus EX may be a semiconductor device fabrication exposure apparatus that exposes the substrate P with the pattern of a semiconductor device, an exposure apparatus used for fabricating, for example, liquid crystal devices or displays, or an exposure apparatus for fabricating thin film magnetic heads, image capturing devices (e.g., CCDs), micromachines, MEMS, DNA chips, or reticles and masks.

Furthermore, in each of the embodiments discussed above, the position of each of the stages is measured using the interferometer system 13, but the present invention is not limited thereto; for example, an encoder system that detects a scale (i.e., a diffraction grating) provided to each of the stages may be used, or the interferometer system may be used in parallel with the encoder system.

Furthermore, in the embodiments discussed above, the optically transmissive mask wherein a prescribed shielding pattern (or phase pattern or dimming pattern) is formed on an optically transmissive substrate is used; however, instead of such a mask, a variable shaped mask (also called an electronic mask, an active mask, or an image generator), wherein a transmissive pattern, a reflective pattern, or a light emitting pattern is formed based on electronic data of the pattern to be exposed, as disclosed in, for example, U.S. Pat. No. 6,778,257, may be used. In addition, instead of a variable shaped mask that comprises a non-emissive type image display device, a pattern forming apparatus that comprises a self-luminous type image display device may be provided.

In each of the embodiments discussed above, the exposure apparatus EX comprises the projection optical system PL; however, the constituent elements explained in each of the embodiments discussed above may be adapted to an exposure apparatus and an exposing method that does not use the projection optical system PL. For example, the constituent elements explained in each of the embodiments discussed above may be adapted to an exposure apparatus and an exposing method wherein an immersion, space is formed between the substrate and an optical member such as a lens, and the exposure light is radiated to the substrate via that optical member.

In addition, the exposure apparatus EX may be an exposure apparatus (i.e., a lithographic system) that exposes the substrate P with a line-and-space pattern by forming interference fringes on the substrate P, as disclosed in, for example, PCT International Publication No. WO2001/035168.

The exposure apparatus LX according to the embodiments discussed above is manufactured by assembling various subsystems, including each constituent element discussed above, so that prescribed mechanical, electrical, and optical accuracies are maintained. To ensure these various accuracies, adjustments are performed before and after this assembly, including an adjustment to achieve optical accuracy for the various optical systems, an adjustment to achieve mechanical accuracy for the various mechanical systems, and an adjustment to achieve electrical accuracy for the various electrical systems. The process of assembling the exposure apparatus from the various subsystems includes, for example, the connection of mechanical components, the wiring and connection of electrical circuits, and the piping and connection of the pneumatic circuits among the various subsystems. Naturally, prior to performing the process of assembling the exposure apparatus from these various subsystems, there are also the processes of assembling each individual subsystem. After the process of assembling the exposure apparatus from the various subsystems is complete, a comprehensive adjustment is performed to ensure the various accuracies of the exposure apparatus as a whole. Furthermore, it is preferable to manufacture the exposure apparatus in a clean room, wherein the temperature, the cleanliness level, and the like are controlled.

As shown in FIG. 28, a microdevice, such as a semiconductor device, is manufactured by: a step 201 that designs the functions and performance of the microdevice; a step 202 that fabricates the mask (i.e., the reticle) based on this designing step; a step 203 that manufactures the substrate, which is the base material of the device; a substrate processing step 204 that comprises a substrate, process (i.e., an exposure process) that includes, in accordance with the embodiments discussed above, exposing the substrate with the exposure light that emerges from the pattern of the mask and developing the exposed substrate a device assembling step 205 (which includes fabrication processes such as dicing, bonding, and packaging processes); an inspecting step 206; and the like.

Furthermore, the features of each of the embodiments discussed above can be combined as appropriate. In addition, there are also cases wherein seine of the constituent elements axe not used. In addition, each disclosure of every Japanese published patent application and U.S. patent related to the exposure apparatus recited in each of the embodiments discussed above, the modified examples, and the like is hereby incorporated by reference in its entirety to the extent permitted by the national laws and regulations.

1. A liquid immersion member, inside an immersion exposure apparatus, that is disposed at least partly around an optical member and an optical path of exposure light, which passes through a first liquid between the optical member and an object, the liquid immersion member comprising:
a first liquid immersion member, which is disposed at least partly around the optical path and forms a first immersion space of the first liquid at an emergent surface side of the optical member such that the optical path of the exposure light between the optical member and the object is filled with the first liquid;
a guide part, which guides at least some of the first liquid in the first immersion space to a first guide space, which is partly around the optical path; and
a second liquid immersion member, which is disposed at an outer side of the first liquid immersion member with respect to the optical path and forms a second immersion space of a second liquid partly around the first immersion space and adjacent to the first guide space.

2. The liquid immersion member according to claim 1, wherein
the guide part extends linearly or in a strip; and
at least part of the guide part is curved.

3. The liquid immersion member according to claim 1, wherein
the guide part comprises a first guide part, which extends, within a plane that is substantially parallel to the front surface of the object, from one side of an axis that passes through the second immersion space toward the first guide space.

4. The liquid immersion member according to claim 3, wherein
the guide part comprises a second guide part, which extends, within the plane that is substantially parallel to the front surface of the object, from an other side of the axis toward the first guide space; and
within the plane that is substantially parallel to the object, a spacing between the first guide part and the second guide part in directions perpendicular to the axis becomes smaller as it approaches the first guide space.

5. The liquid immersion member according to claim 3, wherein
the spacing between the first guide part and the second guide part becomes smaller as it becomes spaced apart from the optical path.

6. The liquid immersion member according to claim 3, wherein
the guide part guides, to the first guide space, at least some of the first liquid that forms the first immersion space and that flows by movement of the object including movement in a first direction that is parallel to the axis.

7. The liquid immersion member according to claim 1, wherein
the guide part guides, to a second guide space, which is partly around the optical path and is different from the first guide space, at least some of the first liquid in the first immersion space.

8. The liquid immersion member according to claim 7, further comprising:
a third liquid immersion member, which is disposed at the outer side of the first liquid immersion member with respect to the optical path, that forms a third immersion space of a third liquid, which is different from the second immersion space, partly around the first immersion space and adjacent to the second guide space.

9. The liquid immersion member according to claim 8, wherein
the guide part comprises:
a third guide part, which extends, within the plane that is substantially parallel to the front surface of the object, from one side of an axis that passes through the third immersion space toward the second guide space; and
a fourth guide part, which extends from other side of the axis toward the second guide space; and
within the plane that is substantially parallel to the object, a spacing between the third guide part and the fourth guide part in directions perpendicular to the axis becomes smaller as it approaches the second guide space.

10. The liquid immersion member according to claim 8, wherein
the spacing between the third guide part and the fourth guide part becomes smaller as it becomes more spaced apart from the optical path.

11. The liquid immersion member according to claim 8, wherein
the third immersion space is formed at the opposite side of the optical path to the second immersion space.

12. The liquid immersion member according to claim 8, wherein
the third immersion space is formed at the same side of the optical path as the second immersion space is.

13. The liquid immersion member according to claim 8, wherein
the second immersion space and the third immersion space are formed substantially spaced apart from each other.

14. The liquid immersion member according to claim 1, wherein
at least part of the guide part is disposed in the first liquid immersion member.

15. The liquid immersion member according to claim 14, wherein
the guide part includes an edge of a peripheral edge part of the first liquid immersion member.

16. The liquid immersion member according to claim 14, wherein
the first liquid immersion member comprises a liquid recovery part, which is disposed such that the object opposes it and which is capable of recovering the first liquid; and
the guide part includes at least part of the liquid recovery part.

17. The liquid immersion member according to claim 16, wherein
the liquid recovery part includes at least part of a lower surface of a porous member.

18. The liquid immersion member according to claim 14, wherein
the first liquid immersion member comprises a liquid recovery part, which is disposed such that the object opposes it and which is capable of recovering the first liquid, and a flat part, which is disposed such that the object opposes it, that adjoins the liquid recovery part; and
the guide part includes a boundary between the liquid recovery part and the flat part.

19. The liquid immersion member according to claim 18, wherein
the liquid recovery part includes at least part of the lower surface of the porous member.

20. The liquid immersion member according to claim 14, wherein
the first liquid immersion member includes a first area, which is disposed such that the object opposes it, and a second area, which is disposed such that the object opposes it and wherein the contact angle of the first liquid with respect to the second area is smaller than the contact angle of the first liquid with respect to the first area; and
the guide part includes the second area.

21. The liquid immersion member according to claim 14, wherein
the first liquid immersion member includes the first area, which is disposed such that the object opposes it, and the second area, which is disposed such that the object opposes it and wherein the contact angle of the first liquid with respect to the second area is smaller than the contact angle of the first liquid with respect to the first area; and
the guide part includes the boundary between the first area and the second area.

22. The liquid immersion member according to claim 14, wherein
the first liquid immersion member includes the first area, which is disposed such that the object opposes it, and the second area, which is disposed such that the object opposes it and whose height is different from that of the first area; and
the guide part includes the boundary between the first area and the second area.

23. The liquid immersion member according to claim 1, wherein
the guide part includes a gas supply port, which supplies a gas from the outer side of the first immersion space toward the first immersion space.

24. The liquid immersion member according to claim 1, wherein
the first guide space includes a space between part of the peripheral edge part of the first liquid immersion member and the object.

25. The liquid immersion member according to claim 24, wherein
the first liquid immersion member comprises a liquid recovery part, which is disposed such that the object opposes it and which is capable of recovering the first liquid; and
the first guide space includes the space between at least part of the liquid recovery part and the object.

26. The liquid immersion member according to claim 25, wherein
the liquid recovery part includes at least part of the lower surface of the porous member.

27. The liquid immersion member according to claim 1, wherein
the first guide space is defined as being between the second immersion space and the optical path.

28. A liquid immersion member, inside an immersion exposure apparatus, that is disposed at least partly around an optical member and an optical path of exposure light, which passes through a first liquid between the optical member and an object passes, the liquid immersion member comprising:
a first liquid immersion member, which is disposed at least partly around the optical path and forms a first immersion space of the first liquid at an emergent surface side of the optical member such that the optical path of the exposure light between the optical member and the object is filled with the first liquid; and
a second liquid immersion member, which is disposed at the outer side of the first liquid immersion member with respect to the optical path and adjacent to the first liquid immersion member in a first direction in which the object moves in a prescribed operation of the immersion exposure apparatus, that forms a second immersion space of a second liquid partly around the first immersion space.

29. The liquid immersion member according to claim 28, wherein
in the prescribed operation, the object moves in the first direction under a condition wherein a prescribed permissible condition under which the first immersion space of the first liquid between the first liquid immersion member and the object can be maintained is not satisfied.

30. The liquid immersion member according to claim 29, wherein
in the prescribed operation, the object moves in the first direction by a distance that is longer than a prescribed permissible distance over which the first immersion space of the first liquid between the first liquid immersion member and the object can be maintained.

31. The liquid immersion member according to claim 29, wherein
in the prescribed operation, the object moves in the first direction at a velocity that is faster than a prescribed permissible velocity at which the first immersion space of the first liquid between the first liquid immersion member and the object can be maintained.

32. The liquid immersion member according to claim 28, wherein
the object includes a plurality of objects; and
in the movement of the plurality of objects in the first direction, the front surfaces of the objects traverse the optical path of the exposure light.

33. The liquid immersion member according to claim 1, wherein
the object is a substrate that is exposed by the exposure light, which passes through the liquid, and moves based on an exposure condition of a plurality of shot regions on the substrate.

34. The liquid immersion member according to claim 1, wherein
the second immersion space is formed substantially spaced apart from the first immersion space.

35. The liquid immersion member according to claim 1, wherein
the second liquid immersion member has a second supply port, which is capable of supplying the second liquid.

36. The liquid immersion member according to claim 35, wherein
the second liquid immersion member comprises a fluid recovery part, which is disposed such that the object opposes it and which is capable of recovering a fluid.

37. The liquid immersion member according to claim 36, wherein
the fluid recovery part is disposed between the first liquid immersion member and the second supply port.

38. The liquid immersion member according to claim 36, wherein
the fluid recovery part is disposed at the outer side of the second supply port with respect to the first liquid immersion member.

39. The liquid immersion member according to claim 36, wherein
the fluid recovery part is provided such that it surrounds the second supply port.

40. A liquid immersion member, inside an immersion exposure apparatus, that is disposed at least partly around an optical member and an optical path of exposure light, which passes through a first liquid between the optical member and an object, the liquid immersion member comprising:
a first liquid immersion member, which is disposed at least partly around the optical path and forms a first immersion space of the first liquid at an emergent surface side of the optical member such that the optical path of the exposure light between the optical member and the object is filled with the first liquid; and
a second liquid immersion member, which is disposed at an outer side of the first liquid immersion member with respect to the optical path and forms a second immersion space of a second liquid partly around the first immersion space, wherein
the second liquid immersion member comprises a second supply port, which is disposed such that the object opposes it and which is capable of supplying the second liquid, and a fluid recovery part, which is disposed such that it surrounds the second supply port and such that the object opposes it and which is capable of recovering a fluid.

41. The liquid immersion member according to claim 40, wherein
the second liquid immersion member is disposed adjacent to the first liquid immersion member in a first direction in which the object moves in a prescribed operation of the immersion exposure apparatus.

42. The liquid immersion member according to claim 40, wherein
the second liquid immersion member is disposed in part of a space around the first liquid immersion member such that it opposes an outer surface of the first liquid immersion member.

43. The liquid immersion member according to claim 40, wherein
a fluid recovery part of the second liquid immersion member is capable of recovering the first liquid from a space between the first liquid immersion member and the object.

44. The liquid immersion member according to claim 40, wherein
the fluid recovery part is capable of recovering at least one of the first liquid, the second liquid, and a gas, in a space between the second liquid immersion member and the object.

45. The liquid immersion member according to claim 40, further comprising:
a third liquid immersion member, which is disposed at the outer side of the first liquid immersion member with respect to the optical path, that forms a third immersion space of a third liquid, which is different from the second immersion space, partly around the first immersion space.

46. The liquid immersion member according to claim 45, wherein
the third liquid immersion member comprises a third supply port, which is disposed such that the object opposes it and which is capable of supplying the third liquid, and a fluid recovery part, which is disposed such that it surrounds the third supply port and such that the object opposes it and which is capable of recovering a fluid.

47. The liquid immersion member according to claim 45, wherein
the third immersion space is formed substantially spaced apart from the first immersion space.

48. The liquid immersion member according to claim 45, wherein
the first liquid immersion member, the second liquid immersion member, and the third liquid immersion member are spaced apart from each other.

49. The liquid immersion member according to claim 45, wherein
the third liquid immersion member is disposed at an opposite side to the second liquid immersion member with respect to the optical path.

50. The liquid immersion member according to claim 49, wherein,
in a state in which the first immersion space is formed, the object is moved in a first direction, and wherein
the second liquid immersion member is disposed at one side with respect to the first liquid immersion member in the first direction, and the third liquid immersion member is disposed at another side with respect to the first liquid immersion member in the first direction.

51. The liquid immersion member according to claim 45, wherein
the third liquid immersion member is disposed at the same side as the second liquid immersion member with respect to the optical path.

52. The liquid immersion member according to claim 45, further comprising:
a recovery member, which is disposed at least partly around the first liquid immersion member and which has a fluid recovery part, the fluid recovery part being capable of recovering a fluid and being different from a fluid recovery part of the second liquid immersion member.

53. The liquid immersion member according to claim 52, wherein
the recovery member is disposed in part of a space around the first liquid immersion member such that it opposes an outer surface of the first liquid immersion member.

54. A liquid immersion member, inside an immersion exposure apparatus, that is disposed at least partly around an optical member and an optical path of exposure light, which passes through a first liquid between the optical member and an object, the liquid immersion member comprising:
a first liquid immersion member, which is disposed at least partly around the optical path and forms a first immersion space of the first liquid at an emergent surface side of the optical member such that the optical path of the exposure light between the optical member and the object is filled with the first liquid;
a second liquid immersion member, which is disposed at an outer side of the first liquid immersion member with respect to the optical path and forms a second immersion space of a second liquid partly around the first immersion space; and
a recovery member, which is disposed at an outer side of the first liquid immersion member with respect to the optical path and which has a fluid recovery part, the fluid recovery part being capable of recovering a fluid.

55. The liquid immersion member according to claim 54, wherein
the second liquid immersion member and the recovery member are disposed in part of a space around the first liquid immersion member such that they oppose an outer surface of the first liquid immersion member.

56. The liquid immersion member according to claim 54, further comprising:
a third liquid immersion member, which is disposed at the outer side of the first liquid immersion member with respect to the optical path, that forms a third immersion space of a third liquid partly around the first immersion space, wherein
the recovery member is disposed between the second liquid immersion member and the third liquid immersion member.

57. The liquid immersion member according to claim 54, wherein
the second liquid immersion member is disposed adjacent to the first liquid immersion member in a first direction in which the object moves in a prescribed operation of the immersion exposure apparatus, and wherein
the recovery member is disposed adjacent to the first liquid immersion member in a second direction intersecting with the first direction.

58. The liquid immersion member according to claim 57, wherein
the recovery member comprises a first recovery member, which is disposed at one side with respect to the first liquid immersion member in the second direction, and a second recovery member, which is disposed at another side.

59. The liquid immersion member according to claim 52, wherein
the fluid recovery part of the recovery member comprises a recovery port, which suctions fluid.

60. A liquid immersion member, inside an immersion exposure apparatus, that is disposed at least partly around an optical member and an optical path of exposure light, which passes through a first liquid between the optical member and an object, the liquid immersion member comprising:
a first liquid immersion member, which is disposed at least partly around the optical path and forms a first immersion space of the first liquid at an emergent surface side of the optical member such that the optical path of the exposure light between the optical member and the object is filled with the first liquid;
a second liquid immersion member, which is disposed at an outer side of the first liquid immersion member with respect to the optical path and forms a second immersion space of a second liquid partly around the first immersion space; and
a gas supply member that has a gas supply port, which supplies a gas from an outer side of a space between the first liquid immersion member and the object toward the space.

61. The liquid immersion member according to claim 60, wherein
the gas supply member is disposed in part of a space around the first liquid immersion member such that it opposes an outer surface of the first liquid immersion member.

62. The liquid immersion member according to claim 60, further comprising:
a third liquid immersion member, which is disposed at the outer side of the first liquid immersion member with respect to the optical path, that forms a third immersion space of a third liquid partly around the first immersion space, wherein
the gas supply member is disposed between the second liquid immersion member and the third liquid immersion member.

63. The liquid immersion member according to claim 60, wherein
the second liquid immersion member is disposed adjacent to the first liquid immersion member in a first direction in which the object moves in a prescribed operation of the immersion exposure apparatus, and wherein
the gas supply member is disposed adjacent to the first liquid immersion member in a second direction intersecting with the first direction.

64. The liquid immersion member according to claim 63, wherein
the gas supply member comprises a first gas supply member, which is disposed at one side with respect to the first liquid immersion member in the second direction, and a second gas supply member, which is disposed at another side.

65. The liquid immersion member according to claim 60, wherein
the gas supply member comprises a recovery port, which recoveries fluid.

66. The liquid immersion member according to claim 60, wherein
the supply port supplies a gas to the space so as to guide, to a first guide space, which is partly around the optical path, at least some of the first liquid in the first immersion space.

67. The liquid immersion member according to claim 1, wherein
the first liquid immersion member comprises a first lower surface, the object being capable of opposing the first lower surface, the first liquid immersion space being capable of being formed between the first lower surface and the object, and wherein
the second liquid immersion member comprises a second lower surface, the object being capable of opposing the second lower surface, the second liquid immersion space being capable of being formed between the second lower surface and the object, and wherein
a distance between the second lower surface and a front surface of the object is smaller than a distance between the first lower surface and a front surface of the object.

68. A liquid immersion member, inside an immersion exposure apparatus, that is disposed at least partly around an optical member and an optical path of exposure light, which passes through a first liquid between the optical member and an object, the liquid immersion member comprising:
a first liquid immersion member, which is disposed at least partly around the optical path, and which has a first lower surface the object being capable of opposing, and which forms a first immersion space of the first liquid at an emergent surface side of the optical member such that the optical path of the exposure light between the optical member and the object is filled with the first liquid; and
a second liquid immersion member, which is disposed at an outer side of the first liquid immersion member with respect to the optical path, and which has a second lower surface the object being capable of opposing, and which forms a second immersion space of a second liquid partly around the first immersion space, wherein
a distance between the second lower surface and a front surface of the object is smaller than a distance between the first lower surface and a front surface of the object.

69. The liquid immersion member according to claim 68, wherein
the second liquid immersion member comprises a second supply port, which is disposed on the second lower surface and supplies the second liquid, and a fluid recovery part, which is disposed on the second lower surface and recovers fluid.

70. The liquid immersion member according to claim 68, wherein
the second liquid immersion member is disposed in part of a space around the first liquid immersion member such that it opposes an outer surface of the first liquid immersion member.

71. The liquid immersion member according to claim 1, further comprising:
a gas supply port, which is disposed at an outer side of the second liquid immersion member with respect to the optical path and supplies gas.

72. A liquid immersion member, inside an immersion exposure apparatus, that is disposed at least partly around an optical member and an optical path of exposure light, which passes through a first liquid between the optical member and an object, the liquid immersion member comprising:
a first liquid immersion member, which is disposed at least partly around the optical path and forms a first immersion space of the first liquid at an emergent surface side of the optical member such that the optical path of the exposure light between the optical member and the object is filled with the first liquid;
a second liquid immersion member, which is disposed at an outer side of the first liquid immersion member with respect to the optical path and forms a second immersion space of a second liquid partly around the first immersion space; and
a gas supply port, which is disposed at an outer side of the second liquid immersion member with respect to the optical path and supplies gas.

73. The liquid immersion member according to claim 72, wherein
the second liquid immersion member comprises a second supply port, which is disposed such that the object opposes it and which is capable of supplying the second liquid, and a fluid recovery part, which is disposed such that the object opposes it and which is capable of recovering a fluid.

74. The liquid immersion member according to claim 72, wherein
the gas supply port supplies gas from an outer side of the second liquid immersion member toward a space between the second liquid immersion member and the object.

75. The liquid immersion member according to claim 74, wherein
the gas supply port supplies the gas so as to suppress that the second liquid in the space flows out of the space.

76. The liquid immersion member according to claim 40, wherein
the second immersion space is formed substantially spaced apart from the first immersion space.

77. The liquid immersion member according to claim 40, wherein
the first liquid immersion member and the second liquid immersion member are spaced apart from each other.

78. The liquid immersion member according to claim 1, wherein
the first liquid immersion member comprises a first supply port, which is disposed such that the object opposes it and which is capable of supplying the first liquid.

79. The liquid immersion member according to claim 78, wherein
the first liquid immersion member comprises a liquid recovery part, which is disposed such that the object opposes it and which is capable of recovering the first liquid.

80. The liquid immersion member according to claim 79, wherein
the fluid recovery part is disposed at an outer side of the first supply port in a radial direction with respect to the optical path.

81. The liquid immersion member according to claim 1, wherein
the first liquid and the second liquid are the same liquid.

82. The liquid immersion member according to claim 1, wherein
the first liquid and the second liquid include pure water.

83. The liquid immersion member according to claim 1, wherein
the second immersion space is smaller than the first immersion space.

84. An immersion exposure apparatus that exposes a substrate with exposure light through a first liquid, comprising:
a liquid immersion member according to claim 1.

85. A device fabricating method, comprising the steps of:
exposing a substrate using an immersion exposure apparatus according to claim 84; and
developing the exposed substrate.

86. An exposing method that exposes a substrate with exposure light through a first liquid, which fills an optical path of the exposure light between the substrate and an optical member wherefrom the exposure light can emerge, the method comprising:
forming a first immersion space of the first liquid at an emergent surface side of the optical member with a first liquid immersion member, which is disposed at least partly around the optical path, such that the optical path of the exposure light between the optical member and the substrate is filled with the first liquid;
exposing the substrate through the first liquid of the first immersion space;
guiding at least some of the first liquid in the first immersion space to a first guide space, which is partly around the optical path; and
forming a second immersion space of a second liquid with a second liquid immersion member, which is disposed at an outer side of the first liquid immersion member with respect to the optical path, such that the second immersion space is partly around the first immersion space and is adjacent to the first guide space.

87. An exposing method that exposes a substrate with exposure light through a first liquid, which fills an optical path of the exposure light between the substrate and an optical member wherefrom the exposure light can emerge, the method comprising:
forming a first immersion space of the first liquid at an emergent surface side of the optical member with a first liquid immersion member, which is disposed at least partly around the optical path, such that the optical path of the exposure light between the optical member and the substrate is filled with the first liquid;
exposing the substrate through the first liquid of the first immersion space; and
forming a second immersion space of a second liquid partly around the first immersion space with a second liquid immersion member, which is disposed at the outer side of the first liquid immersion member with respect to the optical path and adjacent to the first liquid immersion member in a first direction in which the substrate moves in a prescribed operation of the substrate.

88. An exposing method that exposes a substrate with exposure light through a first liquid, which fills an optical path of the exposure light between the substrate and an optical member wherefrom the exposure light can emerge, the method comprising:
forming a first immersion space of the first liquid at an emergent surface side of the optical member with a first liquid immersion member, which is disposed at least partly around the optical path, such that the optical path of the exposure light between the optical member and the substrate is filled with the first liquid;
exposing the substrate through the first liquid of the first immersion space; and
forming a second immersion space of a second liquid partly around the first immersion space with a second liquid immersion member, which is disposed at an outer side of the first liquid immersion member with respect to the optical path, the second liquid immersion member having a second supply port and a fluid recovery part, the substrate being capable of opposing the second supply port, the second liquid being capable of being supplied via the second supply port, the fluid recovery part being disposed such that it surrounds the second supply port, the substrate being capable of opposing the fluid recovery part.

89. An exposing method that exposes a substrate with exposure light through a first liquid, which fills an optical path of the exposure light between the substrate and an optical member wherefrom the exposure light can emerge, the method comprising:
forming a first immersion space of the first liquid at an emergent surface side of the optical member with a first liquid immersion member, which is disposed at least partly around the optical path, such that the optical path of the exposure light between the optical member and the substrate is filled with the first liquid;
exposing the substrate through the first liquid of the first immersion space;
forming a second immersion space of a second liquid with a second liquid immersion member, which is disposed at an outer side of the first liquid immersion member with respect to the optical path, such that the second immersion space is partly around the first immersion space; and
recovering fluid by a fluid recovery part of a recovery member, which is disposed at an outer side of the first liquid immersion member with respect to the optical path.

90. An exposing method that exposes a substrate with exposure light through a first liquid, which fills an optical path of the exposure light between the substrate and an optical member wherefrom the exposure light can emerge, the method comprising:
forming a first immersion space of the first liquid at an emergent surface side of the optical member with a first liquid immersion member, which is disposed at least partly around the optical path, such that the optical path of the exposure light between the optical member and the substrate is filled with the first liquid;
exposing the substrate through the first liquid of the first immersion space;
forming a second immersion space of a second liquid with a second liquid immersion member, which is disposed at an outer side of the first liquid immersion member with respect to the optical path, such that the second immersion space is partly around the first immersion space; and
supplying gas via a gas supply port of a gas supply member from an outer side of a space between the first liquid immersion member and the object toward the space.

91. An exposing method that exposes a substrate with exposure light through a first liquid, which fills an optical path of the exposure light between the substrate and an optical member wherefrom the exposure light can emerge, the method comprising:
forming a first immersion space of the first liquid at an emergent surface side of the optical member with a first liquid immersion member, which is disposed at least partly around the optical path, such that the optical path of the exposure light between the optical member and the substrate is filled with the first liquid, the first liquid immersion member having a first lower surface, which is capable of opposing a front surface of the substrate with a first distance therebetween;
exposing the substrate through the first liquid of the first immersion space; and
forming a second immersion space of a second liquid with a second liquid immersion member, which is disposed at an outer side of the first liquid immersion member with respect to the optical path, such that the second immersion space is partly around the first immersion space, the second liquid immersion member having a second lower surface, which is capable of opposing a front surface of the substrate with a second distance therebetween, the second distance being smaller than the first distance.

92. An exposing method that exposes a substrate with exposure light through a first liquid, which fills an optical path of the exposure light between the substrate and an optical member wherefrom the exposure light can emerge, the method comprising:
forming a first immersion space of the first liquid at an emergent surface side of the optical member with a first liquid immersion member, which is disposed at least partly around the optical path, such that the optical path of the exposure light between the optical member and the substrate is filled with the first liquid;
exposing the substrate through the first liquid of the first immersion space;
forming a second immersion space of a second liquid with a second liquid immersion member, which is disposed at an outer side of the first liquid immersion member with respect to the optical path, such that the second immersion space is partly around the first immersion space; and
supplying gas from a gas supply port, which is disposed at an outer side of the second liquid immersion member with respect to the optical path.

93. A device fabricating method, comprising the steps of:
exposing a substrate using an exposing method according to claim 86; and
developing the exposed substrate.

94. A program that causes a computer to control an immersion exposure apparatus that exposes a substrate with exposure light through a first liquid, which fills an optical path of the exposure light between the substrate and an optical member wherefrom the exposure light can emerge, comprising the steps of:
forming a first immersion space of the first liquid at an emergent surface side of the optical member with a first liquid immersion member, which is disposed at least partly around the optical path, such that the optical path of the exposure light between the optical member and the substrate is filled with the first liquid;
exposing the substrate through the first liquid of the first immersion space; guiding at least some of the first liquid in the first immersion space to a first guide space, which is partly around the optical path; and
forming a second immersion space of a second liquid with a second liquid immersion member, which is disposed at an outer side of the first liquid immersion member with respect to the optical path, such that the second immersion space is partly around the first immersion space and is adjacent to the first guide space.

95. A program that causes a computer to control an immersion exposure apparatus that exposes a substrate with exposure light through a first liquid, which fills an optical path of the exposure light between the substrate and an optical member wherefrom the exposure light can emerge, comprising the steps of:
forming a first immersion space of the first liquid at an emergent surface side of the optical member with a first liquid immersion member, which is disposed at least partly around the optical path, such that the optical path of the exposure light between the optical member and the substrate is filled with the first liquid;
exposing the substrate through the first liquid of the first immersion space; and forming a second immersion space of a second liquid partly around the first immersion space with a second liquid immersion member, which is disposed at the outer side of the first liquid immersion member with respect to the optical path and adjacent to the first liquid immersion member in a first direction in which the substrate moves in a prescribed operation of the substrate.

96. A program that causes a computer to control an immersion exposure apparatus that exposes a substrate with exposure light through a first liquid, which fills an optical path of the exposure light between the substrate and an optical member wherefrom the exposure light can emerge, comprising the steps of:
forming a first immersion space of the first liquid at an emergent surface side of the optical member with a first liquid immersion member, which is disposed at least partly around the optical path, such that the optical path of the exposure light between the optical member and the substrate is filled with the first liquid;
exposing the substrate through the first liquid of the first immersion space; and
forming a second immersion space of a second liquid partly around the first immersion space with a second liquid immersion member, which is disposed at an outer side of the first liquid immersion member with respect to the optical path, the second liquid immersion member having a second supply port and a fluid recovery part, the substrate being capable of opposing the second supply port, the second liquid being capable of being supplied via the second supply port, the fluid recovery part being disposed such that it surrounds the second supply port, the substrate being capable of opposing the fluid recovery part.

97. A program that causes a computer to control an immersion exposure apparatus that exposes a substrate with exposure light through a first liquid, which fills an optical path of the exposure light between the substrate and an optical member wherefrom the exposure light can emerge, comprising the steps of:
forming a first immersion space of the first liquid at an emergent surface side of the optical member with a first liquid immersion member, which is disposed at least partly around the optical path, such that the optical path of the exposure light between the optical member and the substrate is filled with the first liquid;
exposing the substrate through the first liquid of the first immersion space;
forming a second immersion space of a second liquid with a second liquid immersion member, which is disposed at an outer side of the first liquid immersion member with respect to the optical path, such that the second immersion space is partly around the first immersion space; and
recovering fluid by a fluid recovery part of a recovery member, which is disposed at an outer side of the first liquid immersion member with respect to the optical path.

98. A program that causes a computer to control an immersion exposure apparatus that exposes a substrate with exposure light through a first liquid, which fills an optical path of the exposure light between the substrate and an optical member wherefrom the exposure light can emerge, comprising the steps of:
forming a first immersion space of the first liquid at an emergent surface side of the optical member with a first liquid immersion member, which is disposed at least partly around the optical path, such that the optical path of the exposure light between the optical member and the substrate is filled with the first liquid;
exposing the substrate through the first liquid of the first immersion space;
forming a second immersion space of a second liquid with a second liquid immersion member, which is disposed at an outer side of the first liquid immersion member with respect to the optical path, such that the second immersion space is partly around the first immersion space; and
supplying gas via a gas supply port of a gas supply member from an outer side of a space between the first liquid immersion member and the object toward the space.

99. A program that causes a computer to control an immersion exposure apparatus that exposes a substrate with exposure light through a first liquid, which fills an optical path of the exposure light between the substrate and an optical member wherefrom the exposure light can emerge, comprising the steps of:
forming a first immersion space of the first liquid at an emergent surface side of the optical member with a first liquid immersion member, which is disposed at least partly around the optical path, such that the optical path of the exposure light between the optical member and the substrate is filled with the first liquid, the first liquid immersion member having a first lower surface, which is capable of opposing a front surface of the substrate with a first distance therebetween;
exposing the substrate through the first liquid of the first immersion space; and
forming a second immersion space of a second liquid with a second liquid immersion member, which is disposed at an outer side of the first liquid immersion member with respect to the optical path, such that the second immersion space is partly around the first immersion space, the second liquid immersion member having a second lower surface, which is capable of opposing a front surface of the substrate with a second distance therebetween, the second distance being smaller than the first distance.

100. A program that causes a computer to control an immersion exposure apparatus that exposes a substrate with exposure light through a first liquid, which fills an optical path of the exposure light between the substrate and an optical member wherefrom the exposure light can emerge, comprising the steps of:
forming a first immersion space of the first liquid at an emergent surface side of the optical member with a first liquid immersion member, which is disposed at least partly around the optical path, such that the optical path of the exposure light between the optical member and the substrate is filled with the first liquid;
exposing the substrate through the first liquid of the first immersion space;
forming a second immersion space of a second liquid with a second liquid immersion member, which is disposed at an outer side of the first liquid immersion member with respect to the optical path, such that the second immersion space is partly around the first immersion space; and
supplying gas from a gas supply port, which is disposed at an outer side of the second liquid immersion member with respect to the optical path.

101. A computer readable storage medium whereon a program according to claim 94 is stored.
